(19) United States
(12) Patent Application Publication
(10) Pub. No.: US 2024/0076235 A1
(43) Pub. Date: Mar. 7, 2024

(54) BIOLOGICAL CEMENT WITH ALGAL BIOMATTER

(71) Applicant: University of Washington, Seattle, WA (US)

(72) Inventors: Eleftheria Roumeli, Seattle, WA (US); Meng-Yen Lin, Seattle, WA (US); Paul Grandgeorge, Seattle, WA (US); Andrew M. Jimenez, Seattle, WA (US)

(73) Assignee: University of Washington, Seattle, WA (US)

(21) Appl. No.: 18/454,005

(22) Filed: Aug. 22, 2023

Related U.S. Application Data
(60) Provisional application No. 63/373,439, filed on Aug. 24, 2022.

(51) Int. Cl. C04B 18/24; C04B 28/04; C04B 28/14; C04B 40/02

(52) U.S. Cl. CPC C04B 18/248; C04B 28/04; C04B 28/14; C04B 40/0281; C04B 2103/0001

(57) ABSTRACT

A biological cement including algal biomatter, cement, and water. The present disclosure also provides methods of preparing the biological cement. The biological cement can be used in place of traditional cement, for instance by being incorporated into mortar or concrete for structural or other applications. The algal biomatter may include one or more of biomass from Chlorella, Spirulina (Arthrospira platensis), Saccharina latissima, Ulva spp. (such as U. lactuca or U. expensa), Agarophyton, Sargassum, Gracilaria parvispora, Halymenia hawaiiana or Caulerpa lentillifera.

### CROSS-REFERENCE TO RELATED APPLICATION

This application claims priority to and the benefit of the earlier filing of U.S. Provisional Application No. 63/373,439, filed on Aug. 24, 2022, which is incorporated by reference herein in its entirety.

### FIELD OF THE DISCLOSURE

The present disclosure relates generally to biological cements and biological cement mixtures containing regular cement and biomatter. Examples of the biomatter include one or more algal biomaterials of Chlorella spp., Spirulina spp., Saccharina spp., and Ulva spp.

### BACKGROUND

Regular (ordinary) cement is a substance used for construction that sets, hardens, and adheres to other materials. In general, ordinary cement is a powdery substance made with calcined lime and clay. Cement is often mixed with other materials, such as sand, gravel, or other aggregate, and is used to bind the materials together. Cement mixed with fine aggregate produces grout and mortar for masonry. Concrete is produced when cement is mixed with sand and gravel. Concrete is one of the most used construction materials worldwide as it is strong and relatively cheap.

### SUMMARY OF ASPECTS OF THE DISCLOSURE

The current disclosure provides methods of preparing a biological cement product, the method including: forming a biological cement paste by mixing dry matter and water, wherein the dry matter includes: 0.5 wt % to 15 wt % algal biomatter per dry matter; and cement; pouring the biological cement paste into a mold; and curing the biological cement paste, thereby forming the biological cement product; wherein the algal biomatter includes at least one of a Saccharina sp. or an Ulva sp.

Also provided are biological cements that include dry matter and water, wherein the dry matter includes: 0.5 wt %-15 wt % algal biomatter per dry matter including at least one of a Saccharina sp. or an Ulva sp.; and cement. Embodiments also provide the dry matter component alone, without addition of water—that is, a powder mixture containing conventional cement (with optionally one or more convention additive(s), to which has been added 0.5 wt %-15 wt % algal biomatter per dry matter including at least one of a Saccharina sp. or an Ulva sp.

Also provided are building products that include a biological cement as provided herein. By way of example such building product is certain cases is a mortar or a concrete.

Yet another embodiment is a method of tuning one or more mechanical properties of a biological cement that includes dry matter and water, wherein the dry matter includes algal biomatter and (conventional) cement, the method including one or more of: varying an amount of algal biomatter used in the biological cement; varying a type of algal biomatter used in the biological cement; and/or varying a preprocessing/pretreatment of the algal biomatter used in the biological cement. By way of example, such “tuning” may be done in accordance with information in Table 1 and the accompanying discussion.

### BRIEF DESCRIPTION OF THE FIGURES

This application contains at least one drawing executed in color. Copies of this application with color drawing(s) will be provided by the Office upon request and payment of the necessary fee.

FIGS. 1A-1L. Powder characterization and sample fabrication. (FIGS. 1A-1C) Photographs of the cement, Chlorella, and Spirulina powders, respectively. (FIGS. 1D-1F) Corresponding SEM images of each powder. (FIGS. 1G-1I) Particle size distribution of the three dried powders. (FIG. 1J) Cement-Chlorella-water paste before casting (hereafter, 5 wt % Chlorella). (FIG. 1K) Casting of the biocomposite cubes. (FIG. 1L) Photographs of the green cement samples upon demolding.

FIGS. 2A-2C. Compressive strength and aging effect of cement composites with Chlorella and Spirulina. (FIG. 2A) Representative stress-strain curves of cement-Chlorella composites tested at day 7. (FIG. 2B) Effect of different concentrations of Chlorella and Spirulina on the compressive strength of cement composites tested at day 7 and 28. (FIG. 2C) Effect of curing duration on the compressive strength of cement-Chlorella and cement-Spirulina composites containing 5 wt % biomatter.

FIGS. 3A-3H. Effects of pure biomatter on the micromorphology of biocomposites. (FIGS. 3A, 3B) SEM images of PC on day 7. (FIGS. 3C, 3D) SEM images of CC-1 on day 7. (FIGS. 3E, 3F) SEM images of CC-5 on day 7. (FIGS. 3G, 3H) SEM images of CS-5 on day 7. The insets in (FIG. 3F) and (FIG. 3H) show the nanofibers at higher magnification.

FIGS. 4A-4F. Effects of biomatter on the hydration reactions. (FIG. 4A) Isothermal calorimetry heat flow profile of pure cement and composites with 1 and 5 wt % Chlorella in 7 days and (FIG. 4B) zoom-in of the major hydration period. (FIG. 4C) TGA curves of PC, CC-1, and CC-5 on day 28. (FIG. 4D) XRD patterns of CC composites on day 28. (FIG. 4E) Phase evolution of alite or belite, ettringite, and portlandite in CC composites at concentrations of 0.5-10 wt % on day 7 and 28. (FIG. 4F) FTIR spectra of CC composites at concentration of 0.5-10 wt % on day 28.

FIGS. 5A-5D. Composition profile of biocomposites. (FIG. 5A) Elemental ratio of hydration products in pure cement at day 28. (FIG. 5B) Composition profile of Chlorella. (FIG. 5C) Composition profile of nanofibers and (FIG. 5D) spherical structures in the Chlorella composite with 5 wt % biomatter. See also Table 4.

FIGS. 6A-6B. Hydration reactions of ordinary Portland cement and the altered hydration reaction with the addition of algal biomatter. (FIG. 6A) The hydration reaction of ordinary Portland cement. Upon contact with water, alite and belite form a gel surrounding the surface of cement. Ettringite generated from tricalcium aluminate precipitates in prisms. The primary hydration reaction of alite and belite starts, nucleating amorphous C—S—H fibrils and Ca(OH)₂ platelets. (FIG. 6B) The hydrophilic algal surfaces interact with cement particles in the presence of water. The secondary hydration reactions of cement still occur, creating ettringite precipitates. The acidified carboxylic and hydroxyl groups of the biomatter carbohydrates in alkaline conditions facilitate a strong hydrogen bond network which encapsulates cement particles, inhibiting the reaction of alite and belite, thereby hindering the formation of C—S—H and Ca(OH)₂ while forming nanofibers and microspheres of different compositions.

FIG. 7A Exemplary powders of algal biomatter, which are Chlorella, Spirulina, sugar kelp, and Ulva from left to right. FIG. 7B Samples in the size of 15 mm cubes and 10 mm cubes, which are hardened Portland cement, sugar kelp-cement composite, and Chlorella-cement composite from left to right.

FIGS. 8A-8B. (FIG. 8A) Compression test results for sucrose 5% and 0.5% cement composite and glucomannan 5% and 0.5% (GM5 and GM05, respectively) compared to pure cement (PC), Ulva 5% cement composite (UV5), and Spirulina 5% cement composite (SP5). (FIG. 8B) TGA result for sucrose 5% and 0.5% cement composite compared to PC, UV5, and SP5

FIG. 9 Compression test results for cold water extracted Spirulina precipitate solid 5% (CWE_SP5) and supernatant liquid (CWE_SPL) cement composite, Cold water extracted Ulva precipitate solid 5% (CWE_UV5) supernatant liquid (CWE_UVL) cement composite and compared to PC, UV5, SP5.

FIGS. 10A-10B (FIG. 10A) Compression test results for Hot water extracted Spirulina precipitate solid 5% (HWE_SP5) and supernatant liquid (HWE_SPL) cement composite, Hot water extracted Ulva precipitate solid 5% (HWE_UV5) supernatant liquid (HWE_UVL) cement composite and compared to PC, UV5, SP5. (FIG. 10B) TGA results for hot water extracted cement composite compared to PC, UV5, and SP5

FIG. 11 FTIR spectra of biopolymer additive and hot water extraction study cement composite.

FIGS. 12A-12B Steady-state ultimate compressive strength of 1%, 5%, and 10% Ulva at small (dotted), medium (dashed) and large (solid) particle sizes both in (FIG. 12A) raw and (FIG. 12B) self-bonded forms.

FIGS. 13A-13I Strength development curves of Ulva-cement composites. The first row presents the curves of raw Ulva at (FIG. 13A) small, (FIG. 13B) medium, and (FIG. 13C) large particle sizes in order to compare the effect of concentration. The second row presents the curves of raw Ulva at (FIG. 13D) 1%, (FIG. 13E) 5%, and (FIG. 13F) 10% to compare the effect of particle size. The third row presents the curves of raw and self-bonded Ulva at (FIG. 13G) small particle size 1% concentration, (FIG. 13H) medium particle size 5% concentration, and (FIG. 13I) large particle size 10% concentration to see the effect of self-bonding.

FIGS. 14A-14I Thermal degradation of Ulva-cement composites. The first row presents the curves for raw Ulva at (FIG. 14A) small, (FIG. 14B) medium, and (FIG. 14C) large particle sizes to observe the effect of concentration. The second row groups raw Ulva composites by (FIG. 14D) 1%, (FIG. 14E) 5%, and (FIG. 14F) 10% to observe the effect of particle size. The third row presents compares the raw and self-bonded Ulva composites at (FIG. 14g) 1%, (FIG. 14H) 5%, and (FIG. 14I) 10%, all at the largest particle size.

FIGS. 15A-15B. Steady-state micromorphology to observe self-bonded Ulva. Self-bonded Ulva at large particle size in cement composites with 10% concentration. (FIG. 15A) Low magnification image to see the whole particle in the matrix and (FIG. 15B) high magnification image to closely observe the interface between the self-bonded particle and cement matrix.

FIGS. 16A-16B. Steady-state micromorphology to observe self-bonded Ulva. Self-bonded Ulva at small particle size in cement composites with 1% concentration. (FIG. 16A) Low magnification image to see the whole particle in the matrix and (FIG. 16B) high magnification image to closely observe the interface between the self-bonded particle and cement matrix.

FIGS. 17A-17B. Steady-state ultimate compressive strength of 1%, 5%, and 10% Spirulina at small (dotted), medium (dashed) and large (solid) particle sizes both in (FIG. 17A) raw and (FIG. 17B) self-bonded forms. Note again that (FIG. 17) raw Spirulina was only tested at the small particle size.

FIGS. 18A-18I. Strength development curves of Spirulina-cement composites. The first row presents the curves of self-bonded Spirulina at (FIG. 18A) small, (FIG. 18B) medium, and (FIG. 18C) large particle sizes in order to compare the effect of concentration. The second row presents the curves of self-bonded Spirulina at (FIG. 18D) 1%, (FIG. 18E) 5%, and (FIG. 18F) 10% to compare the effect of particle size. The third row presents the curves of raw and self-bonded Spirulina at (FIG. 18G) 1%, (FIG. 18H) 5%, and (FIG. 18I) 10% concentration to see the effect of self-bonding, all at small particle size.

### DETAILED DESCRIPTION

Various implementations of the present disclosure relate to biological cement, such as biological cement including dry matter and water, wherein the dry matter includes 0.5 wt % to 15 wt % algal biomatter and cement. In particular implementations, the algal biomatter includes at least one of Chlorella, Spirulina, Saccharina latissima, or Ulva lactuca. In particular implementations, the biological cement containing algal biomatter has mechanical properties similar to cement without algal biomatter. In particular implementations, the mechanical properties of the biological cement can be tuned by varying the amount or type of algal biomatter included in the biological cement. The present disclosure also provides methods of preparing the biological cement. The biological cement of the present disclosure can be incorporated into mortar, grout, or concrete for structural applications.

In particular implementations, applications of the biological cement disclosed herein include applications as construction materials. In particular implementations, an application of the biological cement disclosed herein includes 3D printing slurries for the construction of custom-designed structures (e.g., for professionals or hobbyist).

In particular implementations, the biological cement includes dry matter and water. In particular implementations, the composition of dry matter includes 0.5-15 wt % algal biomatter (e.g., Saccharina latissima, Ulva lactuca, Chlorella sp., and/or Spirulina sp.)—85-99.5 wt % cement (e.g., Portland cement type I/II). The weight concentration of biomatter is determined with respect to the mass of dry matter. In particular implementations, dry matter includes cement and algal biomatter. It will be recognized that at least a portion of the water added to a mixture of dry matter and water will be lost from the final product, through the hydration process and other changes involved in drying and curing cement-comprising products.

One embodiment of the disclosure is a method of preparing a biological cement product, the method including: forming a biological cement paste by mixing dry matter and water, wherein the dry matter includes: 0.5 wt % to 15 wt % algal biomatter per dry matter; and cement; pouring the biological cement paste into a mold; and curing the biological cement paste, thereby forming the biological cement product; wherein the algal biomatter includes at least one of a Saccharina sp. or an Ulva sp. Optionally, in this method embodiment, the algal biomatter includes at least one of Chlorella, Spirulina (Arthrospira platensis), Saccharina latissima, Ulva lactuca, Ulva expensa, Agarophyton, Sargassum, Gracilaria parvispora, Halymenia hawaiiana or Caulerpa lentillifera.

In examples of these method embodiments, the biological cement paste includes: 3 wt % to 15 wt % algal biomatter per dry matter; or 10 wt % to 15 wt % algal biomatter per dry matter. Optionally, the biological cement paste can include a water to cement ratio of 0.35 to 0.5. In various examples, the biological cement paste includes one or more of: 20 wt % to 40 wt % water; 20 wt % to 33 wt % water; 55 wt % to 80 wt % cement; or 55 wt % to 74 wt % cement.

The method embodiments also include examples wherein the dry matter further includes one or more additional components, such as additives or admixtures. By way of example, any one or more of the following can be included: construction aggregate, limestone, nanoclay, non-algal biomatter, an inorganic polymer, an organic polymer, a salt, a hardening agent, a hardening-retarding agent, a colorant, a water-repelling chemical, an air-entraining agent, a corrosion inhibitor, a glue, a resin, or a self-bonding agent.

In example methods of preparing a biological cement product, the curing includes drying. In examples, the curing includes one or more of: incubating at 50% to 100% relative humidity; incubating at 90% relative humidity; and/or incubating at ambient conditions. By way of example, the ambient conditions in some instances include: a temperature ranging from 20° C. to 30° C.; or a temperature of 25° C. Further, the ambient conditions in some instances include a relative humidity of 30-50% relative humidity.

In yet further examples of the method of preparing a biological cement product embodiments, one or more of the following may apply: the curing includes applying additional water to the biological cement paste; at least a portion of the algal biomatter is dried; at least a portion of the algal biomatter has been preprocessed by hot water extraction; at least a portion of the algal biomatter has been preprocessed by cold water extraction; at least a portion of the algal biomatter has been preprocessed by self-bonding; at least a portion of the algal biomatter is formulated as a bioplastic; at least a portion of the algal biomatter is a powder; and/or at least a portion of the cement is a powder.

In any embodiment provided herein, it is contemplated that the cement can include: tricalcium silicate, dicalcium silicate, tricalcium aluminate, tetracalcium aluminoferrite, and gypsum. For instance, in examples of methods and compositions, the cement includes: 25-50% tricalcium silicate, 20-45% dicalcium silicates, 5-12% tricalcium aluminate, 6-12% tetracalcium aluminoferrite, and 2-10% gypsum, wherein the sum total does not exceed 100%.

Also provided are biological cements including dry matter and water, wherein the dry matter includes: 0.5 wt %-15 wt % algal biomatter per dry matter including at least one of a Saccharina sp. or an Ulva sp.; and cement. Embodiments also provide the dry matter component alone, without addition of water—that is, a powder mixture containing conventional cement (with optionally one or more convention additive(s), to which has been added 0.5 wt %-15 wt % algal biomatter per dry matter including at least one of a Saccharina sp. or an Ulva sp.

Embodiments of the provided biological cement are made by a method including: forming a biological cement paste by mixing dry matter and water, wherein the dry matter includes 0.5 wt % to 15 wt % algal biomatter per dry matter and cement; pouring the biological cement paste into a mold; and curing the biological cement paste, thereby forming the biological cement.

In embodiments of the biological cement (either the dry powder of once it is mixed with water), the algal biomatter includes material from at least one of Chlorella, Spirulina (Arthrospira platensis), Saccharina latissima, Ulva lactuca, Ulva expensa, Agarophyton, Sargassum, Gracilaria parvispora, Halymenia hawaiiana or Caulerpa lentillifera.

Examples of the provided biological cements have at least one mechanical property that is: within 5% to 110% of the same mechanical property of (conventional) cement; or within 90% to 110% of the same mechanical property of (conventional) cement. In this context, the (conventional) cement may be equivalent cement that does not contain the biological biomass of the described biological cement. Thus the comparative sample may be essentially identical in characteristics but for omission of the biological material(s) added based on this disclosure.

Also provided are building products that include a biological cement as provided herein. By way of example such building product is certain cases is a mortar or a concrete.

Yet another embodiment is a method of tuning one or more mechanical properties of a biological cement that includes dry matter and water, wherein the dry matter includes algal biomatter and (conventional) cement, the method including one or more of: varying an amount of algal biomatter used in the biological cement; varying a type of algal biomatter used in the biological cement; and/or varying a preprocessing/pretreatment of the algal biomatter used in the biological cement. By way of example, such “tuning” may be done in accordance with information in Table 1 and the accompanying discussion. In specific example tuning methods, one or more of: the amount of algal biomatter ranges from 0.5 wt % to 15 wt % algal biomatter per dry matter; the amount of algal biomatter ranges from 3 wt % to 15 wt % algal biomatter per dry matter; the amount of algal biomatter ranges from 10 wt % to 15 wt % algal biomatter per dry matter; and/or the type of algal biomatter includes at least one of Chlorella, Spirulina (Arthrospira platensis), Saccharina latissima, Ulva lactuca, Ulva expensa, Agarophyton, Sargassum, Gracilaria parvispora, Halymenia hawaiiana or Caulerpa lentillifera.

Aspects of the current disclosure are now described with additional details and options as follows: (I) Introduction; (II) Representative Terms; (III) Biomatter Component, including types and preparations; (IV) Cementitious Component(s); (V) Methods of Preparation, including Options and Tunable Properties; (VI) Uses, including Environmental Benefits; (VII) Exemplary Implementations; (VIII) Experimental Examples; and (IX) Closing Paragraphs. These headings do not limit the interpretation of the disclosure and are provided for organizational purposes only.

### I. Introduction

Accounting for between 5% and 11% of the global emissions of CO₂, the cement industry is one of the primary sources of carbon emission in the world. Among the greenhouse gases emission, 50% is attributed to the calcination process which converts limestone (CaCO₃) to calcium oxide (CaO), 40% to the fossil fuel combustion during cement manufacturing, and 10% to transportation and operation activities. Substantial research has been conducted to address this harmful environmental impact over the past three decades, including predicting the strength of hydrated cements through molecular dynamics simulations which enables the use of less cement material in applications without sacrificing performance, improving the energy efficiency of the manufacturing process, carbon sequestration through carbonation curing, and reducing clinker/cement ratio by introducing additives such as fly ash (industrial waste), glass (municipal waste), and rice husk ash (natural waste from agricultural and aquacultural farming).

Renewable and carbon-sequestering biological materials provide alternative additives to improve the environmental footprint of cement while enabling additional functionalities. For example, certain bacteria, mycelia, and enzymes have been used to induce biomineralization in self-healing concrete, and plant-derived cellulose has been introduced in cement as macro- and nanoscale reinforcement. Cellulose, in particular, is used as an internal curing agent and water transport pathway to improve cement's access to water, thereby increasing the degree of hydration in cement and further reinforcing mechanical properties. Indeed, in a review by Guo et al. (Nanomaterials 10:2476, 2020), the authors report that fillers in the form of cellulose nanocrystals (CNCs) and cellulose nanofibrils (CNFs) induce a delaying effect on cement hydration but can lead to higher late-age strengths. For example, Fu et al. (Polymers 9:424, 2017) reported an increase in flexural strength from 22.0 to 28.8 MPa (+30.1%) in Portland cement when filled with 2 vol % (CNC/dry cement) tested at day 28. It should however be noted that cellulose often requires cost and energy intensive processing steps for extraction and functionalization, thereby still limiting its large-scale use.

Another approach, which has been applied widely, consists of using entire plant fibers as reinforcement (e.g., in structural concretes). For example, bamboo fibers were used by Akinyemi et al. (Const Building Mater. 111:719-734, 2016) at concentrations between 1 and 1.5 wt % (fibers/total mass of constituents) in a cement and sand mortar mix. Comparing three different fiber pretreatment methods (hot water, microwave irradiation assisted alkaline treatment, and alkali treatment only), they showed that the microwave assisted alkaline treatment leads to the highest flexural strength compared to the two other treatments. The authors suggest that the microwave assisted alkaline treatment, through the removal of cellulose, lignin, and hemicellulose from the fiber's molecular structure, leads to a roughening of the surface, which enables the cement hydrates to fill the voids, in turn leading to improved adhesion with the cement matrix. In another study, Ban et al. (Polymers, 12:2650, 2020) showed that without fiber treatment or additives, the incorporation of 2 vol % bamboo decreases strength from 51.2 to 37.0 MPa (−27.7%). Other examples of plant fibers and tissues as fillers include sugar cane bagasse, hemp, flax, straw, jute, and kenaf.

As an alternative biological-origin filler, algae and algae-derived materials have been receiving increasing attention as their applications broaden from nutraceuticals and pharmaceuticals to biofuels and bioplastics, owing to their advantageous rapid growth rates and scalable cultivation with low land usage compared to other plants. Moreover, the high capacity of carbon sequestration (1 kg of dry algal biomass absorbs roughly 1.8 kg of CO₂; Chisti, Biotech. Adv. 25:294-306, 2007) marks a key benefit of utilizing algal materials, especially in high-volume applications, such as construction materials, when attempting to reduce environmental impact. In cement formulations, specifically, algae-derived biopolymers have been long utilized as viscosity modifiers and agents to control volume changes upon hydration. For example, alginate, extracted from the cell walls of brown algae, has been used to controllably change the viscosity of cement pastes (León-Martinez et al., Constr. Build Mater. 53:19-202, 2014) or to improve the mechanical properties and durability against chloride penetration of hardened cement (Hernández et al., Materiales de Construccion 66:e074-e074, 2016). Carrageenan, another algal cell wall biopolymer, has been leveraged as superabsorbent polymer to improve the autogenous shrinkage in cement pastes (Aday et al., Materials & Structures, 51:1-13, 2018). A considerable amount of prior work has focused on understanding the effects of plant- or algae-derived biopolymers on cementitious materials, but the production of these renewable biopolymers involves energy-intensive steps such as mechanical disintegration followed by long hydrolysis reactions in acidic (Clarkson et al., Adv Mater. 33:2000718, 2021; McHugh, Production and utilization of products from commercial seaweeds; FAO, 1987; ISBN: 92-5-102612-2) or alkaline (Manuhara et al., Aquatic Procedia 7:106-111, 2016) solutions. These processing routes are typically low yield, as only a small fraction of the dry mass is extracted as a product, while the remaining parts of the biomass are manufacturing waste.

A recently emerging and more sustainable alternative suggests using fast-growing, untreated plant, algal, or microbial biomatter, in the form of intact cells or tissues, as a polymeric matrix or filler material, aiming to capitalize on raw biomatter to function as a renewable material platform that potentially can lead to wasteless processes. Photosynthetic biomatter in particular, such as plant or algal cells, can effectively serve as carbon negative matrix materials or additives. The concept of utilizing abundant and intact algal biomatter in the design of hybrid cementitious formulations remains, to a great extent, unexplored. Chen et al. (ACS Sustainable Chem Engl. 9:13726-23735, 2021) recently provided the first insights into the effects of introducing ceased Chlorella cells, in the form of ground-up pellets, on the mechanical properties of cement. Their work shows that the incorporation of 0.5-3 wt % Chlorella powder aggregates into Type I/II Portland cement effectively delays the cement hydration reactions by 16-800%. Further, they estimate that cement composites containing 0.5 wt % Chlorella allow for a 1% reduction in the embodied carbon of cement while not affecting the compressive strength. Yet, the mechanisms governing the interactions between unprocessed algal biomatter and cement and understanding the biomatter effects on each of the hydration reactions and their concentration dependence remain elusive.

In the work described herein, different types of unprocessed or minimally processed algal biomatter (such as Ulva, sugar kelp, Chlorella, and Spirulina), were introduced at concentrations of 0.5-15 wt % in ordinary Portland cement (as an exemplar of conventional cement)—to expand the design space of sustainable algae-cement formulations and explore higher biomatter concentrations. By way of example, Chlorella and Spirulina are widely available and have different biopolymer constituents, thus enabling study of the effects of polymer composition. While the use of unprocessed or minimally preprocessed algae allows production of formulations that require no additional additives, the comparable particle sizes of both algae to cement particles allows the resulting composites to serve as binder materials with applications in mortar or concrete, for instance. Through comprehensive characterization, the fundamental impacts of the biomatter inclusions in the cement hydration reactions and their kinetics are described.

In addition to the known retardation effects induced in the presence of biomatter at low concentrations reported by Chen et al. (ACS Sustainable Chem Engl. 9:13726-23735, 2021), this study reveals a long-term significant reduction in compressive strength at biomatter concentrations above 5 wt %, which was previously not reported. A detailed characterization of the hydration reaction products is presented, and insights are offered on the mechanisms leading to the observed drastic decrease in the hardening of certain biological composite cements.

### (II) Representative Terms

Algal biomatter or algal biomass refers to deceased and dried biological matter including one or more of cells, tissues, or dissociated cells or tissues from macroalgae or microalgae. In particular implementations, algal biomatter is in the form of a powder. Algal biomatter used in the compositions and methods described herein optionally may be subject to additional preprocessing step(s). The term “preprocessing” in this context refers to processing of a biological biomass material before it is added to or mixed with conventional cement.

Ambient conditions refers to the prevailing temperature and the relative humidity of the environment in which the preparation process is taking place. In particular implementations, ambient conditions include the temperature and relative humidity of a construction site.

Powder, as the term is used herein, refers to dry particles produced by grinding, crushing, pulverizing, or disintegration of a solid substance (e.g., biomatter, calcined lime, clay).

Construction aggregate, or simply aggregate, is a broad category of coarse- to medium-grained particulate material used in construction, including sand, gravel, crushed stone, slag, recycled concrete, geosynthetic aggregates, glass, construction waste, and so forth. Aggregates are a component of composite materials such as concrete and asphalt; the aggregate serves as reinforcement to add strength to the overall composite material. Although most kinds of aggregate require a form of binding agent (e.g., cement), there are types of self-binding aggregate which do not require any form of binding agent.

The terms “bio-cement” or “biological cement” refer to cement, mortar or grout that includes a bioproduct of the present disclosure.

Nanoclays are nanoparticles of layered mineral silicates. Depending on chemical composition and nanoparticle morphology, nanoclays are organized into several classes such as montmorillonite, bentonite, kaolinite, hectorite, and halloysite. Organically-modified nanoclays (organoclays) are an attractive class of hybrid organic-inorganic nanomaterials with potential uses in polymer nanocomposites, as rheological modifiers, gas absorbents and drug delivery carriers. Nanoclay is composed of phyllosilicates which include groups of minerals such as talc (Mg₃[Si₄O₁₀(OH)_{2]}), Mica (KAI₂[AlSi₃O₁₀(OH)₂]), kaolin (Al₂[Si₂O₅(OH)₄]), montmorillonite (Mg_{0.33}Al_{1.67}[Si₄O₁₀(OH)₂](Ca, Na) x (H₂O)ₙ), Serpentine (Mg₃[Si₂O₅(OH)₄]) or sepiolite (Mg₄[Si₆O₁₅](OH)₂ 4H₂O). Among other things, nanoclay differ in the size and sequence of the regions in which the SiO₄ tetrahedra are oriented upwards or downwards in the layers. Additionally, nanoclay differ in the nature of the embedded ions. It has been shown that inhaling nanoclay particles causes only minimal and transient inflammation in the lungs. So far, there are no data on how nanoclay behave in the environment.

### (II) Biomatter Component

Methods and compositions provided herein relate to biological cements that include a dry matter (mixture) and water, where the dry matter includes at least two components: a biomatter component, and a cementitious component. In embodiments, the biomatter component is an algal biomatter component—that is, is made from or made of algae (either microalgae or macroalgae, or a combination of two or more algae). More generally, the biomatter may include monomers, polymers, cells, tissues, or dissociated cells or tissues from a biological organism, such as a macroalgae or microalgae.

Exemplary algal biomatter sources include Arthrospira sp. (aka. Spirulina); Chlorella sp. (subspecies: vulgaris); Ulva sp. (e.g., U. expansa, U. lactuca, etc.); Saccharina sp. (e.g., S. latissima (sugar kelp)); red algae Agarophyton sp. (e.g., A. vermiculophyllum); brown macroalgae (seaweed) Sargassum sp.; red algae Gracilaria parvispora (ogo); red algae Halymenia hawaiiana; green algae Caulerpa lentillifera (latok; sea grapes), and so forth.

Sea lettuce (exemplified by Ulva lactuca L.) is an edible, green macroalgae (e.g., seaweed) in the phylum Chlorophyta; it is distributed widely in coastal areas around the world. Sea lettuce grows rapidly and robustly; it is recognized as a valuable food stuff (for humans, as well as in aquaculture fishery processes; CN10394787A2), with high nutritive value with abundant crude fiber, carbohydrates, protein and low amounts of lipid (see, e.g., Dominguez & Loret, Mar Drugs 17(6):357, 2019). Sea lettuce also contains multiple vitamin, essential amino acids, and trace elements such as K, Na, Ca, Mg, N, Zn, Mo, Cu, I, and F.

Sugar kelp (Saccharina latissima) is a yellowish brown marine macroalgae widely cultivated and eaten in Asia and growing in popularity in the United States and elsewhere as a nutritious food high in fiber, vitamins, and minerals. Sugar kelp has long been known as a sweetener and as having thickening and gelling qualities that can be added to food and cosmetics. Sugar kelp is being grown and harvested by more commercial farms for a variety of uses, from food to potential biofuels. Ribbon kelp (Alaria marginata; a brown seaweed) and bull kelp are also grown commercially, and likewise can provide biomass for the methods and compositions provided herein.

Algal biomass, such as ocean/sea harvested “wild” seaweeds or dried seaweeds (e.g., Ulva spp., Saccharina spp., and so forth) washed up on beaches or lack/river harvested wild algae (e.g., Chlorella spp.), is readily collected and can be used in the methods and compositions provided herein. Usually, such naturally harvested algal biomass is washed to remove excess undesirable contaminants, such as salts and sand and the like. However, naturally harvested (e.g., beach collected) seaweeds may be contaminated with substances that are not readily removed, such as pollutants. Naturally harvested products are also likely to have variable characteristics depending on the location and timing (e.g., season) of harvest (Wijesekara et al., J App Phycol. 29:2503-2511, 2017, doi: 10.1007/s10811-017-1239-7); such variation may might impact products made from the herein-described biological cements.

Thus, in additional to naturally harvested algal biomatter, also contemplated are intentionally produced (e.g., “farmed” or otherwise industrially produced, with the involvement of human intervention) algal biomass. Methods have been developed for bulk production of macro- and microalgae, both for chemical and biofuel production (see, e.g., Wijffles et al., Biofpr, 4(3):287-295, 2010, doi: 10.1002/bbb.215) and for food or biomass (see, e.g., Diaz et al., Front. Nutr 9: 1029841, 2023, doi: 10.3389/fnut.2022.1029841). Such methods are applicable to produce algal biomatter for the methods and products of this disclosure.

Commercial producers are also available sources for algal biomatter for the current disclosure. For instance, seaweed farms (seaweed aquaculture farms) are commercially producing myriad types of macro and micro algae; producers are common in China, Indonesia, the Philippines, South and North Korea, Japan, Malaysia, and Zanzibar. By way of example, seaweed can be purchased from shellfish farms and other sea farms, such as Blue Dot sea farms (bluedotseafarms.com, a shellfish and seaweed farm in Washington state). As more uses for algal biomass are developed, it is expected that additional commercial sources will become available.

Optionally, one or more non-algal biomaterials also may be included in embodiments of biological cements provided herein. Exemplary non-algal biomaterials include proteins (such as gluten, lactalbumin, bovine serum albumin BSA); lignin; cellulose (such as bacterial cellulose fibers, nanocellulose, cellulose nanocrystals, cellulose nanofibers, alpha cellulose, carboxymethylcellulose); hemicellulose (such as xylan, glucomannan); other carbohydrates (such as starch, isomalt, sucrose); powdered wood (such as from Douglas fir); agai; coffee beans; dragon fruit; matcha powder; or food production byproducts (such as pulp or waste matter arising from commercial processing of foodstuffs, such as recognized food waste stream components).

The basic preparation processes for algal biomatter useful here can be quite straightforward—generally, gather the desired algae, clean to remove undesirable impurities, dehydrate, then grind to a powder. Exemplary methods are provided herein, and will be well known to those of ordinary skill in the art. By way of example, harvested macroalgal biomatter (e.g., Ulva lactuca) is washed then dried off using a centrifugal or other dehydrator system. Dried off algal biomatter is then fully dried using, for instance, a drying box or other dehydrator for instance by raising the temperature of the biomatter for an extended period of time (e.g., to 70° C. or more for 4 or more hours). Alternatively, the biomatter can be dried in a freeze dehydrator. Once the biomatter is dry, it is ground or pulverized to a fine powder, which can then be used as a biomatter component to be mixed with a conventional cement component.

Though algal biomatter may be employed simply as dried and ground algae, optional additional processing step(s) may also be carried out before the algal biomatter is mixed with the traditional cementitious component.

Additional preprocessing methods of self-bonding and extraction steps may optionally be used to pretreat the biomass before mixing it with cement. The term “preprocessing” in this context refers to processing of a biological biomass material before it is added to conventional cement.

Self-bonding: Biomass may be self-bonded through heat and compressive pressure that forms continuous and strong matrix. Biomass is first ground into homogenous particle size and then biomass is placed into a steel mold (exemplified here with 1 g samples; the weight will depend on the density of biomass, as well as the scale at which self-bonding is being employed). The mold is then put on a hot-press at 120-160° C. and exposed to 0.5-15 MPa for a duration of 5-10 minutes. See, for instance, additional description in U.S. application Ser. No. 18/453,178, filed Aug. 21, 2023, which is incorporated herein by reference in its entirety. For Spirulina an empirical optimal pressure is 10-15 MPa; for other biomass materials, the pressure needed to get adequate self-bonding can be higher, for instance as high as up to 75 MPa. The resultant self-bonded product is then ground to a target particle size to be used as a bio-based addition in cement. This processing method is defined as the self-bonding pretreatment.

Extraction: The extraction pretreatment is a method using water at different temperatures to modify the compositions of biomass before adding the bio-based filler material into the cement mixture. A hot water extraction (HWE) preprocess involves mixing the biomass and water at a ratio of 1:20 to 1:30 (w/w) and stirring the mixture constantly, for instance at 90-100° C. for 1-3 hr. The resultant solution is centrifuged for 10 minutes at 6000 rpm. After extracting the precipitate, the processed-biomass is dried and ground into a homogenous particle size, for instance below 100 μm. This final product can be used as an addition in cement, as described herein. Similarly, a cold water extraction (CWE) preprocess follows the same biomass-to-water ratio and same processing procedure as the HWE preprocess, except the mixture is stirred at room temperature for 24 hr at the liquid state.

Also contemplated herein is use of bioplastic materials obtained from biological materials as (or part of) the biomatter component of mixtures and biological cements (bio-cements) provided herein. By way of example, such bioplastic materials may be as described in, or made using methods described in, U.S. application Ser. No. 18/453,178, filed Aug. 21, 2023, which is incorporated herein by reference in its entirety.

Other commercially available materials also may be used as optional filler in the provided biological cements. Such materials include, for instance, polylactic acid (PLA); polybutylene adipate terephthalate (PBAT); polyhydroxyalkanoates (PHAs including copolymers such as poly(3-hydroxybutyrate-co-3-hydroxyvalerate)); polybutylene succinate (PBS); polyethylene; polypropylene; polystyrene; polycarbonate; and maleic anhydride. In some aspects, the polymers may be biodegradable polymers such as poly(lactic acid) (PLA), polybutylene adipate terephthalate (PBAT), polyethylene oxide (PEO), polycaprolactone (PCL), poly(3-hydroxybutyrate-co-3-hydroxyvalerate) (PHBV), lignin, pine gum, BSA, gluten, casein, lactoglobulin, and lysozyme.

Also contemplated are optional further additives useful in cement mixtures, beyond the biomatter itself. In some aspects, the additives may include 0-30 wt % of the composition, including 0%, 10%, 30%, or fractions thereof. The various additives to the compositions may alter one or more properties of the biological cement in comparison to pure biomatter cement (that is, a mixture of only biomaterials and ordinary cement). Such additives may be conventional additives useful and recognized for tailoring characteristics of conventional cements.

### (IV) Cementitious Material Component

The methods and compositions provided herein involve adding biomatter to a cementitious component, to produce what is referred to herein as a biological cement. This section describes exemplary types of cements and other cementitious materials that are useful in embodiments of the biological cements described herein. Generally, the biological material “filler” embodiments provided herein can be used to enhance any type of traditional cement; the choice of cementitious material to which the provided biomatter (e.g., algal biomatter) is add may be influenced by the desired end use and characteristics of intended product to be made with the biological cement.

Also provided are representative characteristics of traditional/ordinary/non-biological cements; these characteristics may be used to measure biological cements provided herein, for instance in order to assist in tuning characteristic(s) of a biological cement in order to ensure it more close complies with standards traditionally applied to traditional, non-biological cements. Those of ordinary skill in the art will recognize there are myriad cement and cement product characteristics that can be analyzed, using different recognized methods, which can also be used to characterize biological cements (bio-cements) provided herein.

The names by which cement types and varieties are designated may vary by location (e.g., country of production); similarly, recognized characteristics testing methods may be location-specific. Though provided herein with representative names and testing methods, it will be understood that these are not intended to be limiting.

There are two generally recognized types of cementitious materials: hydraulic cements and secondary (or supplementary) cementitious materials (SCMs). Hydraulic cements set and harden by reacting chemically with water. During the reaction, which is called hydration, heat is given off as the water-cement paste hardens and binds the aggregate particles together. Portland cement (MEI) is the most common hydraulic cement; it is made by grinding clinker (generally including four minerals: two calcium silicates, alite (Ca₃SiO₅) and belite (Ca₂SiO₄), along with tricalcium aluminate (Ca₃Al₂O₆) and calcium aluminoferrite (Ca₂(Al,Fe)₂O₅)), which comes from the cement kiln, together with gypsum to produce a fine powder. SCMs are used in conjunction with a hydraulic cement (such as Portland cement) in mixtures to alter the workability of fresh mixtures and/or reduce thermal cracking in massive structures by reducing heat of hydration. SCMs include silica fume, limestone, pozzolana, slag cement, fly ash-C, and fly ash-F. Cementitious materials are usually principal ingredients that make up a concrete mixture.

Different types of cements are defined by their characteristics and constituents (e.g., additives that confer desired characteristic(s) to the cement and/or products made from it. By way of example, representative types of “traditional” (that is, non-biological) cements include: Ordinary Portland cement (OPC), Portland pozzolana cement (PPC), rapid-hardening cement (usually including a higher lime content), extra-rapid-hardening cement (for instance, which include calcium chloride), quick-setting cement, low-heat cement (having a tricalcium aluminate content below 6% total, which helps reduce the evolution of heat during the hydration process), sulfate-resisting cement, blast furnace slag cement (which may contain up to 60% slag ground with clinker; this generally has characteristics similar to OPC), high-alumina cement (made by melting bauxite with lime, then grinding it with clinker), white cement (essentially, OPC that is white rather than grey; the color difference is attributable to avoiding iron oxide materials in its production), colored cement (the opposite of white cement, this is made by adding up to 10% mineral pigment(s) to OPC to achieve a desired color), air-entertaining cement (to which air-entertaining (capturing) agent(s), such as glues, sodium salts, or resins, have been added), expansive cement, hydrographic cement (to which water-repelling chemical(s) are added), and Portland-limestone cement (PLC) (OPC to which up to 15% fine limestone has been added; this is considered a “green” sustainable cement product). Additional “green” cement products include biologically produced calcium carbonate-based or containing cements, such as described in Patent Publication US 2019/0210924 A1.

Regulations of cement strength: The field recognizes that different strengths of concrete are used for different applications. For instance, building code standard ACI 318 (Building Code Requirements for Structural Concrete and Commentary; American Concrete Institute) provides that nonstructural concrete shall have a minimum specified compressive strength (f_{c}′) of 2,500 psi (17.2 MPa) for Class F0; 3,000 psi (20.7 MPa) for Class F1; and 3,500 psi (24.1 MPa) for Classes F2 and F3. The classes within Category F applies to concrete that is exposed to moister and cycles of freeze/thaw; the classes are influenced by different degree of exposure to freezing and thawing. Note that concrete strength does not directly correlate to cement.

The following two tables include information derived from Tables 3 and 4 of ASTM C150. In these tables: Type I—For use when the special properties specified for any other type are not required; Type IA—Air-entraining cement for the same uses as Type I, where air-entrainment is desired; Type II—For general use, more especially when moderate sulfate resistance or moderate heat of hydration is desired; Type IIA—Air-entraining cement for the same uses as Type II, where air-entrainment is desired; Type III—For use when high early strength is desired; Type IIIA—Air-entraining cement for the same use as Type III, where air-entrainment is desired; Type IV—For use when a low heat of hydration is desired; and Type V—For use when high sulfate resistance is desired. Some cements are designated with a combined type classification, such as Type I/II, indicating that the cement meets the requirements of the indicated types and is being offered as suitable for use when either type is desired.

In summary, for Type I/II cement, the compressive strength is required to be higher than 19 MPa at day 7 and 28 MPa at day 28. This illustrates how other types of currently available “traditional” cements compare to the herein described biocomposite cements.

Standard Physical Requirements of Cement (Derived from TABLE 3 of ASTM C150)

| Cement | Test | | | | | | | | |
|---|---|---|---|---|---|---|---|---|---|
| Type^{A} | Method | I | IA | II | IIA | III | IIIA | IV | V |
| Air content of mortar, | C 185 | | | | | | | | |
| volume %: | | | | | | | | | |
| max | | 12 | 22 | 12 | 22 | 12 | 22 | 12 | 12 |
| min | | . . . | 16 | . . . | 16 | . . . | 16 | . . . | . . . |

Fineness,^{B} specific surface, m²/kg (alternative methods):

| | | | | | | | | | |
|---|---|---|---|---|---|---|---|---|---|
| Turbidimeter test | C 115 | | | | | | | | |
| Average value, min^{C} | | 160 | 160 | 160 | 160 | . . . | . . . | 160 | 160 |
| Any one sample, min^{D} | | 150 | 150 | 150 | 150 | . . . | . . . | 150 | 160 |
| Average value, max^{E} | | . . . | . . . | 240^{F} | 240^{F} | . . . | . . . | 240 | . . . |
| Any one sample, | | . . . | . . . | 245^{F} | 245^{F} | . . . | . . . | 245 | . . . |
| max^{E} | | | | | | | | | |
| Air permeability test | C 204 | | | | | | | | |
| Average value, min^{E} | | 280 | 280 | 280 | 280 | . . . | . . . | 280 | 280 |
| Any one sample, min^{F} | | 260 | 260 | 260 | 260 | . . . | . . . | 260 | 260 |
| Average value, max^{E} | | . . . | . . . | 420^{F} | 420^{F} | . . . | . . . | 420 | . . . |
| Any one sample, | | . . . | . . . | 430^{F} | 430^{F} | . . . | . . . | 430 | . . . |
| max^{E} | | | | | | | | | |
| Autoclave expansion, | C 151 | 0.80 | 0.80 | 0.80 | 0.80 | 0.80 | 0.80 | 0.80 | 0.80 |
| max, % | | | | | | | | | |

Strength, not less than the values shown for the ages indicated as follows:^{F}

| | | | | | | | | | |
|---|---|---|---|---|---|---|---|---|---|
| Compressive strength, | C 109/ | | | | | | | | |
| MPa (psi) | C 109M | | | | | | | | |
| 1 day | | . . . | . . . | . . . | . . . | 12.0 | 10.0 | . . . | . . . |
| | | | | | | (1740) | (1450) | | |
| 3 days | | 12.0 | 10.0 | 10.0 | 8.0 | 24.0 | 19.0 | . . . | 18.0 |
| | | (1740) | (1450) | (1450) | (1160) | (3480) | (2760) | | (1160) |
| | | | | 7.0^{G} | 6.0^{G} | | | | |
| | | | | (1020)^{G} | (870)^{G} | | | | |
| 7 days | | 19.0 | 16.0 | 17.0 | 14.0 | . . . | . . . | 7.0 | 15.0 |
| | | (2760) | (2320) | (2470) | (2030) | | | (1020) | (2180) |
| | | | | 12.0^{G} | 9.0^{G} | | | | |
| | | | | (1740)^{G} | (1310)^{G} | | | | |
| 28 days | | . . . | . . . | . . . | . . . | . . . | . . . | 17.0 | 21.0 |
| | | | | | | | | (2470) | (3050) |
| Time of setting; | C 191 | | | | | | | | |
| Vicat test:^{H} | | | | | | | | | |
| Time of setting, min, | | 45 | 45 | 45 | 45 | 45 | 45 | 45 | 45 |
| not less than | | | | | | | | | |
| Time of setting, min, | | 375 | 375 | 375 | 375 | 375 | 375 | 375 | 375 |
| not more than | | | | | | | | | |

^{A}See text above.
^{B}The testing laboratory may select the fineness method to be used. However, when a sample fails to meet the requirements of the air-permeability test, the turbidimeter test is used, and the requirements in this table for the turbidimetric method will govern.
^{C}Average value shall be determined on the last consecutive five samples from a source.
^{D}The value of any one sample shall be the result of a test or average of tests on any one sample.
^{E}Maximum average and maximum single sample fineness limits do not apply is the sum of C₃S + 4.75C₃A is less than or equal to 90.
^{F}The strength at any specified test age shall be not less than that attained at any previous specified test age.
^{G}When the optional heat of hydration in the following Table (“Optional Physical Requirements”) is specified.
^{H}The time of setting is that described as initial setting time in Test Method C 191.

Optional Physical Requirements (Derived from TABLE 4 of ASTM C150)

| Cement | Test | | | | | | | | |
|---|---|---|---|---|---|---|---|---|---|
| Type | Method | I | IA | II | IIA | III | IIIA | IV | V |
| False set, final | C 451 | 50 | 50 | 50 | 50 | 50 | 50 | 50 | 50 |
| penetration, min, % | | | | | | | | | |
| Heat of hydration: | C 186 | | | | | | | | |
| 7 days, max, kJ/kg | | . . . | . . . | 290 | 290 | . . . | . . . | 250 | . . . |
| (cal/g) | | | | (70)^{A} | (70)^{A} | | | (60) | |
| 28 days, max, kJ/kg | | . . . | . . . | . . . | . . . | . . . | . . . | 290 | . . . |
| (cal/g) | | | | | | | | (70) | |

Strength, not less than the values shown:

| | | | | | | | | | |
|---|---|---|---|---|---|---|---|---|---|
| Compressive strength, | C 109/ | | | | | | | | |
| mPa (psi) | C 109M | | | | | | | | |
| 28 days | | 28.0 | 22.0 | 28.0 | 22.0 | . . . | . . . | . . . | . . . |
| | | (4060) | (3190) | (4060) | (3190) | | | | |
| | | | | 22.04^{A} | 18.0^{A} | | | | |
| | | | | (3190)^{A} | (2610)^{A} | | | | |
| Sulfate resistance, 14 | C 452 | . . . | . . . | . . . | . . . | . . . | . . . | . . . | 0.040 |
| days, max, % expansion | | | | | | | | | |
| Gillmore test: | C 266 | | | | | | | | |
| Initial set, min, not less | | 60 | 60 | 60 | 60 | 60 | 60 | 60 | 60 |
| than | | | | | | | | | |
| Final set, min, not | | 600 | 600 | 600 | 600 | 600 | 600 | 600 | 600 |
| more than | | | | | | | | | |

^{A}These strength requirements apply when the optional heat of hydration requirement is requested.

### (V) Methods of Preparation

Prepared biomatter (such as algal biomatter) may be mixed with conventional cement using any mixing process acceptable for dry powders, including hand mixing, stirring, planetary mixing, and so forth. In general, the combination of dry matter is mixed sufficiently so that it is substantially to completely homogenous.

Biological cements described in this disclosure can be used essentially in place of convention cement. Thus, mixing a biological cement with water, and optionally with other components (such as aggregate, additives, and so forth) can be carried out as for mixing Portland cement or other cementitious products. Examples of adding biological cements with water, the forming and curing that product, are described herein. For instance, in the lab-scale implementations provided in the Examples, the water/biological cement slurry is mixed at 1000-1500 RPM for 2-5 minutes. Upon scale up, lower mixing speeds (such as 10-50 rpm) and longer mixing durations (such as 3-8 minutes) may be more applicable, as will be recognized by those of skill in the art. Such scale up applies, for instance, when mixing materials in an industrial scale mixer; generally, such mixers are larger than 100 L.

Added components, such as additives and admixtures, useful with conventional cements will also be useful with the provided biological cements. By way of example, such additional components may be viewed as part of the “dry matter” of a mixture provided herein, and may include one or more of construction aggregate (e.g., gravel, sand, crushed stone, pebbles, slag, recycled concrete, construction waste, geosynthetic aggregates, and so forth), limestone (e.g., finely ground or powdered), nanoclay, non-algal biomatter, an inorganic polymer, an organic polymer, a salt, a hardening agent, a hardening-retarding agent, a colorant, a water-repelling chemical, an air-entraining agent, a corrosion inhibitor, a glue, a resin, or a self-bonding agent.

Similarly, forming products that contain a biological cement described herein is carried out in conventional ways, as will be recognized by those of ordinary skill in the building, construction, and other cement-involved arts.

Tunable properties: By modifying the formula and/or preprocessing procedure to which algae biomatter is subjected, properties of the resultant biological cement product can be tuned to desired specifics—including for instance to comply with a standard set by a building inspection or other regulatory body. This is illustrated in Table 1, which shows that the hardened composite, the 28-day compressive strength, and Young's modulus can be modified according to the desired requirements of either structural or non-structural composites. Similarly, the herein provided processing methods can be customized to satisfy global warming potential (GWP) requirements. For example, introducing 10 wt % Ulva prepared with self-bonding preprocess at a water-to-cement ratio of 0.4, the product reaches a 28-day compressive strength of 33.04 MPa, satisfying the requirements from ASTM C150 while also showing a 9.5% reduction in GWP compared to conventional Portland cement (the control that is provided in the first line of Table 1).

TABLE 1
Formula and properties of algae-based cement composites

| | | Biomass | | | D 28 Comp. | | GWP (kg | |
|---|---|---|---|---|---|---|---|---|
| | | conc. | | Density | strength | D 28 E | CO₂eq/kg | GWP_biocement/ |
| Biomass | Preprocess | (%) | w/c | (g/cm³) | (MPa) | (GPa) | composite) | GWP_PC |
| None | NA | 0 | 0.4 | 1.785 | 57.18 | 0.89 | 0.67797 | 1.000 |
| Chlorella | NA | 1 | 0.4 | 1.705 | 29.91 | 0.50 | 0.66905 | 0.987 |
| Chlorella | NA | 5 | 0.4 | 1.434 | 5.55 | 0.22 | 0.63289 | 0.934 |
| Chlorella | NA | 10 | 0.4 | 1.410 | 8.10 | 0.29 | 0.55267 | 0.815 |
| Spirulina | NA | 1 | 0.4 | 1.851 | 55.02 | 0.71 | 0.66896 | 0.987 |
| Spirulina | NA | 5 | 0.4 | 1.376 | 7.92 | 0.34 | 0.63294 | 0.934 |
| Spirulina | NA | 10 | 0.5 | 1.167 | 3.62 | 0.20 | 0.55294 | 0.816 |
| Ulva | NA | 1 | 0.4 | 1.783 | 46.29 | 0.77 | 0.66905 | 0.987 |
| Ulva | NA | 5 | 0.4 | 1.725 | 40.48 | 0.60 | 0.63293 | 0.934 |
| Ulva | NA | 10 | 0.5 | 1.501 | 15.66 | 0.46 | 0.55308 | 0.816 |
| Spirulina | Self- | 1 | 0.4 | 1.698 | 29.42 | 0.64 | 0.67530 | 0.996 |
| | bonding | | | | | | | |
| Spirulina | Self- | 5 | 0.4 | 1.413 | 6.73 | 0.27 | 0.66450 | 0.980 |
| | bonding | | | | | | | |
| Spirulina | Self- | 10 | 0.5 | 1.224 | 5.81 | 0.21 | 0.61322 | 0.905 |
| | bonding | | | | | | | |
| Ulva | Self- | 1 | 0.4 | 1.791 | 52.62 | 0.67 | 0.67530 | 0.996 |
| | bonding | | | | | | | |
| Ulva | Self- | 5 | 0.4 | 1.838 | 49.09 | 0.58 | 0.66446 | 0.980 |
| | bonding | | | | | | | |
| Ulva | Self- | 10 | 0.5 | 1.634 | 33.04 | 0.59 | 0.61334 | 0.905 |
| | bonding | | | | | | | |
| Spirulina | Hot-water | 5 | 0.4 | 1.506 | 17.41 | 0.30 | 0.67565 | 0.997 |
| | extraction | | | | | | | |
| Ulva | Hot-water | 5 | 0.4 | 1.800 | 42.30 | 0.57 | 0.67571 | 0.997 |
| | extraction | | | | | | | |
| Spirulina | Cold- | 5 | 0.4 | 1.550 | 6.37 | 0.23 | 0.63908 | 0.943 |
| | water | | | | | | | |
| | extraction | | | | | | | |
| Ulva | Cold- | 5 | 0.4 | 1.730 | 30.81 | 0.62 | 0.63922 | 0.943 |
| | water | | | | | | | |
| | extraction | | | | | | | |

The number of GWP (kg CO₂eq/kg composite) in Table 1 is calculated for the hardened composite at selected water-to-cement ratio. The assumptions of the calculation shown are as follows:
The transportation from the location of raw material collection site to manufacturing site is neglected for biomass, based on the assumption that they can be grown in-house (this can be modified).
The mixing process (conversion from powder to slurry form) is assumed to consume the same energy as mixing concrete. (This assumption can be refined based on the mixing condition or viscosity later).
For hardened ordinary Portland cement, the mixing is assumed to be completed in central mix plant.
For curing, assuming no CO₂ generated at 50% RH, and 1 g of sample requires 1 g of water to cure at 100% RH. The same CO₂ is required to cure 1 g of sample at 0% RH than at 100% RH (this is the strongest assumption and could be revisited). The equation for kgeCO₂/kg dry composites for curing is “mu_curing=2*mu_water*np.abs(RH_perc/100−0.5)”, where mu_water is 0.4e-3 kgeCO₂/kg water
Assume after 28-day curing process, the composite loses 10% of water, this will affect the weight and volume of slurry (liquid phase).
Assume the volume of slurry is the sum of each component's volume. (This may contribute to the mixing energy if the unit of energy is kWh/m³ wet material, currently used kWh/m³ dry composites.)
The energy for grinding is calculated from equation: E[kJ/g]=Wi*10*(1/np.sqrt(P80)−1/np.sqrt(F80)), where Wi=0.42 kJ/g is the work index, P80 [um], product 80% target particle size, F80 [um] feed 80% (Ngamnikom & Songsermpong, J Food Engin. 104(4):632-638, 2011). The P80 target particle size for all grinding process here is 8.51.
For all energy conversion factor to CO₂ is 0.12 g CO₂/kJ

### (VI) Uses, Including Environmental Benefits

The biological cement compositions provided herein can be used in place of traditional cement (e.g., in place of Portland cement), or as a component mixed in with traditional cement. Thus, the biological cements provided herein are useful in making concrete, mortar, and so forth. As described, the characteristics (e.g., compressive strength, density, and so forth) of biological cement can be selected (tuned) by altering the biological component (source, amount, and/or preparation processing step(s)), in order to provide biological cement (biocement) useful in specific end products.

Environmental benefits of using algal biomass in cements: Using algal biomass in different forms as addition(s) in cements can be used to reduce the environmental impact of conventional Portland cement. According to literature, ordinary Portland cement from cradle to gate, including materials collection, transportation to cement plants, and the manufacturing of cement powder at plant, emits 0.92 to 1 kg CO₂eq/kg cement. By incorporating algal biomass, which stores carbon through photosynthesis, the processes and products described herein show lower global warming potential (GWP) than the conventional Portland cement by 2 to 18%. Here, the GWP improvement is demonstrates in the relative percentage as “GWP_biocement/GWP_PC” rather than the GWP (kg CO₂eq/kg) value, as it emphasizes the improvement better. Refer to Table 1 above, for the corresponding analysis.

The Exemplary Implementations and Examples below are included to demonstrate particular implementations of the disclosure. Those of ordinary skill in the art should recognize in light of the present disclosure that many changes can be made to the specific implementations disclosed herein and still obtain a like or similar result without departing from the spirit and scope of the disclosure. At least some of the subject matter described in the Example(s) was published on or around May 23, 2023, as Lin et al., ACS Sustainable Chem Eng. 11:8242-8254, 2023 (including supporting information online at pubs.acs.org/doi/10.1021/acssuschemeng.2c07539).

### (VII) Exemplary Implementations

First Set of Exemplary Implementations:

1. A method of preparing a biological cement, the method including: forming a biological cement paste by mixing dry matter and water, wherein the dry matter includes 0.5 wt % to 15 wt % algal biomatter per dry matter and cement; pouring the biological cement paste into a mold; and forming a biological cement by curing the biological cement paste.

2. The method of embodiment 1, wherein the mixing includes homogenizing the dry matter and water by hand mixing, stirring, or planetary mixing.

3. The method of embodiments 1 or 2, wherein the mixing includes mixing at 100-5000 rpm.

4. The method of any of embodiments 1-3, wherein the algal biomatter includes at least one of Chlorella, Spirulina, Saccharina latissima, or Ulva lactuca.

5. The method of any of embodiments 1-4, wherein the biological cement paste includes 3 wt % to 15 wt % algal biomatter per dry matter.

6. The method of any of embodiments 1-5, wherein the biological cement paste includes 10 wt % to 15 wt % algal biomatter per dry matter.

7. The method of any of embodiments 1-6, wherein the biological cement paste includes a water to cement ratio of 0.35 to 0.5.

8. The method of any of embodiments 1-7, wherein the biological cement paste includes 20 wt % to 40 wt % water.

9. The method of any of embodiments 1-8, wherein the biological cement paste includes 20 wt % to 33 wt % water.

10. The method of any of embodiments 1-9, wherein the biological cement paste includes 55 wt % to 80 wt % cement.

11. The method of any of embodiments 1-10, wherein the biological cement paste includes 55 wt % to 74 wt % cement.

12. The method of any of embodiments 1-11, wherein the cement includes tricalcium silicate, dicalcium silicate, tricalcium aluminate, tetracalcium aluminoferrite, and gypsum.

13. The method of embodiment 12, wherein the cement includes 25-50% tricalcium silicate, 20-45% dicalcium silicates, 5-12% tricalcium aluminate, 6-12% tetracalcium aluminoferrite, and 2-10% gypsum, wherein the sum total does not exceed 100%.

14. The method of any of embodiments 1-13, further including agitating the biological cement paste within the mold.

15. The method of embodiment 14, wherein the agitating removes voids within the biological cement paste.

16. The method of embodiment 15, wherein the voids include air bubbles or water bubbles.

17. The method of any of embodiments 14-16, wherein the agitating includes vibrating.

18. The method of embodiment 17, wherein the vibrating includes using an immersion vibrator, a surface vibrator, or a form vibrator.

19. The method of any of embodiments 1-18, wherein the curing includes drying.

20. The method of any of embodiments 1-19, wherein the curing includes incubating in a humidity chamber at 50% to 100% relative humidity.

21. The method of embodiment 20, wherein the curing includes incubating in a humidity chamber at 90% relative humidity.

22. The method of any of embodiments 1-19, wherein the curing includes incubating at ambient conditions.

23. The method of embodiment 22, wherein the ambient conditions include a temperature ranging from 20° C. to 30° C.

24. The method of embodiment 23, wherein the ambient conditions include a temperature of 25° C.

25. The method of any of embodiments 22-24, wherein the ambient conditions includes a relative humidity of 30-50% relative humidity.

26. The method of any of embodiments 1-25, wherein the curing includes applying water to the biological cement paste.

27. The method of any of embodiments 1-26, wherein the algal biomatter is dried.

28. The method of any of embodiments 1-27, wherein the algal biomatter is a powder.

29. The method of any of embodiments 1-28, wherein the cement is a powder.

30. A biological cement including dry matter and water, wherein the dry matter includes 0.5 wt %-15 wt % algal biomatter and cement made by the method of any of embodiments 1-29.

31. The biological cement of embodiment 30, including 3 wt % to 15 wt % algal biomatter per dry matter.

32. The biological cement of embodiments 30 or 31, wherein the biological cement has a mechanical property that is within 5% to 110% of a mechanical property of cement.

33. The biological cement of any of embodiments 30-32, wherein the biological cement has a mechanical property that is within 90% to 110% of a mechanical property of cement.

34. The biological cement of embodiment 33, wherein the mechanical property includes compressive strength.

35. The biological cement of embodiments 33 or 34, wherein the mechanical property of cement includes a compressive strength of 5-70 MPa according to compression tests 28 days after forming.

36. A composition of biological cement including dry matter and water, wherein the dry matter includes 0.5 wt %-15 wt % algal biomatter and cement.

37. The composition of embodiment 36, wherein the algal biomatter includes at least one of Chlorella, Spirulina, Saccharina latissima, or Ulva lactuca.

38. The composition of embodiments 36 or 37, wherein the biological cement includes 3 wt % to 15 wt % algal biomatter per dry matter.

39. The composition of any of embodiments 36-38, wherein the biological cement paste includes 10 wt % to 15 wt % algal biomatter per dry matter.

40. The composition of any of embodiments 36-39, wherein the biological cement includes a water to cement ratio of 0.35 to 0.5.

41. The composition of any of embodiments 36-40, wherein the biological cement includes 20 wt % to 35 wt % water.

42. The composition of any of embodiments 36-41, wherein the biological cement includes 20 wt % to 33 wt % water.

43. The composition of any of embodiments 36-42, wherein the biological cement includes 55 wt % to 75 wt % cement.

44. The composition of any of embodiments 36-43, wherein the biological cement includes 55 wt % to 73 wt % cement.

45. The composition of any of embodiments 36-44, wherein the cement includes tricalcium silicate, dicalcium silicate, tricalcium aluminate, tetracalcium aluminoferrite, and gypsum.

46. The composition of embodiment 45, wherein the cement includes 25-50% tricalcium silicate, 20-45% dicalcium silicates, 5-12% tricalcium aluminate, 6-12% tetracalcium aluminoferrite, and 2-10% gypsum, wherein the sum total does not exceed 100%.

47. The composition of any of embodiments 36-46, wherein the algal biomatter is dried.

48. The composition of any of embodiments 36-47, wherein the algal biomatter is a powder.

49. The composition of any of embodiments 36-48, wherein the cement is a powder.

50. A method of tuning the mechanical properties of the biological cement of any of embodiments 30-35 including dry matter and water, wherein the dry matter includes algal biomatter and cement, the method including:

varying the amount of algal biomatter or varying the type of algal biomatter.

51. The method of embodiment 50, wherein the amount of algal biomatter ranges from 0.5 wt % to 15 wt % algal biomatter per dry matter.

52. The method of embodiments 50 or 51, wherein the amount of algal biomatter ranges from 3 wt % to 15 wt % algal biomatter per dry matter.

53. The method of any of embodiments 50-52, wherein the amount of algal biomatter ranges from 10 wt % to 15 wt % algal biomatter per dry matter.

54. The method of any of embodiments 50-53, wherein the type of algal biomatter is selected from at least one of Chlorella, Spirulina, Saccharina latissima, or Ulva lactuca.

55. A mortar including the composition of any of embodiments 36-49.

56. A concrete including the composition of any of embodiments 36-49.

57. A method as substantially described herein.

58. A material as substantially described herein.

59. A composition as substantially described herein.

60. A system as substantially described herein.

Second Set of Exemplary Implementations:

1. A method of preparing a biological cement product, the method including: forming a biological cement paste by mixing dry matter and water, wherein the dry matter includes: 0.5 wt % to 15 wt % algal biomatter per dry matter; and cement; pouring the biological cement paste into a mold; and curing the biological cement paste, thereby forming the biological cement product; wherein the algal biomatter includes at least one of a Saccharina sp. or an Ulva sp.

2. The method of embodiment 1, wherein the algal biomatter includes at least one of Chlorella, Spirulina (Arthrospira platensis), Saccharina latissima, Ulva lactuca, Ulva expensa, Agarophyton, Sargassum, Gracilaria parvispora, Halymenia hawaiiana or Caulerpa lentillifera.

3. The method of embodiment 1, wherein the biological cement paste includes: 3 wt % to 15 wt % algal biomatter per dry matter; or 10 wt % to 15 wt % algal biomatter per dry matter.

4. The method of embodiment 1, wherein the biological cement paste includes a water to cement ratio of 0.35 to 0.5.

5. The method of embodiment 1, wherein the biological cement paste includes one or more of: 20 wt % to 40 wt % water; 20 wt % to 33 wt % water; 55 wt % to 80 wt % cement; or 55 wt % to 74 wt % cement.

6. The method of embodiment 1, wherein the cement includes: tricalcium silicate, dicalcium silicate, tricalcium aluminate, tetracalcium aluminoferrite, and gypsum.

7. The method of embodiment 6, wherein the cement includes: 25-50% tricalcium silicate, 20-45% dicalcium silicates, 5-12% tricalcium aluminate, 6-12% tetracalcium aluminoferrite, and 2-10% gypsum, wherein the sum total does not exceed 100%.

8. The method of embodiment 1, wherein the dry matter further including one or more of: construction aggregate, limestone, nanoclay, non-algal biomatter, an inorganic polymer, an organic polymer, a salt, a hardening agent, a hardening-retarding agent, a colorant, a water-repelling chemical, an air-entraining agent, a corrosion inhibitor, a glue, a resin, or a self-bonding agent.

9. The method of embodiment 1, wherein the curing includes drying.

10. The method of embodiment 1, wherein the curing includes one or more of: incubating at 50% to 100% relative humidity; incubating at 90% relative humidity; and/or incubating at ambient conditions.

11. The method of embodiment 10, wherein the ambient conditions include: a temperature ranging from 20° C. to 30° C.; or a temperature of 25° C.

12. The method of embodiment 10, wherein the ambient conditions includes a relative humidity of 30-50% relative humidity.

13. The method of embodiment 1, wherein one or more of: the curing includes applying additional water to the biological cement paste; at least a portion of the algal biomatter is dried; at least a portion of the algal biomatter has been preprocessed by hot water extraction; at least a portion of the algal biomatter has been preprocessed by cold water extraction; at least a portion of the algal biomatter has been preprocessed by self-bonding; at least a portion of the algal biomatter is formulated as a bioplastic; at least a portion of the algal biomatter is a powder; and/or at least a portion of the cement is a powder.

14. A biological cement including dry matter and water, wherein the dry matter includes: 0.5 wt %-15 wt % algal biomatter per dry matter including at least one of a Saccharina sp. or an Ulva sp.; and cement.

15. The biological cement of embodiment 14, made by a method including: forming a biological cement paste by mixing dry matter and water, wherein the dry matter includes 0.5 wt % to 15 wt % algal biomatter per dry matter and cement; pouring the biological cement paste into a mold; and curing the biological cement paste, thereby forming the biological cement.

16. The biological cement of embodiment 14, wherein the algal biomatter includes at least one of Chlorella, Spirulina (Arthrospira platensis), Saccharina latissima, Ulva lactuca, Ulva expensa, Agarophyton, Sargassum, Gracilaria parvispora, Halymenia hawaiiana or Caulerpa lentillifera.

17. The biological cement of embodiment 14, wherein the biological cement has at least one mechanical property that is: within 5% to 110% of the same mechanical property of cement; or within 90% to 110% of the same mechanical property of cement.

18. A building product including the biological cement of embodiment 14, which building product is a mortar or a concrete.

19. A method of tuning one or more mechanical properties of a biological cement including dry matter and water, wherein the dry matter includes algal biomatter and cement, the method including one or more of: varying an amount of algal biomatter; varying a type of algal biomatter; and/or varying a preprocessing/pretreatment of the algal biomatter.

20. The method of embodiment 19, wherein one or more of: the amount of algal biomatter ranges from 0.5 wt % to 15 wt % algal biomatter per dry matter; the amount of algal biomatter ranges from 3 wt % to 15 wt % algal biomatter per dry matter; the amount of algal biomatter ranges from 10 wt % to 15 wt % algal biomatter per dry matter; and/or the type of algal biomatter includes at least one of Chlorella, Spirulina (Arthrospira platensis), Saccharina latissima, Ulva lactuca, Ulva expensa, Agarophyton, Sargassum, Gracilaria parvispora, Halymenia hawaiiana or Caulerpa lentillifera.

### (VIII) Experimental Examples

### Example 1: Long-Term Hindrance Effects of Algal Biomatter on the Hydration Reactions of Ordinary Portland Cement

The incorporation of carbon-fixing materials such as photosynthetic algae in concrete formulations offers a promising strategy toward mitigating the concerningly high carbon footprint of cement. Prior literature suggests that the introduction of up to 0.5 wt % Chlorella biological matter (biomatter) in ordinary Portland cement induces a retardation of the composite cement's strength evolution while enabling a long-term compressive strength comparable to pure cement at a lower carbon footprint. This work provides insights into the fundamental mechanisms governing this retardation effect and reveal a concentration threshold above which the presence of biomatter completely hinders the hydration reactions.

Chlorella or Spirulina, two algal species with different morphology and composition, was incorporates in (mixed with) ordinary Portland cement at concentrations ranging between 0.5 and 15 wt % and study the evolution of mechanical properties of the resulting biocomposites over a period of 91 days. The compressive strength in both sets of biocomposites exhibits a concentration-dependent long-term drastic reduction, which plateaus at 5 wt % biomatter content. At and above 5 wt %, all biocomposites show a strength reduction of more than 80% after 91 days of curing compared to pure cement, indicating a permanent hindrance effect on hardening. Characterization of the hydration kinetics and the cured materials shows that both algal biomatters hinder the hydration reactions of calcium silicates, preventing the formation of calcium hydroxide and calcium silicate hydrate, while the secondary reactions of tricalcium aluminate that form ettringite are not affected.

It is proposed that the alkaline conditions during cement hydration lead to the formation of charged glucose-based carbohydrates, which subsequently create a hydrogen bonding network that ultimately encapsulates calcium silicates. This encapsulation prevents the formation of primary hydrate products and thus blocks the hardening of cement. Furthermore, new hydration products were observe with composition and micromorphology deviating from the expected hardened cement compounds. The analysis provides fundamental insights into the mechanisms that govern the introduction of two carbon-negative algal species as fillers in cement, which are crucial for enabling strategies to overcome the detrimental effects that those fillers have on the mechanical properties of cement.

### Materials and Methods

Materials. Commercially available Type I/II Portland cement (SAKRETE, Charlotte, NC, USA), abiding by ASTM c150,⁴⁵ was used as the conventional cement matrix. The chemical composition of the Portland cement is shown in Table 2. Chlorella and Spirulina powders were purchased from Nuts.com (Cranford, NJ, USA). The moisture content of Chlorella and Spirulina powders was measured in the range of 6-8 wt % of the biomatter with a moisture analyzer (VWR-53M.H, VWR, Radnor, PA, USA).

TABLE 2
Oxide Content (wt %) of Type I/II Portland
Cement Used in This Example

| CaO | SiO₂ | SO₃ | Al₂O₃ | MgO | Fe₂O₃ | K₂O | Na₂O |
|---|---|---|---|---|---|---|---|
| 67.14 | 14.00 | 9.68 | 3.51 | 1.70 | 2.81 | 0.89 | 0.28 |

Sample Preparation. Biomatter powder was premixed with cement powder at concentrations of 0.5%, 1%, 5%, 10%, and 15% by weight of total dry mass using a speedmixer (SpeedMixer DAC 330-100 PRO, FlackTek, Landrum, SC, USA) operating at 1500 rpm for 30 s. Next, deionized water was progressively added to the mix to produce pastes which were further homogenized in the same mixer (operating at 1500 rpm for a total of 180 s with three 15 s breaks every 45 s). All the cement pastes were prepared at a fixed water-cement ratio (w/c) of 0.4. Note that, in order to keep only the essential components of this mix and avoid unexpected interactions, no water reducing admixtures were added to the pastes. Then, the mixed fresh pastes were cast into rubber molds to produce cubic samples with nominal dimensions of 10×10×10 mm3. The cast slurries were rodded on a vibration table (No. 1A vibrator, Buffalo Dental Manufacturing Co. Inc., Syosset, NY, USA) to eliminate macroscopic air bubbles. After casting, the fresh samples were sealed with plastic films and placed in a moisture-controlled chamber to cure at 90±5% RH and 23±1° C. for 24 h before demolding. A pure cement (PC) sample at w/c 0.4 was made with the same procedure as a reference in comparison to the cement-Chlorella composites (CCs) and cement-Spirulina composites (CSs) at varying algal concentrations. Throughout this Article, samples are labeled to reflect their components and concentrations. For example, CS-0.5 corresponds to the cement-Spirulina composition at 0.5 wt % Spirulina and CC-5, to cement-Chlorella at 5 wt % Chlorella.

Compression Tests. Compression testing (see Figure S1a of Lin et al., ACS Sustainable Chem Eng. 11:8242-8254, 2023) was performed on a minimum of 5 samples for each mixture after 3, 7, 14, 28, or 91 days of curing using a universal test frame (Autograph AGS-X 10 kN, Shimadzu Scientific Instruments, Columbia, MD, USA) equipped with a 5 kN load cell. The cubic samples were compressed at a constant stress rate in accordance with ASTM C109/C109 M.⁴⁶ The stress, σ, was calculated from σ=F/A, where F is the measured force and A is the cross-sectional area. The compressive strain was calculated as ϵ=d/H, where d is displacement and H is the initial sample height. Maximum compressive strength is obtained from the stress-strain curve, as the maximum stress value withstood by the samples prior to fracture.

Scanning Electron Microscopy (SEM) and Energy-Dispersive X-ray Spectroscopy (EDS). Samples were coated with 4 nm of platinum in a sputter coater (SC7620, Quorum Technologies, Lewes, U.K.) and imaged with SEM (JSM-6010 Plus, JEOL, Peabody, MA, USA) at an accelerating voltage of 10 kV. Samples for EDS were coated with 4 nm of gold in a sputter coater (108 Manual, Ted Pella, Redding, CA) and detected with SEM (Phenom ProX Desktop SEM, Thermo Fisher Scientific, Waltham, MA, USA) at an accelerating voltage of 10 kV. For the powders, particle size analysis from the acquired images was conducted using ImageJ.⁴⁷

Isothermal Calorimetry (IC). The early stage hydration kinetics were monitored in an isothermal calorimeter (TAM air; TA Instruments, New Castle, DE, USA). Using the 20 mL admix ampules, the heat generated by the hydration reactions was measured at a constant temperature of 24° C. starting from the instant of water-cement contact through the mixing and hardening process until day 7. Quantities related to heat were normalized by the mass of solid powders (cement and biomatter).

Thermogravimetric Analysis (TGA). Samples of 5-8 mg were heated in platinum crucibles from ambient temperature to 1000° C. in a TGA instrument (D550, TA Instruments, New Castle, DE, USA) under a 20 mL/min flow of nitrogen gas. The temperature was first increased to 140° C. at a heating rate of 10° C./min and was kept constant for 30 min to evaporate the absorbed water in samples and was subsequently increased to 1000° C. at a rate of 10° C./min.

X-ray Diffraction (XRD). The X-ray diffraction measurement was conducted using a D8 Advance XRD, Bruker, Billerica, MA, USA with Cu Kα X-ray radiation (wavelength 1.5406 Å). The diffraction patterns were measured in the range 5°-70° 2θ with a step size of 0.02° and a collection of 0.07 s/step. The XRD analysis was done using the MDI-500 library (JADE 8.3, Materials Data, Livermore, CA).

Fourier Transform Infrared Spectroscopy (FTIR). Samples were analyzed in an FTIR spectrometer (Nicolet is10 FT-IR; Thermo Fisher Scientific, Waltham, MA, USA) in attenuated total reflection (ATR) mode. The scanning region was set in the range of 7800-350 cm-1 with a resolution of 2 cm-1 over 64 runs.

### Results and Discussion

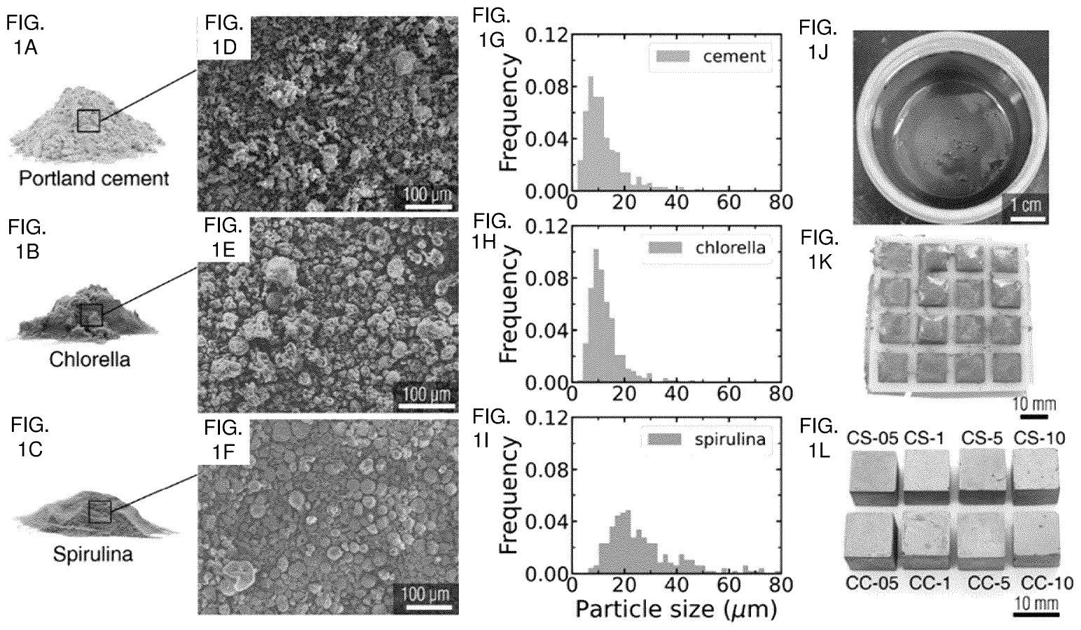

FIGS. 1A-1L illustrates morphological features of the raw Chlorella and Spirulina cells as well as cement, along with the sample fabrication process. SEM images reveal that the cement particles have a size distribution of 5-20 μm (see FIGS. 1D, 1G) with a mean particle size of 13 μm. Chlorella, being a unicellular algae, grows in individual cells which obtain a circular shape and do not form tissues. The dehydrated Chlorella cells can form aggregates with sizes ranging between 10 and 20 μm (FIGS. 1E, 1H), while when in the hydrated state, the average particle size of individual cells is 3.7±0.9 μm. Spirulina cells, on the other hand, form chains with length of 6-30 μm and width of 6.8±0.8 μm in the hydrated state, which give rise to aggregates of 20-40 μm in the dried state (FIGS. 1F, 1I). As presented in FIGS. 1J-1L, the samples containing the target amount of biomatter were mixed into pastes with cement and water, which were subsequently molded into cubic shapes for further analysis.

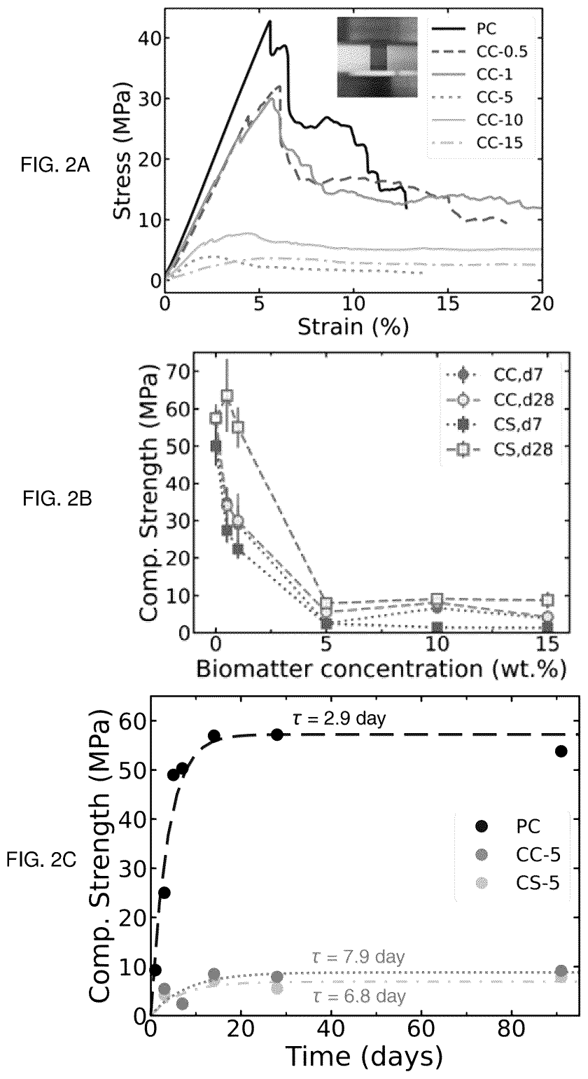

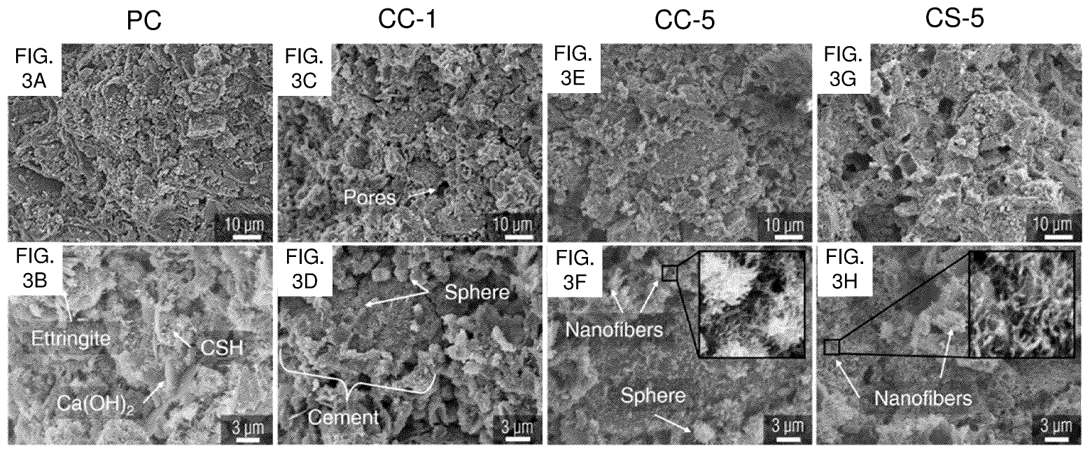

Effects of Biomatter on Compressive Strength. The effects of each type of biomatter was assess on the mechanical properties of cement through quasi-static compression tests at different ages, as shown in FIG. 2. The stress-strain curves of hardened Portland cement and cement-Chlorella composites with different concentrations of Chlorella (FIG. 2A) show an initial linear stress increase, followed by a quasi-brittle fracture as cracks develop in the samples. The same behavior is also found in the Spirulina composites (see Figure S1b of Lin et al., ACS Sustainable Chem Eng. 11:8242-8254, 2023). As anticipated, the incorporation of the soft algal biomatter results in reductions of both the compressive strength and Young's modulus of the composites, which are found to decrease with increasing filler (biomatter) content.

In FIG. 2B, the maximum compressive strength of the described composites is compared at varying concentrations of biomatter (Spirulina and Chlorella), tested at day 7 and 28. For both sets of composites, the compressive strength first rapidly decreases with increasing algae concentration, before reaching a low-strength plateau at around 5 wt %. The introduction of 0.5 wt % of either Chlorella or Spirulina leads to reductions of 7-day compressive strength by 31% and 46%, respectively, compared to pure cement. Upon further increasing the biomatter content to 1 wt %, the 7-day strength of the composites slightly decreases from 34.7 to 28.9 MPa for Chlorella and from 27.4 to 22 MPa for Spirulina. Increasing the content of algal biomatter to 5 wt % drastically decreases the 7-day compressive strength of both cement-Chlorella and cement-Spirulina composites to around 2.5 MPa (corresponding to a 95% reduction compared to pure cement), suggesting a clear decay of early strength with increasing concentration.

Although the effects of adding Chlorella and Spirulina are identical at early ages, the two composites show different performances after longer curing times. At low concentrations, the compressive strength of the Spirulina composites increases over time, while the Chlorella composites show no strength growth. The 28-day strength of 0.5 and 1 wt % Spirulina composites increases to more than 55 MPa (more than 2-fold increase compared to 7-day strength), reaching the same values as pure cement. Similarly, at higher concentrations, the compressive strength values of composites with 5-15 wt % Spirulina increase about 3-fold (from 2 to ˜8 MPa) from day 7 to day 28. This result indicates differences in the nucleation and growth-rate kinetics and aging mechanisms at low amounts of Chlorella and Spirulina, which are more pronounced at later ages. The effects of functional groups and biopolymer composition on the difference of strength evolution between Chlorella and Spirulina composites is a topic for future investigation.

Still, in both types of microalgae, the drastic reduction of compressive strength with increasing concentration suggests different hydration reactions between composites containing low (0.5-1 wt %) and high (>5 wt %) concentrations of algal biomatter. To further investigate the mechanisms causing such a significant change in the mechanical performance of the provided composites, the following part of this study focuses on analyzing the structure and properties of composites containing 5 wt % of either Chlorella or Spirulina, as this concentration was the identified behavioral threshold in both systems.

To monitor the strength evolution over time, Chlorella and Spirulina composites at 5 wt % biomatter concentration were, respectively, tested in compression on day 3, 7, 14, 28, and 91. In FIG. 2C, the strength evolution of pure cement and the two sets of composites are presented. The strength of the composites increases most prominently from day 3 to 14, varying from 2.5 to 7.2 MPa for Chlorella composites and from 2.4 to 8.4 MPa for Spirulina composites. These strength values then remained approximately constant until day 91.

Compared to pure cement samples, whose strength increases from 50% of full strength on day 3 (25 MPa) to 86% on day 7 (50.3 MPa), not only the final strength of the composites is notably lower but also the strength evolution is slower as it increases from 30% of full strength to 90% from day 7 to 14. An exponential expression is proposed to quantitatively assess the characteristic evolution time for the compressive strength of the described biomatter composites:

σ(t)=σt(1−e^{-t/τ}) (1)

In eq 1, σf (MPa) corresponds to the final (plateau) strength and τ (days) is the characteristic evolution time, representing the required time of strength to reach a plateau. The fitting parameters (σf and τ) were computed using the least-square method, and the corresponding curves are presented as dashed lines in FIG. 2C. By means of comparison, a τ value of 3.8 days was found for the pure cement versus 6.8 days for the Chlorella composites and 7.9 days for the Spirulina composites. While the difference in τ shows a delay in strength evolution for the composites, the large difference in final strength, σf, between either composites and the pure cement suggests fundamentally different cement-microalgae interactions than the pure retardation effect previously reported in the literature.⁴⁴ In this study, unprocessed algae cells of defined particle size and native composition were use (discussed in detail in the following sections), while in prior literature⁴⁴ the Chlorella filler was previously pressed in pellets (may or may not contain additives) and then mechanically ground into powder; both processing steps might lead to altered composition and substantially reduced surface area compared to the raw algal biomatter.

Effects of Biomatter on the Micromorphology of Hardened Cement. To investigate the distribution of algal biomatter filler in the cement matrix and the biomatter-cement interactions, the optical microscopy and SEM images of the biocomposite microstructures were analyze on day 7 and 28.

Based on macroscopic and optical microscopy images (reported in Figures S2a,S2b of Lin et al., ACS Sustainable Chem Eng. 11:8242-8254, 2023), an increasing size and number of voids (size range tens of μm) was visually observed at the surfaces of samples with increasing concentrations of algal biomatters. While such micropores may act as structural defects leading to a mechanical embrittlement, the strength of cements is generally tightly dictated by the density and interconnection of hydration products⁴.

From SEM images, it was observed that the microstructure of pure cement becomes highly dense by day 7 with the anticipated continuous growth of hydration products (FIGS. 3A, 3B), as corroborated by its strength value of 86% of the final strength which indicates the nearly plateaued hydration reactions. The micrographs reveal that the calcium hydroxide (Ca(OH)₂, also called portlandite) platelets as well as ettringite (Ca₆Al₂(SO₄)₃(OH)₁₂·26H₂O) prisms are well dispersed within the hydrated matrix. The length of ettringite prisms is 0.8-1.7 μm, in agreement with observations that ettringite grows to lengths 1-5 μm at low water-to-cement ratios (w/c<0.5).^{48,49} The nanoscale tapered fibers covering the cement particles' surface are amorphous calcium silicate hydrate (C—S—H) with lengths 200-400 nm, which can be attributed to the fibrous Type-1 C—S—H described by Jennings et al.⁵⁰

Upon the introduction of algal biomatter, even at only 1 wt % Chlorella, fewer Ca(OH)₂ platelets and ettringite prisms are found in the composites (FIGS. 3C, 3D), and they are almost eliminated at the 5 wt % filler content (FIGS. 3E, 3F). The higher magnification views reveal nanofibers with a consistent length of ˜500 nm, covering the composite matrix surface. These nanofibers grow radially outward from the smooth inner cement particle surface. Even though the size of the discovered nanofibers is close to the amorphous C—S—H fibrils found in pure hardened cement, their distribution is significantly different, resulting in a different morphology than pure cement, which suggests that the nanofibers seen in the composites may not be composed of C—S—H. Moreover, in the Chlorella 1 wt % composites besides the nanofibers, the formation of distinct interconnected microspheres, 3-5 μm in diameter, was also observed matching the average cell size. The similarity in shape and size between these microspheres and the Chlorella cells suggest that chemical interactions between the biomatter surface and the cement colloid may occur, which lead to the formation of the observed shells of nanofibers covering the biomatter and anhydrated cement particles and nanofiber clusters, which are observed between anhydrated cement. Finally, both the 1 and 5 wt % Chlorella composites have a notably higher porosity than pure cement, which supports their reduced strength. In contrast, the C—S—H nanofibers in pure cement form a dense coating surrounding the cement particles, which they are grown from, and bridge the gaps between the unreacted particles and other reaction products (Ca(OH)₂ and ettringite), ultimately generating a dense interconnected matrix.

The SEM images (FIGS. 3G, 3H) also reveal that the Spirulina composite surfaces are coated by clearly more nanofibers when compared to the Chlorella composite surfaces, which supports the 43% higher compressive strength of the 5 wt % Spirulina composites compared to the Chlorella. In addition, macroscopic pores of 10 to 30 μm are more prevalent in the Spirulina composites while smaller pores between 2 and 10 μm are noted in the Chlorella composites. This finding aligns with the larger cavities (10-50 μm) on the surface of Spirulina composites (see Figure S2g, S2h of Lin et al., ACS Sustainable Chem Eng. 11:8242-8254, 2023), while larger numbers of smaller pores are found in the composites with higher biomatter concentrations (Figure S3a, S3b of Lin et al., ACS Sustainable Chem Eng. 11:8242-8254, 2023). These larger pores in Spirulina composites are consistent with the larger size of the Spirulina aggregates reported from the particle size analysis of the dry powders (see FIG. 1C), highlighting the connection between the formed pores and the cell size.

As algal cells dehydrate, losing the bound water over time, it is expected that the difference between the hydrated versus dried volume of the cells should be reflected in the shrinkage and apparent density of the samples. To quantify these changes, the overall shrinkage and apparent density of the composite cements was characterized over time. The addition of Chlorella and Spirulina at low concentrations reduces the shrinkage of samples (see Supplementary text and Figure S3c,S3d of Lin et al., ACS Sustainable Chem Eng. 11:8242-8254, 2023). At day 28, PC samples had shrunk by 0.3%, whereas CC-1 and CS-1, respectively, shrunk by 0.2% and 0.25%, suggesting the biomass slowly releases water over time and stabilizes the bulk volume. Such a slow water release might have a beneficial internal curing effect, enabling a prolonged period of water accessible to the hydrating cement particles and thereby leading to higher final strengths. However, strength measurements did not suggest strength improvement, implying that internal curing does not take place in the described composites. At higher filler concentrations, samples were too weak to allow precise shrinkage measured over time. Apparent density measurements were used to assess water evaporation of the composites. Indeed, the decreasing apparent density with increasing biomatter concentrations (Figure S3e of Lin et al., ACS Sustainable Chem Eng. 11:8242-8254, 2023) not only account for the lower density of algal biomatter (1.3 g/cm³) but also suggest a facilitation of water evaporation at high biomatter concentrations (for calculations of evaporated water, see the discussion in the SI). For example, when more than 5 wt % algae is introduced, the apparent density of biocomposites at day 28 is as low as the theoretical density prediction from eq 5 in the SI, when assuming 100% water evaporation. This drastic water evaporation over time suggests that, in those biocomposites, water only marginally participates to the hydration process, leading to the weak mechanical properties and distinct porous microstructure aforementioned. Next, the hydration reaction is studied more in depth.

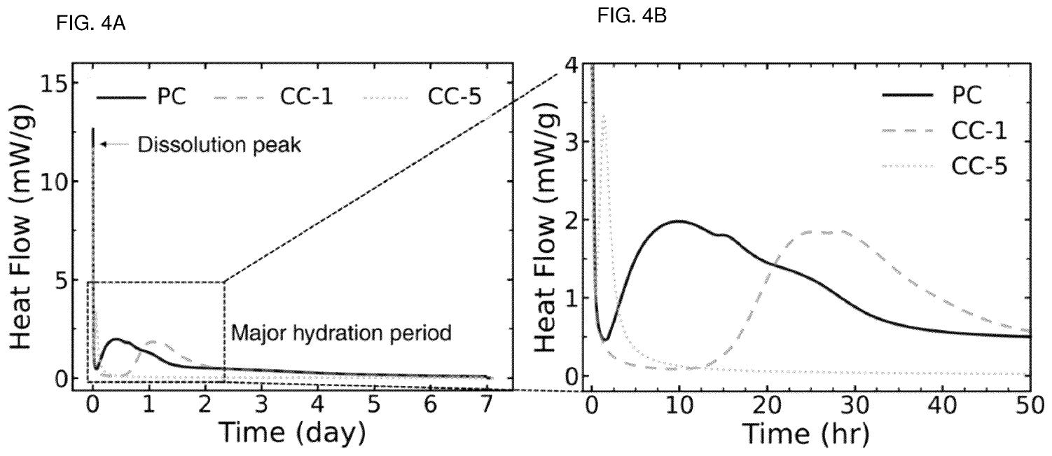

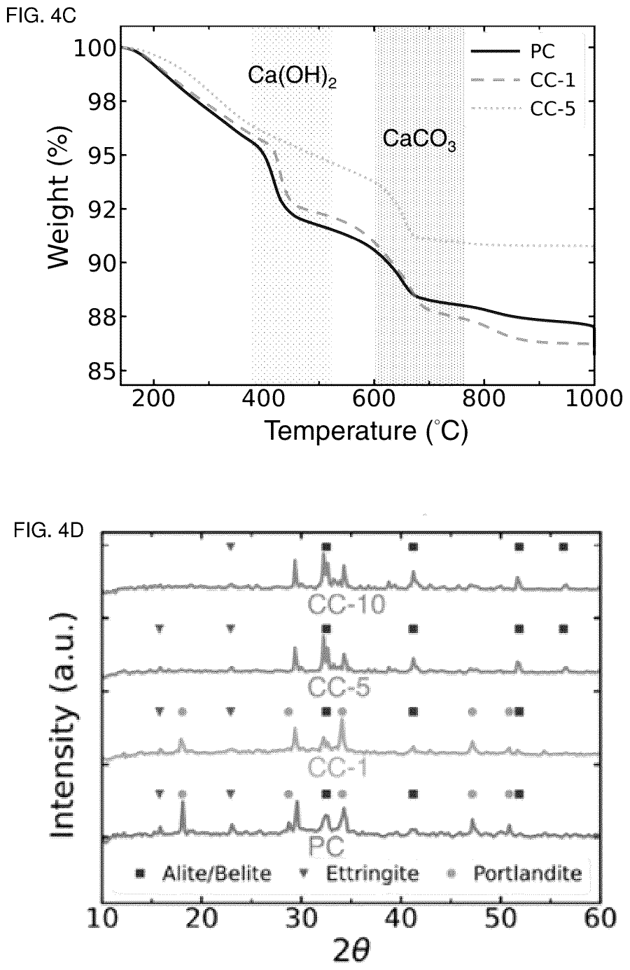

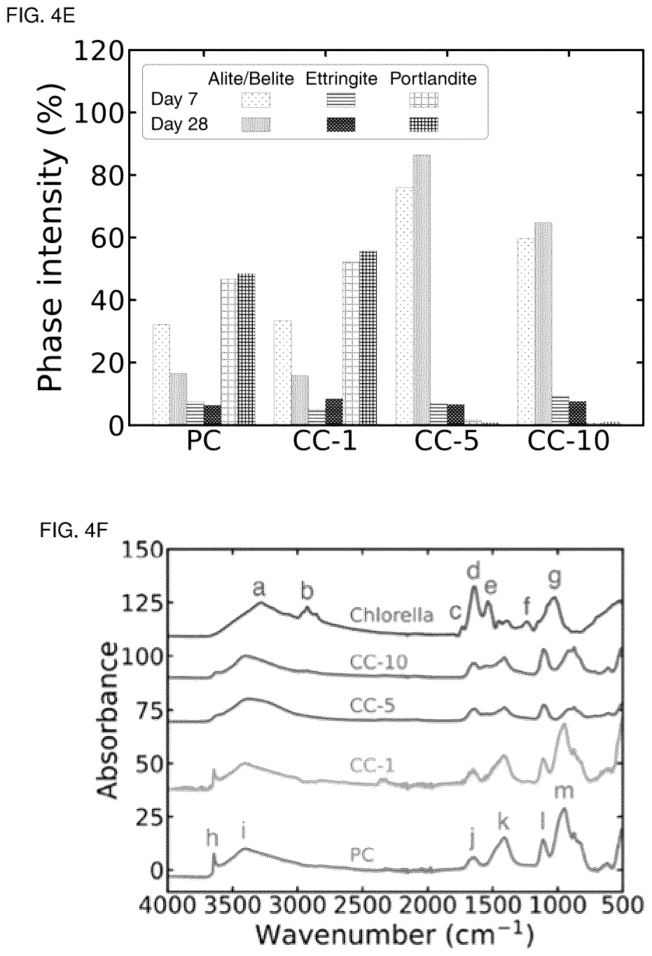

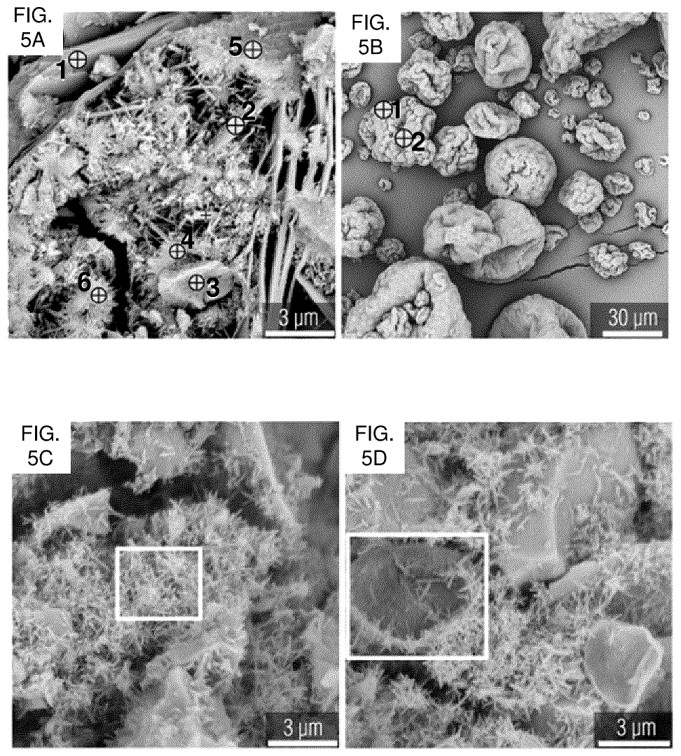

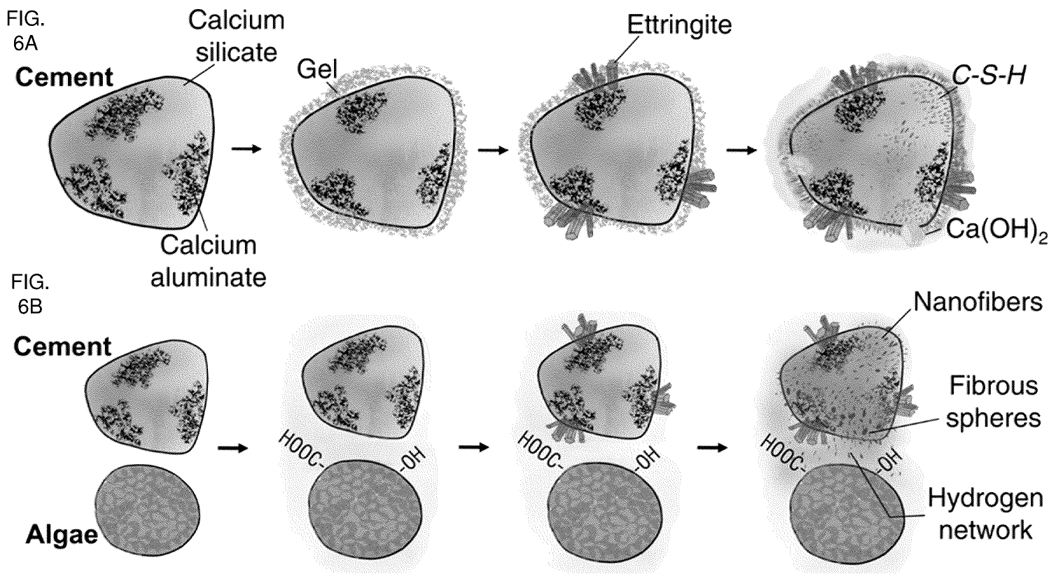

Effects of Biomatter on the Hydration Reactions. To further investigate the compositions of the nanofibers and potentially altered hydration reactions, the pure cement and the composites were characterized using IC, TGA, XRD, FTIR, and EDS. The heat flow measured by isothermal calorimetry allows one to monitor the hydration kinetics at early age until day 7 (FIG. 4A). Focusing on the major hydration periods as shown in FIG. 4A, the first extensive heat flow peak within the first hour corresponds to the ion dissolution and activation of tricalcium aluminate hydration reactions. The following induction period (time period before the onset of the primary reaction) of composites containing 1 wt % biomass is prolonged by a factor 6.25 compared to pure cement (from 2 h for pure cement to 12.5 h for the biocomposite), and the dominant hydration peaks during the acceleration period are delayed from 10 h after mixing to 26 h. Meanwhile, the time difference between the first silicate hydration peak (marked as 1 in FIG. 4B) and the second aluminate hydration peak with the depletion of sulfate (peak 2) is 1 h shorter with the addition of 1 wt % Chlorella. These suggest that, at low concentration, biomatter slows down the nucleation of C—S—H and Ca(OH)₂ and promotes the depletion of sulfate. With the addition of 5 wt % Chlorella, the heat flow profile is radically modified. With the exception of the same initiation peak in the first hour, the dominant hydration peaks entirely disappear even until day 7 (see FIG. 4A) while a new peak with heat flow content of 3.3 mW/g appears at 1.4 h (labeled (*) in FIG. 4B; not observed in PC and CC-1), possibly suggesting a distinct chemical reaction between the algal biomatter and the cement colloid.

Combining the mechanical performance and the calorimetry results, this work shows that introducing low-concentration algal biomatter into ordinary Portland cement causes a retardation effect whereas long-term hindrance is induced at concentrations higher than 5 wt %. Highlighting the altered hydration reactions, the hydration products were focused on to further assess the interactions between the biomatter fillers and cement.

The mass loss profiles collected through TGA allow quantification of the water, Ca(OH)₂, and calcium carbonate CaCO₃ contents in the described materials. The TGA curves of pure cement, and the Chlorella composites with 1 and 5 wt % biomatter samples tested at day 28 are shown in FIG. 4C. The initial mass loss from room temperature to 140° C. corresponds to water adsorbed by the samples, including the water contained in the cement pores and taken up by the biomatter. This water content is reported in Figure. S3f of Lin et al. (ACS Sustainable Chem Eng. 11:8242-8254, 2023) for each sample. In combination with the increased porosity observed in FIG. 3 (and Figure S3e,S3f of Lin et al., ACS Sustainable Chem Eng. 11:8242-8254, 2023), as well as the decreased apparent density, the lower pore water content in the composites containing more than 5 wt % algal biomatter confirms that more water evaporation occurs over time at higher algae contents. This water evaporation is likely due to fewer hydration products stabilizing pore water and a loose microstructure (facilitated by the suppressed hydration reactions), which enables more rapid water diffusion toward the surface. To facilitate the thermogravimetric analysis of these hydration products using the chemically bound water, the effect of pore water was exclude by setting the sample mass at 140° C. as 100% for all samples in FIG. 4C. For pure cement, the first significant mass loss takes place between 380 and 520° C. and is associated with the decomposition of Ca(OH)₂ to CaO (Ca(OH)₂→CaO+H₂O), while the second decomposition occurring between 600 and 780° C. is attributed to CaCO₃ (CaCO₃→CaO+CO₂).⁵¹ The rest of mass loss ranging from 140 to 1000° C. is attributed to the chemically bound water within ettringite or the C—S—H interlaminar structure.^{51,52}

The Chlorella composite with 1 wt % biomatter shows a degradation profile qualitatively similar to pure cement. From the first mass loss stage, the Ca(OH)₂ content was calculated to be 3.5% in pure cement and 3% in the Chlorella 1 wt % composite. The second mass loss stage reveals a calcium carbonate content of 3% for pure cement and 3.5% for the composite.

However, the distinct decomposition of Ca(OH)₂ in the range of 380-520° C. is not observed for the composite with 5 wt % Chlorella, while the calcium carbonate mass loss step is evident and shows a 3% content in that composite. This result implies that the introduction of algal biomatter at a concentration of 5 wt % prevents the primary hydration reactions in ordinary Portland cement where alite (Ca₃O₅Si) and belite (Ca₂O₄Si) react with water to create C—S—H and Ca(OH)₂ and therefore eliminate the silicate hydration peak in the calorimetry heat profile.

Comparing the XRD patterns of pure cement and the Chlorella composites at different concentrations (FIG. 4D), it was observe that peaks at 18.1°, 28.7°, 47.1°, and 50.8° are gradually decreased as the biomatter content increases, and at 5 wt %, they are absent from the collected patterns. These peaks correspond to Ca(OH)₂,⁵³⁻⁵⁵ and therefore, their absence in the 5 wt % Chlorella composite corroborates the TGA findings that indeed this hydration product is either never formed or entirely depleted in the presence of 5 wt % biomatter. On the other hand, the peaks at 32.3°, 32.6°, 41.3°, and 52°, attributed to anhydrated cement silicates (alite and belite),⁵⁶⁻⁵⁸ are prominent and even found to be increasing with increasing Chlorella content, indicating the existence of unhydrated reactants. Although the peaks associated with anhydrated cement were observed even at the composites with 10 wt % Chlorella, ettringite peaks (located at 15.8° and 22.9°) appear,^{53,55} albeit at low intensity, in the XRD patterns of Chlorella composites with up to 5 wt % biomatter. As ettringite is the earlier-formed product of cement hydration, the detection of these peaks suggests that the hydration reactions, where tricalcium aluminate (Ca₃Al₂O₆) reacts with gypsum and water, were activated when the mixture was in contact with water.

Phase analysis through peak deconvolution of the XRD patterns of biocomposites is conducted at varying biomass concentrations on both day 7 and 28. The phase evolutions of the anhydrated cement (alite/belite), ettringite, and portlandite in Chlorella composites are shown in FIG. 4E. The amount of alite and belite reduces over time with a slight increase in portlandite in pure cement and the composites with low biomass additions, which suggests a continuous hydration process in those materials. Throughout the 28-day curing duration, the absence of portlandite in composites containing more than 5 wt % Chlorella and the relatively high amount of anhydrated cement (˜60-80%) again confirms the impeded primary hydration reaction caused by the addition of Chlorella at high concentration. The presence of ettringite remains at ˜6% in all of the biocomposites over time, indicating that the initial formation of ettringite indeed happens while the constant volume suggests lack of extensive monosulfate transformation. Hence, only the primary hydration reactions of alite and belite are proposed to be hindered in the presence of Chlorella biomatter at high concentration. In the early hydration reaction stage, during which ettringite is formed, results show that the cement particles have access to water, but the strength acceleration stages that require C—S—H and Ca(OH)₂ formation are hindered.

The same conclusions can be drawn for the Spirulina composites with the ettringite XRD peaks being present even at 10 wt % biomatter content (Figure S4 of Lin et al., ACS Sustainable Chem Eng. 11:8242-8254, 2023) and the alite and belite peaks showing increasing intensity with the increase of biomatter content. Interestingly, a new amorphous feature was detect from the broad peak between 15° and 23° in the Spirulina patterns (Figure S4a of Lin et al., ACS Sustainable Chem Eng. 11:8242-8254, 2023), suggesting the presence of amorphous products, similar to the C—S—H form which results in an amorphous peak between 15° and 25° 0.59 In addition, the presence of 10% portlandite in Spirulina composites CS-5 and CS-10 (Figure S4b of Lin et al., ACS Sustainable Chem Eng. 11:8242-8254, 2023) suggests that introducing Spirulina induces less hindrance effect on the primary hydration reaction compared to Chlorella. These results support the measured higher compressive strength and capability of strength growth over time of Spirulina compared to the Chlorella composites. This finding is in agreement with the SEM observation of Spirulina composites, which are covered with a denser layer of nanofibers compared to Chlorella composites.

Based on the current characterizations from SEM, TGA, and XRD, the elimination of Ca(OH)₂, the presence of ettringite, and increasing amounts of anhydrated alite and belite were consistently detect. However, whether the nanofibers detected in the composites are C—S—H or ettringite or whether they are the byproducts of algal biomatter and cement have not yet been characterized. Since C—S—H and Ca(OH)₂ are both formed as products of the same hydration reactions, if the detected nanofibers are C—S—H, then another chemical reaction must have occurred to transform Ca(OH)₂ into different products. Alternatively, if the nanofibers are ettringite, their presence indirectly suggests that the primary hydration reactions are impeded with the introduction of biomatter even if cement has access to water to form the secondary reaction products. Finally, if the nanofibers are byproducts of biomatter and cement, this implies that biomatter would interfere with the primary hydration reaction of alite and belite, leading to the absence of both Ca(OH)₂ and C—S—H.

FTIR analyses were conducted to probe the potential chemical reactions between biomatter and cement (spectra presented in FIG. 4F, main peak assignments listed in Table 3). The functional groups of Chlorella include the predominant bending at 1375-1450 cm-1 from polysaccharides or lipids, C—O stretching peaks at 1075, 1095, and 1150 cm-1, and C—C stretch from carbohydrates or alcohols at 1030 and 1050 cm-1).^{44,61}

TABLE 3
Characteristic FTIR Peaks of Chlorella and Hardened Portland Cement

| | Chlorella | | | Pure Cement | |
|---|---|---|---|---|---|
| | peak (cm⁻¹) | bond type | | peak (cm⁻¹) | bond type |
| (a) | 3000-3600 | OH stretch | (h) | 3643 | OH stretch in Ca(OH)₂ |
| (b) | 2925 | C—H stretch | (i) | 3397 | OH of H₂O in C—S—H or |
| | | | | | ettringite |
| (c) | 1735 | C═O stretch in COOH | (j) | 1636 | H₂O in ettringite and free |
| | | | | | water |
| (d) | 1630-1650 | C═O stretch in amide I, | (k) | 1411 | CO₃ bending in CaCO₃ |
| | | O—H stretch in H₂O | | | |
| (e) | 1540 | N—H bend and C—N | (l) | 1111 | SO₄ stretch in ettringite |
| | | stretch in amide II | | | |
| (f) | 1230-1240 | C—N stretch, N—H bend | (m) | 948 | Si—O stretch in C—S—H |
| | | in amide III | | | |
| (g) | 1023 | C—O stretch in alcohols | | | |

For pure cement (FIG. 4F and Table 3), the sharp peak at 3640-3646 cm-1 corresponds to the OH stretching in Ca(OH)₂,^{58,62,63} while the OH stretching in free water, C—S—H, or ettringite give rise to a broader peak centered at 3400 cm-1.63-65 The free water as well as the ettringite-bound water also results in an absorption band at 1640-1675 cm-1.63 The CO₃ out-of-plane bending in CaCO₃ is detected at 1400-1490 cm-1,58,63 the SO₄ antisymmetrical stretching in ettringite at 1100-1120 cm-1,63 and Si—O stretching in C—S—H at 950-980 cm-1.58,62,64

Comparing the spectra of the Chlorella composites with Chlorella and pure cement (FIG. 4F), it was again find that the peak associated with Ca(OH)₂ (sharp OH stretching peak at ˜3640 cm-1) is almost eliminated when Chlorella content is higher than 5 wt %. Meanwhile, the peak at 1110 cm-1 for the SO₄ antisymmetrical stretching in ettringite appears consistently in all the composites. The broad peak between 3280 and 3400 cm-1 associated with the OH in H O in ettringite and C—S—H is found to be broader and more red-shifted with O—H bonds (stretching peak at 3600-3000 cm-1), C═O and C—O bonds in COOH (C═O stretching peak at 1740-1730 cm-1, C—O stretching peak at 1050-1020 cm-1), and protein-related groups (amide I band at 1600-1700 cm-1 from C═O stretching and water O—H bending around 1640 cm-1, amide II region from N—H bending and C—N stretching centered at 1540 cm-1, and amide III vibrations of C—N stretching and N—H bending result in the weaker 1230-1240 cm-1 peaks).^{44,60} In addition, carbohydrate-related bands with multiple peaks (C—H stretching peak at 3000-2800 cm-1, weak symmetric and asymmetric CH₃, CH₂, and C—H) were detect with increasing Chlorella content. In addition, the intensity of C—S—H associated with the Si—O peak at ˜948 cm-1 is significantly decreased at biomatter content higher than 5 wt % while the peak itself is also red-shifted. These findings imply that C—S—H is either absent or substantially altered in the composites with 5 wt % Chlorella or higher. Together with the XRD data, which revealed a higher amount of alite and belite in those composites, these results suggest that the primary hydration reactions are hindered at biomatter content higher than 5 wt %.

To further investigate the micromorphology and composition of hydration products, EDS was utilize to identify the spatial distribution of elemental composition. In the hardened pure cement, the morphologically distinct Ca(OH)₂ platelets (spots 1 and 2 in FIG. 5A) were probed, which yield an O/Ca ratio of 2.9-3.6 as shown in Table 4. The value is reasonably higher than the stoichiometric 2 due to signal contributions from the neighboring matrix. Irregular reactant particles (spot 3 in FIG. 5A) have a Ca/Si ratio of 1.8, close to the stoichiometric expectation of 2 for belite, while for alite, expected to be a ratio of 3. Finally, targeting the C—S—H coating, which appears to have a flower-like fibrous form (spots 4-6 in FIG. 5A), a Ca/Si ratio of 1.6-2.6 (anticipated value 0.6-2.364,66) was measured. Spot analysis of raw algal biomatter (FIG. 5B) reveals carbon, nitrogen, and oxygen, as the top three elements found in that biomatter, which are present at the ratio of 5.5:1.1:1 for Chlorella and 2.3:0.87:1 for Spirulina, reflecting the higher protein content of Spirulina and higher carbohydrate content of Chlorella.

TABLE 4
Elemental Composition (Atomic Ratio) of Pure Cement,
Raw Chlorella Powder, and the Nanofibers and Macrospheres
of Composites with 5 wt % Chlorella
Pure cement

| spot | products | O/Ca or Ca/Si |
|---|---|---|
| 1 | Ca(OH)₂ | 2.87 |
| 2 | Ca(OH)₂ | 3.58 |
| 3 | Alite, Belite | 1.84 |
| 4 | C—S—H | 2.6 |
| 5 | C—S—H | 1.62 |
| 6 | C—S—H | 2.34 |

Raw chlorella

| element | spot 1 | spot 2 |
|---|---|---|
| C | 5.34 | 5.87 |
| N | 1.04 | 1.17 |
| O | 1 | 1 |
| P | 0.04 | 0.21 |
| S | 0.02 | 0.17 |
| Ca | 0.02 | 0.07 |

Chlorella 5 wt %

| element | nanofibers | macrospheres |
|---|---|---|
| Ca | 8.39 | 5.78 |
| Si | 1 | 1 |
| N | 1.58 | 3.52 |
| O | 4.57 | 18.14 |
| S | 1.29 | 1.20 |
| Al | 0.27 | 0.61 |

Next, focusing on the two distinct micromorphological features of the composites revealed in the previous section, the nanofibers and spherical structures, seen in both the Chlorella and Spirulina composites, and acquire compositional maps (areas shown in FIGS. 5C, 5D). It was observe that the nanofibers in both biocomposites show significantly higher Ca/Si ratio (4.5-9.0 for the 5 wt % Chlorella and 3.1-5.2 for 5 wt % Spirulina; see Table 4) than the ratio of 0.6-2.3 reported for C—S—H in pure cement,^{64,66} so do the microspheres (5.5 and 8.6 for 5 wt % Chlorella and Spirulina, respectively). The measured high Ca/Si ratios confirm that the formed nanofibers are not C—S—H. Meanwhile, the presence of silica and low content of aluminum and sulfur corroborate that the nanofibers are not ettringite either, which is already suggested from the morphological analysis as it typically displays lengths in μm scale as shown in FIG. 3B, unlike the consistent length of 500 nm observed for the nanofibers. Interestingly, the nanofibers and spheres in both biocomposites show a notable N/Si ratio ranging from 1.6 to 4. Since there is no significant amount of nitrogen in pure cement, but there is in biomatter, the results suggest that the formed nanofibers and micro-spheres may be in fact new amorphous compounds derived from the distinct exothermic reaction between cement and algal biomatter observed in the IC results (FIG. 4B) and associated with the new broad peaks found in the XRD patterns of Spirulina composites.

The results reported here collectively suggest that the drastically different hydration behaviors and mechanical properties of the composites are dominated by chemical interactions between the functional groups on the biomatter surface and the inorganic cement colloid. The weakening mechanical performance of the biocomposites is the result of distinct hydration products instead of the structural defects alone. Chlorella and Spirulina both have a high concentration of carbohydrates ranging from 13.6 to 54.4 wt % depending on strains and growth conditions, and for both, more than 50% of the carbohydrates have glucose monomers.^{40,67-69} In alkaline conditions in cement pastes, glucose degrades into acidic forms such as parasaccharinic acid or glycolic acid, as demonstrated by Yang and Montgomery.⁷⁰ Therefore, the acidification of glucose-based carbohydrates is expected in both cases of Chlorella and Spirulina when mixed with the cement paste. Because of the alkaline and rich calcium cation (Ca²⁺) environment, the new negatively charged end groups of the glucose-based carbohydrates would interact with the calcium cations, which can stabilize in chelated structures similar to calcium glycolate. Chaudhari et al.⁷¹ demonstrated that both glycolic acid and calcium glycolate significantly delay the induction period in cement hydration reactions. In fact, they proposed that calcium glycolate adsorbs onto the alite surface, forming a stable hydrogen bond network. The hydrogen bond network then retards the diffusion of water to anhydrated cement, inhibiting the formation of hydration products (Ca(OH)₂ and C—S—H). This hypothesis is aligned with the current observation that there is a concentration threshold above which the hydration retardation effect becomes a complete hindrance. At lower concentrations (<5 wt %), the hydration reactions of composites containing biomatter are delayed since the adsorption of calcium glycolate-like forms only partially cover the entire surface of anhydrated cement, inducing a prolonged diffusion process. However, at higher concentrations, when alite and belite are fully encapsulated by the screening hydrogen bond network of calcium glycolate-like carbohydrates, the hydration reactions are indefinitely delayed, thereby inhibiting the formation of Ca(OH)₂ and C—S—H. Similarly, Smith et al.⁷² showed that the charged degradation forms of glucose nonselectively adsorb on ettringite through electrostatic interactions and, therefore, delay its secondary reaction with tricalcium aluminate that produces calcium aluminate monosulfate. However, they found that the reaction of tricalcium aluminate with gypsum and water to form ettringite is not blocked when the charged carbohydrates are present. This observation explains the consistent presence of ettringite in the provided composites, suggesting that the primary reaction that produces ettringite crystals is not hindered.

In summary, a mechanism is proposed to explain the observed effects of polysaccharide-based compounds on the strength evolution of cement-algae biocomposites and propose a graphical summary in FIG. 6. Upon water exposure, the secondary hydration reactions derived from tricalcium aluminate occur even in the presence of biomatter, generating ettringite precipitates. In both types of biomatter, acidified carbohydrates are formed in alkaline conditions, which upon calcium chelation and surface adsorption facilitate a strong hydrogen bond network ultimately encapsulating calcium silicates on the cement particles. The formed network inhibits the reaction of calcium silicates and water and, thus, hinders the formation of C—S—H and Ca(OH)₂ while forming nanofibers and microspheres of different compositions. Moreover, the negative-charged carbohydrates adsorb on the positive-charged ettringite precipitates blocking their further reactions. The morphologically distinct microspheres and nanofibers, which are found to coat the reactant surfaces, are amorphous compounds with high amounts of nitrogen, suggesting protein-related products. The presence of ettringite versus the absence of Ca(OH)₂ and C—S—H in the described composites could also be attributed to the different reaction rates of hydration reactions. As the tricalcium aluminate hydration happens faster, it is less influenced by the presence of biomatter, which interacts with both reactants and reaction products, while the slower hydration reactions of calcium silicates are affected more significantly. It has been shown the hindrance effect induced by the algal biomatter is a chemical process, and therefore, more specific surface area (smaller particles) would likely exacerbate the hindrance effect. Finally, to explain the different aging behavior between Chlorella and Spirulina and the higher strength evolution in Spirulina composites, the different carbohydrate content in the two types of biomatter. The carbohydrate content of the biomatters was analyzed via high performance liquid chromatography (HPLC) (results shown in Figure S5 of Lin et al., ACS Sustainable Chem Eng. 11:8242-8254, 2023 for Chlorella, and prior work from Fredricks et al.⁴⁰ for Spirulina) and found that Chlorella contains 21.7 wt % carbohydrates, 10.8 wt % of which are glucose-based, while Spirulina has 14 wt % carbohydrates, 6.1 wt % of which are glucose-based. This result supports the more significant suppressing effect when Chlorella is introduced in cement as compared to Spirulina. A similar effect of wood flour in Portland cement at 7.5 wt % (wood flour/dry cement) was reported by Dong et al.⁷³ They showed that the wood with high content of sugar and sugar acid (poplar wood) inhibits the hydration process more than the Chinese fir (lower content of sugar and sugar acid). However, they reported that ettringite generation was not negatively affected by the presence of wood flour in either case, which agrees with the presented findings.

Potentials of Reducing Carbon Footprint. To provide insight into the potential of mitigating the carbon footprint using algal biomatter, the environmental impact as assess of the biocomposite cements through the quantification of specific CO₂ emissions as a function of algae concentration. Assuming that the algae is embedded in the cement paste and stored in the long term (will not decompose), the carbon-negative fillers can have beneficial environmental effects, which is estimated as follows. On one hand, the CO₂ emissions of anhydrated cement are commonly estimated to be 1 kg CO₂/kg anhydrated.⁷⁴ On the other hand, although the environmental impact of algae production is less straightforward to estimate as it strongly depends on culture conditions, the use of fertilizers, or harvesting and drying methods,⁷⁵⁻⁷⁷ Liao et al.⁷⁸ estimated the overall (negative) carbon emission for microalgae to be approximately −0.54 kg CO₂ eq/kg of dry Spirulina. Based on these values, the net reduction in specific CO₂ emissions of biocomposite cements compared to neat cements can be estimated as a function of filler concentration (see SI section Estimation of the Reduction of CO₂ Emissions). As examples, values for algae concentrations of 0.5%, 1%, and 5% are report in Table 5. Such reductions in emissions could have beneficial effects on the environmental impact of cements.

TABLE 5
Variation in Strength and Specific CO₂ Emissions (kg
CO₂/kg) for Biocomposite Cements Compared to Neat Cements

| algae concentration | specific CO₂ emissions |
|---|---|
| (wt %) | reduction (%) |
| 0.5 | 0.6 |
| 1 | 1.3 |
| 5 | 6.4 |

### Conclusions

In this Example, the effects have been investigated of introducing Spirulina and Chlorella microalgae at different concentrations into Portland cement on the resulting mechanical properties, morphologies, and hydration kinetics via multiple characterization methods. Below 5 wt % algae concentration, the compressive strength evolution of the biocomposites and the onset of the primary hydration reaction are delayed. Adding more than 5 wt % of either algae, the long term compressive strength was found to have a drastic reduction by 85%; this may be due to the hindrance effect of the primary hydration reactions, which leads to the absence of calcium hydroxide as quantified from the TGA, XRD, and FTIR results. For composites containing 5 wt % biomatter, the appearance of a new exothermic reaction was observed during the hardening process, which was correlated with the distinct morphologies and protein-related compositions of the nanofibers and spheres shown in the SEM and EDS.

Focusing on the consistent presence of ettringite and the absence of Ca(OH)₂ and C—S—H, a mechanism was proposed to explain the concentration-dependent behavior of cement-algae composites based on the polysaccharide-based compounds. Including the carbon sequestration capacity of biomatter, calculations provided here suggest that 1.3% reduction of specific CO₂ is achievable with the addition of 1 wt % algal biomatter in Portland cement.

### References for Example 1

(1) Adams et al., Bringing embodied carbon upfront: Coordinated action for the building and construction sector to tackle embodied carbon; accessed 2019; available online at worldgbc.org/embodied-carbon.
(2) Worrell et al., Annual Review of Energy and the Environment 2001, 26, 303-329.
(3) Humphreys & Mahasenan, Towards a sustainable cement industry. Substudy 8: climate change; 2002; available online at osti.gov/etdeweb/biblio/20269589.
(4) Palkovic et al., Construction and Building Materials 2016, 115, 13-31.
(5) Duque-Redondo et al., Cem. Concr. Res. 2022, 154, 106716.
(6) Zhou et al., Proc. Natl. Acad. Sci. U.S.A. 2019, 116, 10652-10657.
(7) Ioannidou et al., Proc. Natl. Acad. Sci. U.S.A. 2016, 113, 2029-2034.
(8) Hendriks et al., Proceedings of the fourth international conference on greenhouse gas control technologies 1999, 939-944.
(9) Arehart et al., Journal of Cleaner Production 2020, 266, 121846.
(10) Chousidis et al., Construction and Building Materials 2015, 101, 810-817.
(11) Islam et al., International Journal of Sustainable Built Environment 2017, 6, 37-44.
(12) Cordeiro et al., Construction and Building Materials 2012, 29, 641-646.
(13) Vijay et al., Construction and Building Materials 2017, 152, 1008-1014.
(14) Menon et al., Sci. Rep. 2019, 9, 1-12.
(15) Nguyen et al., Adv. Mater. 2018, 30, 1704847.
(16) De Belie et al., Advanced materials interfaces 2018, 5, 1800074.
(17) Wang et al., Matter 2022, 5, 957-974.
(18) Onuaguluchi et al., Construction and Building Materials 2014, 63, 119-124.
(19) Cao et al., Cement and Concrete Composites 2015, 56, 73-83.
(20) Barnat-Hunek et al., Construction and Building Materials 2019, 223, 1-11.
(21) Guo et al., Nanomaterials 2020, 10, 2476.
(22) Fu et al., Cellulose-Reinforced Nanofibre Composites; Elsevier, 2017; pp 455-482; DOI: 10.1016/b978-0-08-100957-4.00020-6.
(23) Fu et al., Polymers 2017, 9, 424.
(24) Laborel-Préneron et al., Construction and Building Materials 2016, 111, 719-734.
(25) Akinyemi et al., Construction and Building Materials 2020, 245, 118405.
(26) Ban et al., Polymers 2020, 12, 2650.
(27) Bilba et al., Cement and Concrete Composites 2003, 25, 91-96.
(28) Rahimi et al., Journal of Building Engineering 2022, 45, 103448.
(29) Ahmad & Chen, Construction and Building Materials 2020, 251, 118981.
(30) Zeller et al., J. Appl. Polym. Sci. 2013, 130, 3263-3275.
(31) Gavrilescu & Chisti, Biotechnology advances 2005, 23, 471-499.
(32) Mirón et al., Biochemical Engineering Journal 2003, 16, 287-297.
(33) Chisti, Biotechnology advances 2007, 25, 294-306.
(34) León-Martínez et al., Construction and Building Materials 2014, 53, 190-202.
(35) Hernández et al., Materiales de Construcción 2016, 66, e074-e074.
(36) Aday et al., Materials and Structures 2018, 51, 1-13.
(37) Clarkson et al., Adv. Mater. 2021, 33, 2000718.
(38) McHugh, Production and utilization of products from commercial seaweeds; FAO, 1987; ISBN: 92-5-102612-2.
(39) Manuhara et al., Aquatic Procedia 2016, 7, 106-111.
(40) Fredricks et al., J. Polym. Sci. 2021, 59, 2878-2894.
(41) Roumeli et al., Proc. Natl. Acad. Sci. U.S.A. 2022, 119, e2119523119.
(42) Duraj-Thatte et al., Nat. Chem. Biol. 2021, 17, 732-738.
(43) Campbell et al., Annu. Rev. Mater. Res. 2023, 53, 1.
(44) Chen et al., ACS Sustainable Chem. Eng. 2021, 9, 13726-13734.
(45) ASTM International. Standard Specification for Portland Cement; ASTM International, 2021.
(46) ASTM International. Standard Test Method for Compressive Strength of Hydraulic Cement Mortars (Using 2-in. or [50 mm] Cube Specimens); ASTM International, 2021.
(47) Schneider et al., Nat. Methods 2012, 9, 671-675.
(48) Mehta, Cem. Concr. Res. 1976, 6, 169-182.
(49) Luo et al., Construction and Building Materials 2019, 195, 305-311.
(50) Jennings et al., J. Am. Ceram. Soc. 1981, 64, 567-572.
(51) Pane & Hansen, Cement and Concrete Research 2005, 35, 1155-1164.
(52) Rupasinghe et al., Cement and Concrete Composites 2017, 80, 17-30.
(53) Jiang et al., Journal of Materials Research and Technology 2021, 15, 2982-2992.
(54) Linggawati, KnE Engineering 2016, 1, 1-8.
(55) Kontoleontos et al., Mater. Res. 2013, 16, 404-416.
(56) Jadhav et al., Bulletin of Materials Science 2011, 34, 1137-1150.
(57) Monteagudo et al., Thermochim. Acta 2014, 592, 37-51.
(58) Flores et al., Materials 2017, 10, 498.
(59) Baston et al., Mineralogical Magazine 2012, 76, 3045-3053.
(60) Barón-Sola et al., J. Hazard. Mater. 2021, 419, 126502.
(61) Šimonovičová et al., Frontiers in Microbiology 2021, 12, 3820.
(62) Li et al., Carbon 2005, 43, 1239.
(63) Fernández-Carrasco et al., In Infrared spectroscopy-Materials science, engineering and technology; IntechOpen, 2012; DOI: 10.5772/36186.
(64) Pelisser et al., J. Phys. Chem. C 2012, 116, 17219-17227.
(65) Gastaldi et al., J. Mater. Sci. 2009, 44, 5788-5794.
(66) Zhang et al., Cem. Concr. Res. 2018, 107, 85.
(67) Safi et al., Renewable and Sustainable Energy Reviews 2014, 35, 265-278.
(68) El-Naggar et al., Sci. Rep. 2020, 10, 1-19.
(69) Shekharam et al., Phytochemistry 1987, 26, 2267-2269.
(70) Yang & Montgomery, Carbohydrate research 1996, 280, 27-45.
(71) Chaudhari et al., J. Mater. Sci. 2017, 52, 13719-13735.
(72) Smith et al., Proc. Natl. Acad. Sci. U.S.A. 2011, 108, 8949-8954.
(73) Dong et al., Journal of Advanced Concrete Technology 2016, 14, 13-20.
(74) Ali et al., Renewable and Sustainable Energy Reviews 2011, 15, 2252-2261.
(75) Tzachor et al., Marine Biotechnology 2022, 24, 991-1001.
(76) Beckstrom et al., Algal Research 2020, 46, 101769.
(77) Ye et al., Algal Research 2018, 34, 154-163.
(78) Liao et al., Sustainable Materials and Technologies 2023, 36, e00591.

### Example 2. Green Cements with Algal Biomatter Filler

Example 2 provides additional specific examples of biological cements. These additional biological cements were made using two additional multicellular algae—Sugar Kelp (Saccharina latissima), a type of multicellular brown algae, and Ulva lactuca, a type of green algae. Their analysis is provided in comparison to data also reported in Example 1, for Chlorella and Spirulina.

### Materials

Commercially available Type I/II Portland cement (SAKRETE, Charlotte, NC), abiding by ASTM C150, was used in all algae-cement composites. The chemical composition of the Portland cement is shown in Table 2.

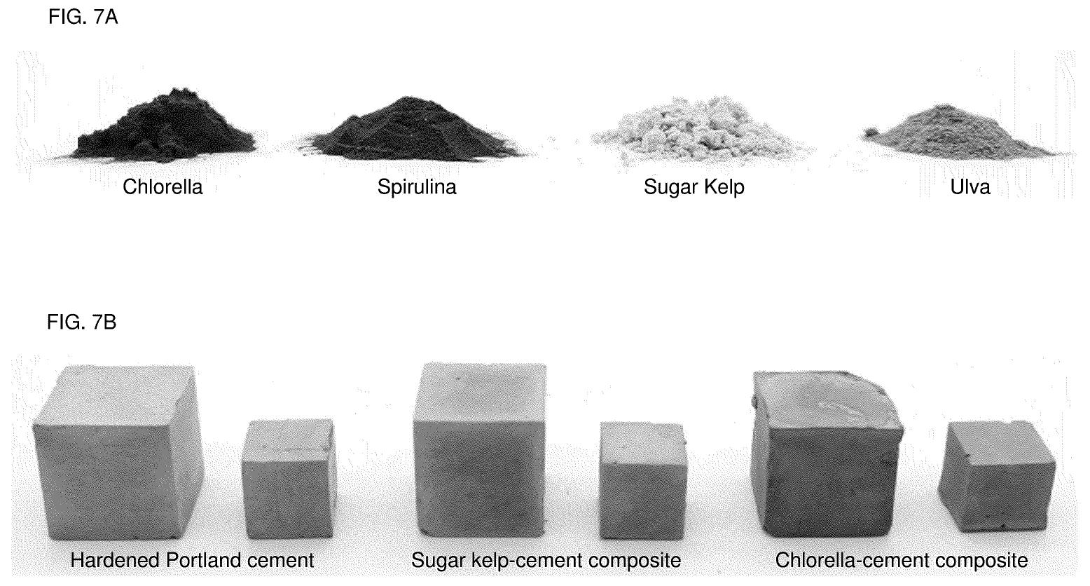

Four species of algae were used as algal biomatter fillers to partially substitute Portland cement in dehydrated powder forms, as shown in FIG. 1A and FIG. 7A. Two of the algal biomatters were Chlorella and Spirulina, which are microalgae with intact cells ranging from 10-20 μm and 20-40 μm respectively. The other two multicellular algae—Sugar Kelp (Saccharina latissima), a type of multicellular brown algae, and Ulva lactuca, a type of green algae—were ground into powders as broken tissue and cells. Ulva was also added to commercial sand mix to make mortar. In addition to cement and algal biomatter, additives such as nanoclay (e.g., montmorillonite or halloysite) and biopolymers such as glucomannan were used as admixtures to modify the biocomposites. For all of the materials, pure cement with W/C at 0.4 was taken as the reference sample, positive control (PC).

### Methods

Each biocomposite was made according to the design of mixture and water-to-cement ratio (W/C). For biocomposite with Chlorella, Spirulina, and sugar kelp, the concentration of algal biomatter was added to up to 15% by weight of total dry mass at W/C ranging from 0.35-0.5. For Ulva-cement and Ulva-mortar composites, up to 10 wt. % of Ulva was used when W/C was 0.45. The modification of biocomposites induced by admixture was further investigated at the dosage of 0.5 wt. % and 2.5 wt. %.

The fresh pastes were mixed on a planetary mixer (e.g., on a FlackTek DAC 330-100 PRO Speedmixer™, FlackTek, Inc., Landrum, SC) at room (ambient) temperature. The biomatter powder, admixtures, and cement were first premixed into homogenize mixture at 1500 rpm for 30 seconds. Deionized water is added and the fresh paste was mixed at 1500 rpm for 1.5 minutes in total that stops with 15-second intervals every 45 seconds to obtain the homogenous fresh paste. The materials on the wall of mixing cups were scraped off with spatulas in between the mixing process. After mixing, the fresh paste, as shown in FIG. 1B, was cast into cubes in molds (e.g., rubber molds) on a vibration table (FIG. 1C) with proper rodding to eliminate macro air bubbles. To prevent water evaporation, samples were sealed with plastic films on the surface and placed in an enclosed chamber at around 90 RH % (relative humidity %) and 23° C. to cure for 24 hr before demolding. The demolded samples (FIG. 1D and FIG. 7B) were stored in the same humidity chamber until the designated test day.

### Results.

Apart from the cement-Chlorella and cement-Spirulina composites discussed extensively in Example 1, the compressive strength of cement-Ulva and mortar-Ulva composites were also studied. At day 7, biocomposites with 2 and 5 wt. % Ulva showed compressive strength of 31.81 MPa and 30.28 MPa, which were identical to that of hardened cement with the same sample size. At day 28, the strength of biocomposites with 2 wt. % Ulva increased by 23% (39.13 MPa) and 49% for 5 wt. % Ulva (45.14 MPa). These promising results show the potential of using Ulva to partially substitute cement resulting in new cement compositions that have uncompromised mechanical performance and simultaneously reduce environmental impact.

### Example 3: Effects of Marine Micro and Macroalgae Building Blocks on Strength Development in Green Cement Composites

The utilization of biomass-based green cement has gained significant attention in the concrete industry as sustainability becomes a key focus. Among the available biobased additions, marine algal materials have emerged as a promising candidate due to their advantageous features such as rapid growth rate and efficient carbon sequestration. However, incorporating algae into the cement matrix presents challenges, involving hindrance and retardation of the hydration reactions, leading to a decline in the mechanical properties of algae green cement. In this study, the chemical interactions between two types of algae fillers, namely Spirulina and Ulva, and the cement matrix were investigate. Initially, the interaction was examined in a simplified chemical system using biopolymer representatives (glucomannan, lactalbumin, sucrose, and stearic acid). The results demonstrated a significant decrease in the mechanical properties of glucomannan and alpha-lactalbumin cement composites. Consequently, a study was conducted involving extraction-modified algae-cement composites to investigate further the interaction between the algae fillers and the cement matrix. It was found that both hot and cold water-extracted Spirulina and Ulva resulted in an improvement in compressive strength.

Furthermore, the formation of distinct nanofibers in 500-700 nm within the matrix was observed in the case of lactalbumin-cement composites and hot water-extracted Spirulina supernatant cement composites, suggesting that proteins may act as the main hindering agents in the hydration reaction and facilitate protein-related inorganic byproducts. Overall, this study enhances the understanding of the algae-induced hindrance mechanisms on the cement hydration reactions and provides a starting point for improving algae-cements through non-chemical pretreatment on algae biomatter.

### Chemical Composition of Micro and Macroalgae

Two species under investigation in this study: Spirulina sp. and green Ulva sp. Spirulina sp. is a protein-rich blue-green microalgae characterized by spiral-shaped chains of cells and the absence of a hemicellulose cell wall.[18,19] On the other hand, Ulva, commonly known as sea lettuce, is a green macroalgae with an average cell size of 40-50 μm.[20] Ulva primarily consists of polysaccharides with a hemicellulose-based cell wall. Analyzing the fundamental differences in their chemical compositions provides insights into the factors contributing to the varying mechanical strengths observed in their respective cement composites.

An examination of the data presented in Table 6. reveals significant variations in the reported chemical composition percentages within the same species. This variability can be attributed to factors such as cultivation environment and sub-species variations. However, notable distinctions can still be observed between the two species. Ulva species exhibit higher percentages of carbohydrates and fiber in their raw algae dry mass, while Spirulina species predominantly consist of proteins within the dry mass.

TABLE 6
Chemical composition comparison between Ulva sp. and Spirulina sp.^{[21-28]}

| Chemical | Carbohydrates & | | | |
|---|---|---|---|---|
| Composition | Fiber | Protein | Fatty Acids | Ash/Mineral |
| Spirulina | 10-50% | 50-70% | 1-10% | 1-7% |
| Species | | | | |
| [25-28] | | | | |
| | Monosaccharides: | Aspartate | Palmitic | Potassium: 640-2700 |
| | Glucose 20-50% | Glutamate | acid: >40% | mg/100 g* |
| | Rhamnose 20-50% | | | Sodium: 450-2000 |
| | Fiber: | | | mg/100 g |
| | Hemicellulose 40-50% | | | Iron: 88 mg/100 g |
| Ulva | 40-70% | 4-20% | 1-10% | 3-20% |
| Species | | | | |
| [21-24] | | | | |
| | Monosaccharides: | Aspartate: | Palmitic acid: | Magnesium: |
| | Rhamnose 8-40% | 10-12% | 25-50% | 3891 mg/100 g |
| | Glucose 10-18% | Glutamate: | 18:1n-7: 2-20% | Calcium: |
| | Xylose 2-10% | 10-12% | α-Linolenic | 2720 mg/100 g |
| | Fiber: | | acid: 12-15% | Potassium: |
| | Hemicellulose 14-21% | | | 630 mg/100 g |
| | Lignin 2-10% | | | Sodium: 552 |
| | Cellulose 2-10% | | | mg/100 g |

*dry weight

In this study, an objective is to examine the chemical interactions between algae and cement and analyze the variations in compressive strength between micro and macro-algae-based cement composites. Results reveal a substantial disparity in strength between the (green macroalgae) Ulva 5% cement composite samples and (microalgae) Spirulina 5% cement composite samples. Significantly, the Ulva cement biocomposite demonstrates superior performance compared to the Spirulina cement biocomposites. To address this observation, it is proposed that a specific chemical component acts as a hindrance agent, impeding the cement hydration process in micro and green macro algae-based composites.

To gain comprehensive insights into the behavior of these cement biocomposites, it is crucial to identify and understand the specific categories of chemical compositions that influence strength and hydration reactions. By investigating representative biopolymer cement composites and modified biomatter cement composites, valuable insights can be gained into the underlying factors that affect strength and hydration processes, enabling us to optimize the performance of cement biocomposites and enhance their potential in sustainable construction applications. Additionally, studying algae-biomatter extraction sheds light on the chemical interactions involved.

This investigation into the chemical interaction between algae and cement sets the stage for developing improved algae-based biomatter cement composites, facilitating their successful implementation in commercial construction while meeting industry standards.

### Material and Chemical Procurement

The Spirulina was obtained directly from nuts.com, while the Ulva seaweed was cultivated in ponds, harvested, and freeze-dried by collaborators from the Pacific Northwest National Labs (PNNL; Sequim, USA). The cement utilized in this study is Type 1/II Ordinary Portland Cement (Sakrete, Atlanta, GA).

### Cement Composite Sample-Making Process

As in Example 1.

### Extraction Methods

The extraction procedure for this study was determined through a modified version after conducting several literature reviews. Chaiklahan et al. [29] reported the optimal conditions for Spirulina extraction, including a solid-to-liquid ratio of 1:45 (w/v) Spirulina to water, a temperature of 90° C., and a duration of 120 minutes, resulting in a biomass yield of 8.3% dry weight. Yongzhou Chi et al. [30] found that a ratio of 1:30 algae to water, an extraction temperature of 100° C., and a duration of 2 hours yielded successful results for Ulva species.

Additionally, MyoungLae Cho et al. [31] reported that an algae-to-water ratio of 1:20, an extraction temperature of 65° C., and a duration of 2 hours, with constant mechanical stirring, provided satisfactory outcomes. However, in this study, deportation and lipid removal procedures were not executed as described in the aforementioned literature. Consequently, the extracted supernatant may contain multiple types of biopolymers.

Both hot water and cold water extractions were performed to investigate the effects of different extraction temperatures on the composition of biomass cement. In the case of hot water extraction, the intent was to extract a maximum amount of water-soluble substances by utilizing heat to break down the cell walls of the biomass. This method allows examining the impact of heat on the composition of the biomass and observing any changes in the cement properties.

On the other hand, cold water extraction allow direct comparison of the effects of heat on the biomass. By conducting the extraction process without applying heat, the protein can be maintained in its native form and the specific influence of temperature on the composition of the biomass evaluated. This approach also enables observing the potential effect of protein denaturation. Hence, by employing both hot and cold water extraction methods, comprehensive insights into the effects of temperature and extraction procedures on the composition of biomass cement are obtained.

Polysaccharides Hot-water extraction (HWE): The hot water extraction (HWE) process of algae in the study involved specific parameters. A 1:30 (w/w) ratio solution was prepared between the algae biomass and water during extraction. The procedure was carried out at 100° C. for 2 hours. To compensate for water evaporation, one-third of the initial weight of the water was added after the first hour of extraction, ensuring a consistent liquid environment. After completion of the extraction process, the mixture was allowed to cool down to room temperature. Subsequently, centrifugation was performed at 6000 rpm for 10 minutes to separate the solid biomass from the liquid extract, ensuring the isolation of the desired components.

Polysaccharides Cold-water extraction (CWE): A 1:30 (w/w) ratio solution was prepared between the algae biomass and water during extraction. The procedure was carried out at room temperature for 24 hours. After completion of the extraction process, centrifugation was performed at 6000 rpm for 10 minutes to separate the solid precipitate and the liquid supernatant.

Sample-Making Process for Extraction Product: The sample-making process for the extraction precipitate involved: the precipitate obtained from the centrifuged solution was air-dried. Once the precipitate was completely dried, a coffee grinder was used to grind it into a fine powder. Subsequently, the standard process for making cement composite samples was followed to produce the testing sample.

For the supernatant cement composite samples, after the supernatant was collected, the supernatant was incorporated into the cement during the sample-making process, serving as the water component.

### Characterization Methods

Characterization methods, including compression tests, Scanning Electron Microscopy, Energy-dispersive X-ray Spectroscopy, and Thermogravimetric Analyses, and Fourier-transform infrared spectroscopy were carried out essentially as in Example 1.

### Analysis of Biopolymer Additive Cement Composites

The Spirulina and Ulva species under investigation comprise four primary chemical components: polysaccharides, disaccharides, lipids, and proteins. To assess the impact of these components on cement composites, representative chemicals were selected for each category based on accessibility and functional group characteristics. Specifically, glucomannan was chosen to represent polysaccharides, sucrose for disaccharides, stearic acid for lipids, and lactalbumin for proteins. In this analogous study, cement composites containing 5% of each representative chemical will be compared with those containing 5% of Spirulina and Ulva, respectively, using a water-to-cement (w/c) ratio of 0.4. The behavior of these composites will be evaluated through compression tests, thermogravimetric analysis (TGA), and scanning electron microscopy (SEM) imaging.

Prior to incorporating the selected biopolymer into the cement matrix, particle size distribution (PSD) analysis was conducted, and the morphology of the biopolymer examined using scanning electron microscopy (SEM) imaging. The purpose of the PSD analysis was to ensure that the particle size of the biopolymer was within an appropriate range, as excessively large particles could introduce defects in the cement matrix and impede the observation of the chemical reaction effects when the biopolymer is insoluble. The particle size distribution of lactalbumin and stearic acid are presented, with average particle sizes of 15.998 μm and 20.79 μm, respectively. These sizes are comparable and suitable for investigating the chemical influence. Additionally, SEM imaging enabled us to visualize the morphology of the biopolymer outside the cement matrix.

### Mechanical Properties

Cement composites containing 5% of each representative chemical, as well as 5% of Spirulina (SP5), Ulva (UV5), and their respective controls, were subject to mechanical testing. The data indicate that glucomannan and lactalbumin at 5% concentration had the most detrimental impact on the final strength of the composites. By adding 5% glucomannan (GM5), the compressive strength at day 28 decreased from 57.17±4.19 MPa to 2.07±0.31 MPa while it decreased from 57.17±4.19 to 8.52±0.60 MPa when introducing 5% lactalbumin. In contrast, stearic acid 5% (SA5) and sucrose 5% (SU5) had a similar final strength to the Ulva 5% (UV5) samples (in the range of 25-30 MPa, 44-52% of pure cement). These results suggest that proteins and polysaccharides may be the primary factors contributing to the cement's weaker mechanical strength and hindrance of hydration.

The hydration products were investigated by looking at the TGA curve of analogous cement composites and comparing them with the degradation regions of typical cement hydration products. The pure cement (PC) and Ulva 5% cement composite (UV5) exhibit a typical calcium chloride (CH) decomposition drop in the TGA result, which is around 380° C. to 520° C. area in the figure.[32,34,35] The absence of calcium chloride aligns with compressive strength results where the two composites are stronger than most others. Interestingly, although the strength of SU5 is similar to the UV5, it does not show a typical calcium chloride (Ca(OH)₂) decomposition drop in the TGA curve, suggesting that the sucrose 5% composite's strength might not be contributed by the typical hydration products. Spirulina 5% cement composite is referred to as SP5.

### Saccharide Retardation Study

Comparing the influence of disaccharide and polysaccharide on the compression strength of the composites, it is evident that the SU5 cement composite exhibits better than expected compressive strength, while the GM5 composite shows significantly weaker mechanical properties. However, this difference could be attributed to the extreme water uptake ability of glucomannan which would become a viscous hydrogel upon meeting water and decrease the workability of the slurry, leading to a noticeable amount of manufacturing voids.[33] To further exclude the influence of workability-induced defects on the compressive strength, lower percentages (0.5%) of sucrose and glucomannan were added to the cement composite.

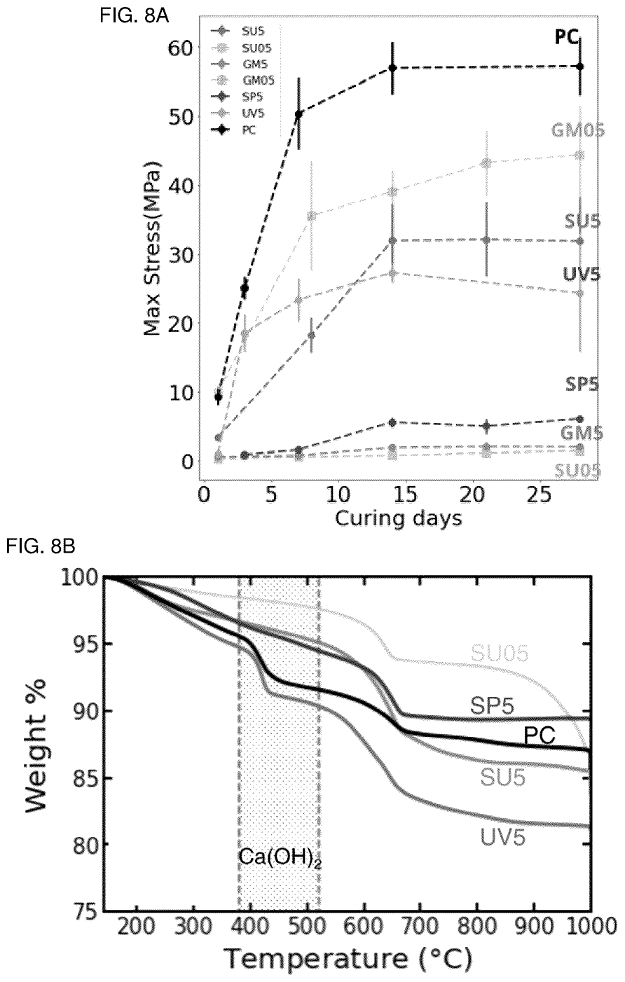

The compressive strength was compare between the 0.5% sucrose cement composite (SU05) and the 0.5% glucomannan cement composite (GM05) as shown in FIG. 8A. Interestingly, the results reveal that GU05 outperforms SU05 in compressive strength, indicating that the lower molecular weight of saccharide has a more destructive influence on the strength at the same percentage. Additionally, an interesting relationship was found between the sucrose concentration and the final compressive strength. Contrary to the previous notion that incorporating more retardants into the cement matrix would lead to lower mechanical properties, SU05 exhibits lower mechanical strength than SU5 while both samples do not show a typical Ca(OH)₂ decomposition at 380-520° C. (FIG. 8B), implying the hindrance of primary hydration reaction derived from alite and belite.

To further validate the results obtained from the mechanical testing, scanning electron microscopy (SEM) analysis was conducted on the SU5 and SU05 cement composites. Based on SEM images, the SU5 composite exhibits a denser matrix than the SU05 composite, correlating to the higher apparent density of the SU5 composite (˜1.97 g/mm³). The denser matrix in the SU5 composite contributes to its superior mechanical properties, as confirmed in the compressive strength results. The ettringite needles (1.35±0.01 μm) were observed in the SU05 matrix, which is not observed in the SU5 matrix. The higher compressive strength and denser matrix may be attributed to the sucrose crystallization and reinforcing the matrix. The higher compressive strength and denser matrix in the SU5 composite may be attributed to sucrose crystallization and reinforcement of the matrix.

However, the exact cause of this phenomenon remains unclear and may be further elucidated using X-ray diffraction (XRD). The differences in microstructure and morphology between the two composites contribute to the variations in their mechanical properties.

### Analysis of Extraction-Modified Algae Cement Composite

### Mechanical Properties

Upon finding that polysaccharides and proteins are the primary components responsible for the retardation and hindrance of the cement hydration process, extraction methods were applied to remove these undesirable components and improve the performance of the algae biomatter cement composite. Extraction modification of raw algae material holds great potential for enhancing the low performance of raw algae cement composites. In this study, hot and cold water extractions were performed on micro and macroalgae, specifically Spirulina and Ulva. These extraction methods were selected for their environmentally friendly nature, as they require less intensive chemical pretreatment and result in lower carbon footprints compared to other methods requiring multistep chemical treatment and drying processes.

The obtained biomass precipitate was incorporated into 5% cement matrices with a water-to-cement ratio of 0.4 (w/c) to compare its performance with the raw algae cement composite directly. Additionally, the resulting supernatant was incorporated into cement composites to evaluate its effect compared to pure cement. The performance of these composites was evaluated through compression tests, thermogravimetric analysis (TGA), and scanning electron microscopy (SEM) imaging.

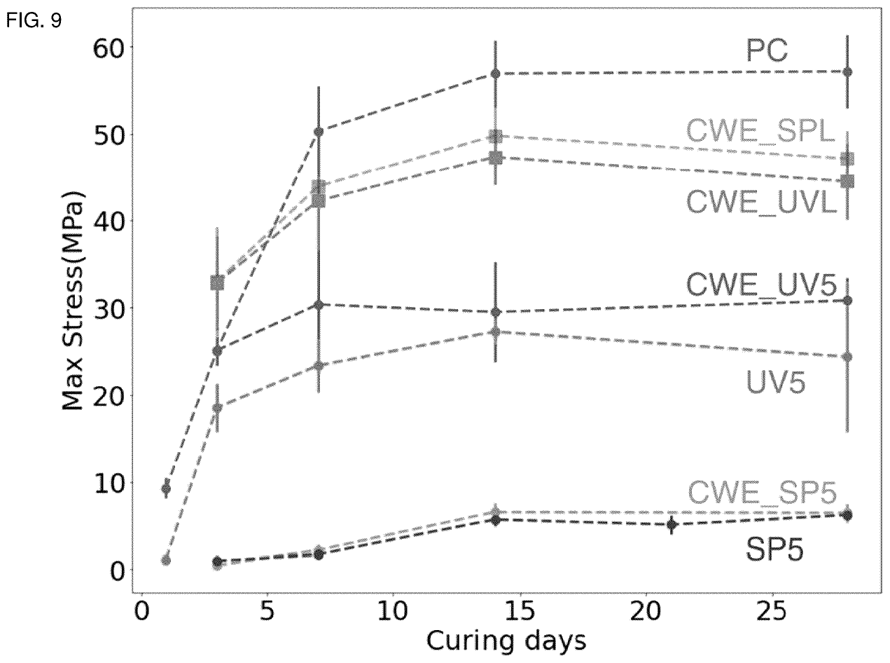

Comparing the compressive strength of the composites with 5% virgin biomass and pretreated biomass, as shown in FIG. 9, it was fond that the cold water extracted Ulva precipitate solid 5% cement composite (CWE_UV5) demonstrates slightly superior performance compared to its virgin counterparts by 20.6%. Conversely, the cold water extracted Spirulina precipitate solid 5% cement composite (CWE_SP5) exhibits a similar compressive strength to SP5 while CTW_SPL shows a slight decline in compressive strength. The combined results from the compressive strength of Spirulina supernatant and precipitate composites derived from the cold water extraction suggest that the cold water extraction method alone is insufficient to remove the detrimental components from virgin Spirulina. Consequently, more effective hot water extraction methods [29-31] were employed to investigate this matter further.

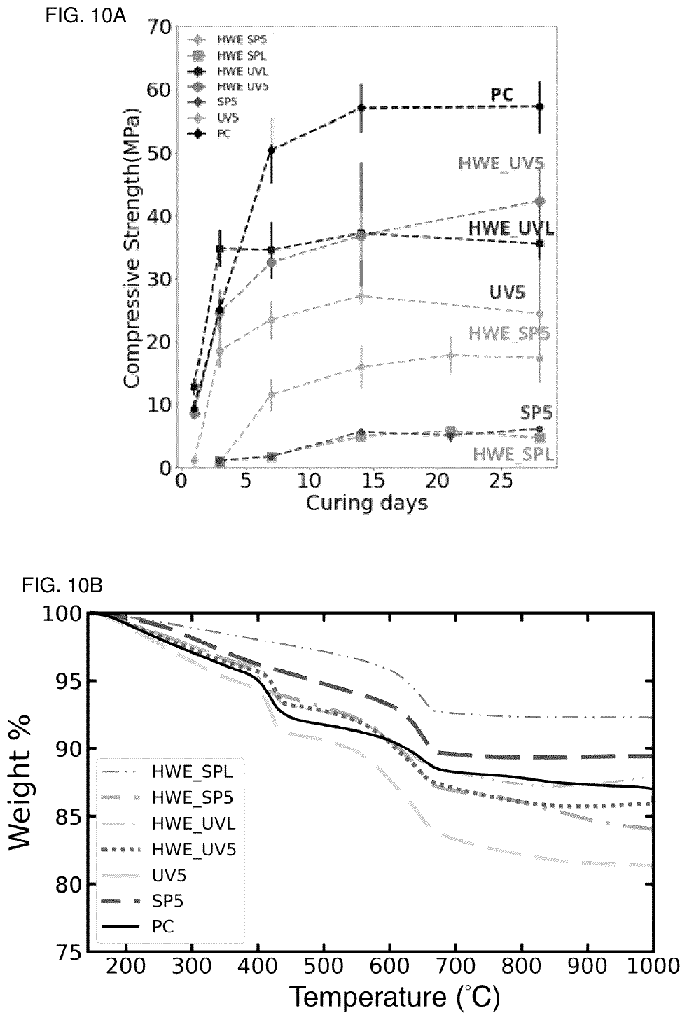

Algae cement composite modified by the hot water extraction method with raw Ulva, Spirulina cement composite, and pure cement were compared (FIG. 10A-10B).

The compressive strength of the hot water extracted Spirulina precipitate solid 5% cement composite (HWE_SP5) and hot water extracted Ulva precipitate solid 5% cement composite (HWE_UV5) perform significantly better than their virgin counterparts by 73.6% (42.30 vs. 24.36 MPa). This difference suggests that the extraction procedure performed at 100° C. effectively removes undesirable chemicals that hinder the cement hydration, which water-soluble proteins and polysaccharides may induce. In contrast, the hot water extracted Spirulina supernatant liquid cement composite (HWE_SPL) and hot water extracted Ulva supernatant liquid cement composite (HWE_UVL) showed lower compressive strength with very low biocomposite percentages (˜2%, back-calculated from mass loss in TGA), which is consistent with the precipitate compression test results. Both supernatant liquid composites show a significant decrease in strength compared to the pure cement samples. Additionally, it was found that only SP5 and HWE_SPL do not present a typical Ca(OH)₂ decomposition profile in the TGA result (FIG. 10B), implying the main chemical that causes the hindrance of the hydration reaction was extracted from raw Spirulina and present in the supernatant through hot water extraction. This finding highlights the importance of characterizing the compositions of the extracted supernatant and the modified algae precipitations in future work.

### Morphological Analysis

Based on the SEM image analysis, the typical hydration product HWE_UV5 and HWE_UVL were identify in the composite matrix. For example, HWE_UV5 shows sintered CSH product around the supernatant particle and CSH nanofiber within the matrix. In addition, the ettringite needles, Ca(OH)₂ platelets, and fibrous CSH nanofibers were see in HWE_UVL at the higher magnification (×11,000). This observation explains the fact that even though the strength of HWE_UVL is lower than pure cement due to the low concentration (˜2.1% from the mass loss in TGA) of extracted compounds in the supernatant, the presence of typical hydration products still provides structural compounds for the mechanical properties. Complementarily, the abundant CSH in the modified Ulva precipitates composites contributed to the 73.6% improved compressive strength. On the other hand, distinct nanofibers were observe in the HWE_SPL cement composite, similar nanofibers previously identified in the LB5 matrix. This identical microstructure aligns well with the hypothesis that the high protein content in the Spirulina biomatter cause the hindrance and the retardation of the hydration reaction and further decrease the final strength of the algae biomatter composite. This also explains the better compression strength of the Ulva biomatter cement composites, which have a lower protein percentage across all Ulva species than Spirulina.

### Evaluation of the Hydration of Cement Composite

To confirm the presence of hydration products, representative cement composite samples were investigated using FTIR. Analysis of the glucomannan (GM5) and lactalbumin (LB5) samples revealed a lack of peaks at 3643 cm⁻¹, corresponding to the absence of Ca(OH)₂. Stearic acid 5% cement composite (SA5) exhibited a unique peak at 2914.5 cm⁻¹ and 2849.1 cm⁻¹, attributed to the asymmetric and symmetric stretching vibrations of the —CH₂— band in stearic acid.[8,35,36] Also observed was a peak at 1653.5 cm⁻¹, which indicates the presence of H₂O in ettringite, and a peak at 1411.2 cm⁻¹, which indicates the carbonate (CO₃) out-of-plane bending in calcite. Other notable peaks include 1110.6 cm⁻¹ for the anti-symmetric SO₄ stretching band in ettringite. Notably, the GM and LB samples showed less distinct and redshifted peaks at 947.8 cm⁻¹, which corresponds to the Si—O in CSH [8,35,36], confirming the nanofibers observed are distinct from CSH.

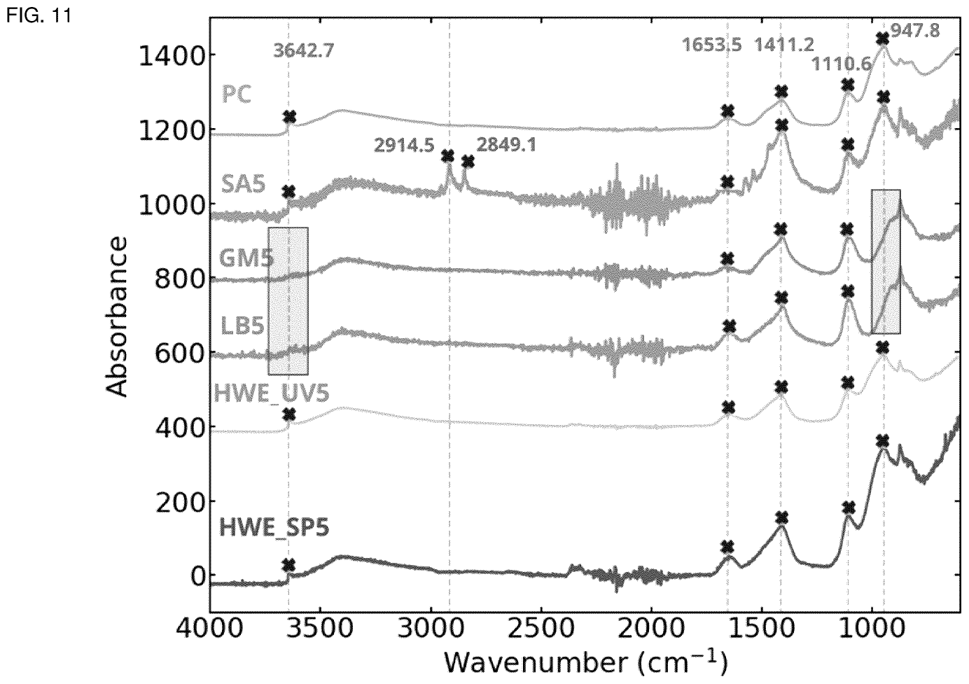

Based on FTIR analysis presented in FIG. 11, it was evident that the glucomannan (GM) and lactalbumin (LB) composites lack the peak of OH in Ca(OH)₂ at 3642.7 cm⁻¹ and the peak of Si—O in CSH at 950 cm⁻¹. This confirms again with explains the low compressive strength of the composites and the absence of a decomposition profile in the range of 380-520° C. in TGA results. The results suggest that both lactalbumin and glucomannan hinder the primary hydration reaction completely, leading to the absence of the Ca(OH)₂ peak. However, they still permit the secondary hydration reaction from tricalcium aluminate, which leads to ettringite production. Notably, the strength of Ulva and Spirulina composites improved after hot-water extraction, as confirmed by the presence of Ca(OH)₂ and CSH, corresponding to the peaks at 3642.7 cm⁻¹ and 947.9 cm⁻¹, respectively. This effective pretreatment highlights the need to characterize the water-soluble biopolymers that exist in algal biomatter, especially at high temperature, as they seem responsible for the hindrance effect in the virgin algae-cement composites.

To directly examine the impact of removing chemical components that weaken the cement composites, extraction methods were employed on the virgin algal biomatter as a pretreatment. Both hot-water extraction-modified precipitate Ulva and Spirulina cement composites exhibited improved final compressive strength, suggesting the effective removal of hindering chemicals. This finding is consistent with the results obtained through the supernatant as the control study to compare with pure cement. In addition, through mechanical testing, SEM imaging, and FTIR analysis of extraction-modified Ulva and Spirulina cement composites, similar nanofiber morphology was observed in the hot water extraction supernatant Spirulina cement composite, akin to the lactalbumin cement composite samples, indicating the correlation between protein and the nanofiber byproduct. These results comply with the finding that hot water extraction pretreatment successfully removes the detrimental water-soluble proteins from virgin Spirulina, leading to reduced hindrance and the formation of nanofibers and improved compressive strength. Furthermore, this explains the higher compressive strength observed in the raw Ulva samples.

Finally, the study on biomass proteins revealed a significant effect of pH and calcium cations on inducing secondary structural changes. Both alkaline and high concentration of calcium ion environments exhibited the most pronounced alterations in secondary structure among all the tested conditions. These findings contribute to the understanding of protein behavior within the cement matrix.

### References for Example 3

1. U.S. Environmental Protection Agency. (2022, September 19). Cement Manufacturing Enforcement Initiative. Online at epa.gov/enforcement/cement-manufacturing-enforcement-initiative
2. Singla V. (2022, January 18). Cut Carbon and Toxic Pollution, Make Cement Clean and Green. Natural Resources Defense Council, Inc.; online at nrdc.org/bio/veena-singla/cut-carbon-and-toxic-pollution-make-cement-clean-and-green
3. Kusuma et al., (2022). Renewable and Sustainable Energy Reviews, 163, 112503.
4. Rejini Rajamma et al., (2009). Journal of Hazardous Materials, 172(2-3), 1049-1060. ISSN 0304-3894. doi.org/10.1016/j.jhazmat.2009.07.109.
5. Vo & Navard, (2016). Construction and Building Materials, 121, 161-176.
6. Tonoli et al., (2009). Composites Part A: Applied Science and Manufacturing, 40(12), 2046-2053.
7. Jo & Chakraborty, (2015). Scientific Reports, 5, 7837. doi: 10.1038/srep07837.
8. Chen et al., (2021). ACS Sustainable Chemistry & Engineering, 9(41), 13726-13734. Online at doi.org/10.1021/acssuschemeng.1c04033
9. Hernandeza et al., (2015). Materiales de Construccion, 66(321): e074, doi.org/10.3989/mc.2016.07514
10. León-Martínez et al., (2014). Construction and Building Materials, 53, 190-202.
11. Chahbi et al., (2022). Australian Journal of Mechanical Engineering. doi.org/10.1080/14484846.2022.2066855
12. Murugappan & Muthadhi, (2022). Materials Today: Proceedings, 65(Part 2), 839-845. ISSN 2214-7853. doi.org/10.1016/j.matpr.2022.03.424.
13. Karthick Srinivas et al., (2021). Journal of Building Engineering, 44, 102958. ISSN 2352-7102. doi.org/10.1016/j.jobe.2021.102958.
14. Mamlouk & Zaniewski, (1999). Materials for Civil and Construction Engineers. Addison Wesley Longman. ISBN:978-0134320533.
15. Double et al., (1983). Series A, Mathematical and Physical Sciences, 310(1511), 53-66. Online at jstor.org/stable/37463
16. Mehta, (1976). Cement and Concrete Research, 6, 169-182.
17. Luo et al., (2019). Construction and Building Materials, 195:305-311.
18. Ciferri & Tiboni, (1985). Ann. Rev. Microbiol., 39, 503-526.
19. Markou et al., (2012). Bioenergy Research, 5, 915-925. doi.org/10.1007/s12155-012-9205-3
20. Largo et al., (2004). Hydrobiologia, 512, 247-253. doi.org/10.1023/B:HYDR.0000020333.33039.4b
21. Yaich et al., (2011). Food Chemistry, 128(4), 895-901. doi.org/10.1016/j.foodchem.2011.03.114
22. Osuna-Ruiz et al., (2019). Ciencias Marinas, 45(3), 101-120. doi.org/10.7773/cm.v45i3.2974
23. Osuna-Ruiz et al., (2017). J Environmental Management, 193, 126-135. doi.org/10.1016/j.jenvman.2017.02.005
24. Peña-Rodríguez et al., (2011). Food Chemistry, 129(2), 491-498. doi.org/10.1016/j.foodchem.2011.04.104
25. Bensehaila et al., (2015). African Journal of Biotechnology, 14, 1649-1654. DOI: 10.5897/AJB2015.14414.
26. Oliveira et al., (1999). Aquaculture International, 7, 261-275. doi.org/10.1023/A:1009233230706
27. Shekharam et al., Phytochemistry 26 (1987): 2267-2269.
28. Kusmiyati et al., International Energy Journal 20 (2020): 611-620.
29. Chaiklahan et al., (2013). International journal of biological macromolecules, 58, 73-78. doi.org/10.1016/j.ijbiomac.2013.03.046
30. Chi et al., (2018). Carbohydrate polymers, 181, 616-623. doi.org/10.1016/j.carbpol.2017.11.104
31. Wassie et al., (2021). Frontiers in nutrition, 8, 747928. doi.org/10.3389/fnut.2021.747928
32. Manrich et al., (2020). Journal of Agricultural Science and Technology B, 10 doi.org/10.17265/2161-6264/2020.05.004.
33. Keithley et al., (2013). Journal of Obesity, vol. 2013, Article ID 610908, 7 pages. doi.org/10.1155/2013/610908
34. Singh et al., (2015). International Journal of Concrete Structures and Materials, 9. https://doi.org/10.1007/s40069-015-0099-2
35. Lin et al., (2022). ACS Sustainable Chemistry & Engineering, doi.org/10.1021/acssuschemeng.2c07539
36. Thiery et al., (2022). Micron (Oxford, England: 1993), 158, 103266. doi.org/10.1016/j.micron.2022.103266
37. Yang et al., (2017). Composites Part A: Applied Science and Manufacturing, 102, 263-272. doi.org/10.1016/j.compositesa.2017.07.022
38. Byfors, (1987). Cement and Concrete Research, 17(1), 115-130. doi.org/10.1016/0008-8846(87)90066-4
39. Sumra et al., (2020). Journal of Wuhan University of Technology—Materials Science Edition, 35, 908-924. doi.org/10.1007/si1595-020-2337-y
40. Grdadolnik, (2003). Acta chimica slovenica, 50(4), 777-788.
41. Wi et al., (1998). Biospectroscopy, 4(2), 93-106.
42. Mizuguchi et al., (1997). FEBS letters, 417(1), 153-156. doi.org/10.1016/s0014-5793(97)01274-x
43. Boye et al., (1997). J Agricultural and Food Chemistry, 45(4), 1116-1125. doi.org/10.1021/jf960360z
44. Zhong et al., (1999). J Physical Chemistry B, 103(19), 3947-3953

### Example 4: Algal Biomass Particle Size and Self-Bonding Effects on Cement Composites

Cement is a large contributor to carbon dioxide (CO₂) emissions, and there is ongoing research to reduce this impact. Algal biomass, in various forms, is studied for potential applications in many industrial industries including the cement industry. This is large in part due to the wide availability of the abundant organic biomass in coastal marine regions. Prior literature has seen Arthrospira (Spirulina) platensis microalgae integrated with Ordinary Portland cement (OPC). This work explores the incorporation of raw and self-bonded algal biomatter to see the impact on the cement composites. The known effect of particle size is also further studied. Microalgae (Arthrospira platensis) Spirulina and macroalgae (Ulva expensa) were respectively incorporated in OPC at concentrations of 1%, 5%, and 10%. This is completed at three distinct particle size ranges as well as for raw and self-bonded biomass. Their effects on the mechanical strength, hydration product formation, and micromorphology of the composites were observe through compression testing, thermogravimetric analysis and scanning electron microscopy, respectively. Spirulina microalgae composites performed as expected with a drastic reduction in compressive strength at 5% concentration while Ulva macroalgae experiences a decrease in performance with increasing concentration, but the effect is not significant until 10% and is less dramatic than what is observed in the Spirulina. Smaller particle sizes in the Ulva composites are on average 1.49 times stronger than their large particle size counterparts, this factor is similar in Spirulina but again at relatively much lower strengths. Self-bonding has the opposite effects on the microalgae and macroalgae systems, where self-bonding enhances the strength of Ulva-cement composites up to 224%. This work furthers the investigation of whole algal biomass as additions to cement, with the intention of finding methods to reduce the detrimental environmental impact associated with cement production.

### Algal Biomass as an Additive

Algae is a widely abundant biomass seen often as waste due to its proliferation in coastal regions with no standard industrial application [31]. However, algae is well-studied for its potential applications such as packaging film, fibers in polymer composites, and biodiesel fuel in various industries [31]-[35]. Due to the advantage of rapid growth rates and low land use requirements, utilizing algae in cementitious materials has become an emerging field. In the past 25 years, algae-cement composites have been investigated for potential enhancements in workability [36], self-healing of cracks [37]-[39], and mechanical performance [40]. The algae's ability to sequester carbon [41] also provides a potential benefit as an additive for cement in regards to the negative environmental impact of cement production. Both macro- and micro-algae have been previously studied for their potential benefits to composite systems [31], [34], [42]. Other than using the extracted algal biomatter, there is previous work exploring microalgae as filler in cement composites that revealed the hindrance effect of Chlorella and Spirulina on cement hydration reactions at high concentration (>5 wt %) by Lin et al. [43], and the retardation effect of Chlorella at low concentration (<3 wt %) by Chen et al. [44]. Ramasubramani et al. and Achenza et al. have previously explored macroalgae applications [45], [46], but a well-developed understanding of the mechanisms is not defined. In this current work Arthrospira (Spirulina) platensis (microalgae) and Ulva expensa (Ulva) (macroalgae) are respectively introduced to the cement matrix to compare the effects on the strength development, the steady-state compressive strength, and the cement hydration reactions.

### Particle Size Effect and Self-Bonding

Regarding OPC, it is understood that the particle size shares an inverse relationship with the percentage of hydrated product, and therefore the final mechanical strength. This relationship is explained by the water penetration at smaller particle sizes allowing for an increase in hydration reactions to occur [47]. Previous works of microalgae as additives in cement composites used raw Chlorella powder [43] and ground Chlorella pellets [44], which showed different mechanical properties respectively while the effect of particle size has not been studied in detail. The hydrophilic feature of algal biomass is noted to have a potential impact on the cement-biomass interface, which can hinder the mechanical performance [27]. Furthermore, the surface area to volume ratio of a particle is directly proportional to its surface energy [48], which is well studied at the nanoscale in particular. Effectively decreasing the particle size of the biomass will increase the surface area to volume ratio, which could prove preferential for interface development and mechanical performance as well.

Pressing algae at high temperature and pressure increases the number of both covalent and hydrogen bonding, and a processable thermoplastic is obtained with mechanical properties more desirable than the raw biomass; this process classifies the biomass as “self-bonded.” The compressive strength of pure self-bonded Spirulina is reported at 76 MPa by lyer et al., suggesting the development of strong bonds between the Spirulina material [49]. The self-bonding of biomass, both Spirulina and Ulva, is investigated further in this work to observe the effect on mechanical performance of cement composites. The importance of the interface energy between filler and matrix is noted, and microstructural analysis will be implemented to compare the interfaces between the cement matrix and varying biomasses.

The following experiment aims to integrate algal biomass in different forms with the OPC matrix. Integration of the algal biomass will be performed with both Spirulina and Ulva at three discrete particle sizes; as previously discussed, particle size is expected to have an inverse relationship with the mechanical performance of the cement composites. The effect of self-bonding the biomass as a pre-processing condition is also explored with the hopes of seeing a correlation to mechanical performance. Further understanding the effects of particle size and self-bonding of both micro and macroalgae on the mechanical strength of cement composites will continue the ongoing research for utilizing algal biomass in applications for structural materials to reduce carbon emissions of the cement industry.

### Materials

Type I-II OPC was obtained in a powder form from Sakrete (Charlotte, NC, USA) and meets ASTM C150 [50] standards. The chemical composition of this cement powder is shown in Table 2. Spirulina (nuts.com, Cranford, NJ, USA) microalgae was commercially obtained in a powder form with a density of around 1.2 g/cm³. Characterized by SEM images and ImageJ, the particle sizes of the specific materials used in this experiment are 5-20 μm for cement and 20-40 μm for Spirulina's chain of cells [43]. Ulva, a form of green macroalgae, was provided by Pacific Northwest National Laboratories (PNNL, Richland, WA, USA) in the form of freeze-dried flakes on the centimeter scale. Noting that algal growth environment affects subsequent composition, the specific Ulva used in this experiment was grown in a high-flow current environment.

### Self-Bonding

Biomass was self-bonded via hot-pressing to observe the effect of this preprocessing step. The Ulva in supply was provided as inhomogeneous flakes, so 8-11 g of biomass is ground with coffee grinding (Hamilton Beach Model No. 80335RV, Allen, VA, USA) for 60 seconds to both decrease the particle size and homogenize the powder before hot-pressing. One gram ground algal biomass was placed in steel bar-shaped then hot-pressed at a desired temperature of 140° C., and a target pressure of one MPa for a duration of five minutes using the TMAX-SYP-600 (TMAXCN, Xiamen, Fujian, China). The result was a bar of the self-bonded biomass, which was ground into different particle sizes as a bio-additive.

### Particle Size Processing

For both the Spirulina and the Ulva, there were three discrete particle size ranges desired for this experiment. The procedures for the two larger particle size ranges and the smallest differ slightly. Biomass (excluding virgin Spirulina) was ground using a hand grinder with adjustable fineness, starting at a coarser setting, and increasing the fineness as necessary. Using a sieve tower that meets ASTM E-11 [51] specifications, biomass was passed through the sieves iteratively with additional grinding between passes until enough biomass at each particle size range was obtained. The largest particle size range was the biomass that fell between Mesh No. 35 and 100 (500 μm and 150 μm, large), while the next range between Mesh No. 100 and 325 (150 μm and 45 μm, medium).

The smallest particle size was achieved via milling. For this step, biomass was first processed to a particle size range akin to the medium range described above. Virgin Ulva was ball-milled at 500 rpm for 20 minutes using a Vertical High Energy Planetary Ball Mill (MSE Supplies, Tucson, AZ), while both the self-bonded Ulva and self-bonded Spirulina were speed-milled at 2500 rpm for 60 seconds using the SpeedMixer grinding accessory (Form-Tech Scientific, Toronto, Canada) with a speed mixer (DAC 330-100 PRO; FlakTek SpeedMixer, Landrum, SC). Due to processing constraints, raw Spirulina was not altered to the larger particle size ranges, and the out-of-bag particle size aligned with the smallest particle size range.

### Sample Fabrication

In this experiment, samples of 1, 5 and 10 wt % biomass were introduced to the cement composites, where the weight percent is the ratio of the mass of biomass powder to the mass of total dry powders used (biomass and cement summation). For 1 and 5%, a water-cement ratio of 0.40 was used while 0.50 was used for 10% samples due to workability constraints at high concentration. The dry powders were placed into a speed mixer (DAC 330-100 PRO; FlakTek SpeedMixer, Landrum, SC) and mixed at 1500 rpm for 30 seconds. The DI water was then added to the dry powders, and this was mixed in the speed mixer at 1500 rpm for 45 seconds four total times with 15 second resting intervals in between. After sufficient mixing, the cement slurries were cast to VytaFlex 30 urethane rubber (Smooth-On, Macungie, PA) molds of cubes measuring 10 mm in each dimension; molds 8 mm in each dimension were used for both control and 1% biomass samples due to load cell limitations. All molds were coated with AquaRelease 75 (Mann Release Technologies, Macungie, PA) concrete water-based release agent prior to casting the slurry to prevent samples adhesion to the molds. When casting the slurry, the molds rested on a vibrating table (Buffalo No. 1A Vibrator; Syosset, NY) while the slurry is cast. Once the cement slurries fill the molds halfway, a steel spatula was used to rod the mixture to remove entrapped air bubbles. This rodding was repeated when the molds are filled by the slurry. The resultant samples are then covered with a plastic film to minimize water evaporation and left to set for 24 hours in a humidity chamber held to ˜90% RH+/−5% and 23+/−1° C. For each biomass concentration, a minimum of 32 samples were fabricated. This was completed for virgin Spirulina at its out-of-bag particle size as well as for self-bonded Spirulina, raw Ulva, and self-bonded Ulva at small, medium, and large particle size ranges.

After the designated 24 hours of initial setting in the rubber molds, the cement samples were removed from their molds and returned to the humidity chamber to continue the hardening/curing process for the duration of the experiment.

### Additional Methods

Compression testing was conducted as described in Example 1.

Scanning electron microscopy (SEM) and energy dispersive spectroscopy (EDS) SEM analysis was conducted to as described in Example 1.

TGA observes the change in mass of a sample as a temperature regiment is applied and can observe relative different amounts of hydration products at steady state. TGA analysis was carried out as described in Example 1.

### Results and Discussion

Effects of Ulva macroalgae on cement composites: First at the effect of macroalgae on the cement composites was examined. This was assessed by isolating each characterization method for discussion: first mechanical results, followed by thermal degradation profiles, and concluding with micromorphological assessments. The effects of these variables are not directly transferrable to the microalgae studied, which were discussed in Example 1.

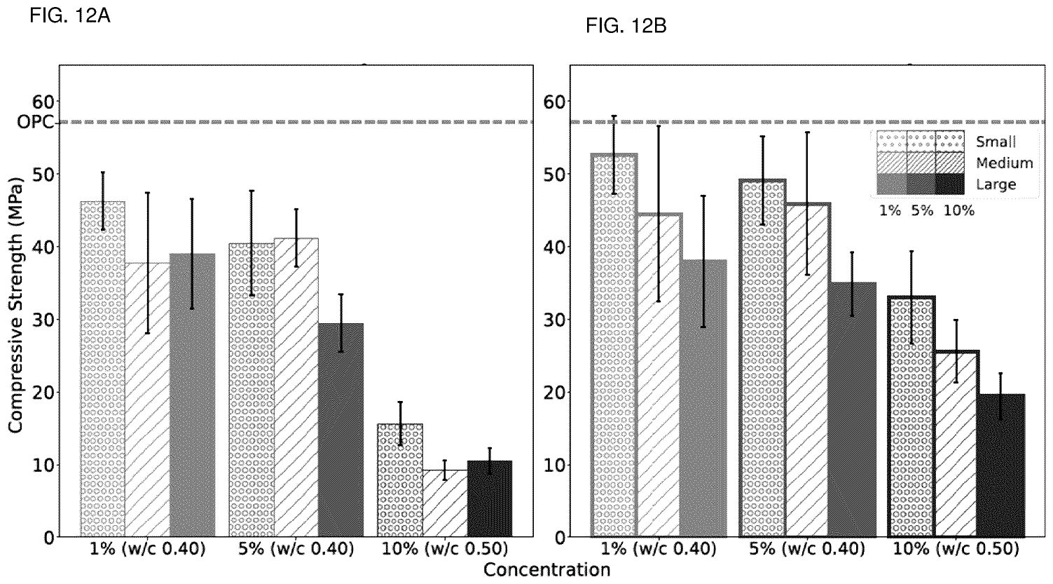

Mechanical Results: The steady-state mechanical performance is considered in below where FIG. 12A shows the 28-day σc of raw Ulva cement composites and FIG. 12B shows such for self-bonded cement composites. The black dashed line shows the σc of pure cement. These plots are grouped from left to right by concentration, and are organized within each group by particle size (smallest to largest in each group). Comparing the raw Ulva results, it was observed that biomass concentration is inversely proportional to σc in a nonlinear manner at each particle size. This drop in mechanical performance is expected as previous work has seen similar results where there is a low-strength plateau at 5% [43], though this was with Spirulina microalgae rather than the Ulva macroalgae here. Compared to this dramatic decrease in mechanical performance with microalgae filler, the raw Ulva macroalgae seems to perform similarly both at 1% and 5% before experiencing a drop at 10%. Looking at the self-bonded Ulva results (FIG. 12B), there is a similar trend, though the decrease in performance at 10% is less dramatic. This indicates that the effect of self-bonding biomass creates a strength enhancement, and therefore an opportunity for higher amounts of cement replacement, but this will be discussed in further detail in this section. Regarding the effect of concentration, an increase in concentration will decrease the steady-state ac of the macroalgae-cement composites a significant amount at 10%. When considering the effects of both particle size and self-bonding, higher concentrations will enhance their effect as higher amounts of the composite filler will be present in the final sample.

Looking at each individual group of bar plots in FIGS. 12A-12B, the effect of particle size at each concentration for raw and self-bonded materials can be observed. Considering the variance of the samples, no significant effect of particle size on the mechanical performance of the 1% macroalgae-cement composites was seen at steady-state. However, at 5 and 10% for both the raw and self-bonded samples, the largest particle size is significantly weaker at steady-state than the smallest particle size while the medium particle is inconsistent with its behavior relative to the small and large sizes. Similar trends in particle size for both raw and self-bonded results suggests that self-bonding does not change the effect of particle size.

Considering the effect of self-bonding, the grouped concentration plots in FIG. 12A can be compared with the same respective concentrations in FIG. 12B (comparing 1% raw with 1% self-bonded, etc.). Similar to the trend observed with the effect of particle size, there is no observable significant difference when comparing the 1% raw and self-bonded samples. Once again, a trend becomes observable at 5 and 10%; self-bonded biomass enhances the steady-state σc by as much as 21.26% and 176.39% respectively compared to raw biomass at the same particle size. This improvement is especially significant for samples containing 10% self-bonded Ulva where small, medium, and large particle size samples experience a respective increase of 17.38, 16.35, and 8.89 MPa in their average σc. At 5%, the enhancements are a less dramatic 8.60 (small), 4.74 (medium), and 5.4 (large) MPa. These results indicate that self-bonding Ulva as a preprocessing step for cement additions leads to an increase in mechanical properties relative to utilizing raw biomass.

This observed enhancement is more significant as particle size decreases and is best represented at 10% where the filler concentration (and therefore the amount of self-bonded particles) is highest. Both of these factors increase the surface area of self-bonded particles, meaning this could be an explanation for the strength enhancement becoming more dramatic. While discussing this enhancement as a result of particle size and self-bonding, it is important to note that the overall mechanical performance significantly decreases when the concentration of Ulva is increased from 5% to 10%. However, all self-bonded Ulva samples other than the largest particle 10% sample meet the 21 MPa requirements for light commercial and residential applications [12]. More impressively, the 5% self-bonded Ulva of the smallest particle size even meets the 41 MPa strength requirements for structural applications [13], highlighting the opportunity for using self-bonded Ulva to reduce the carbon footprint of cement.

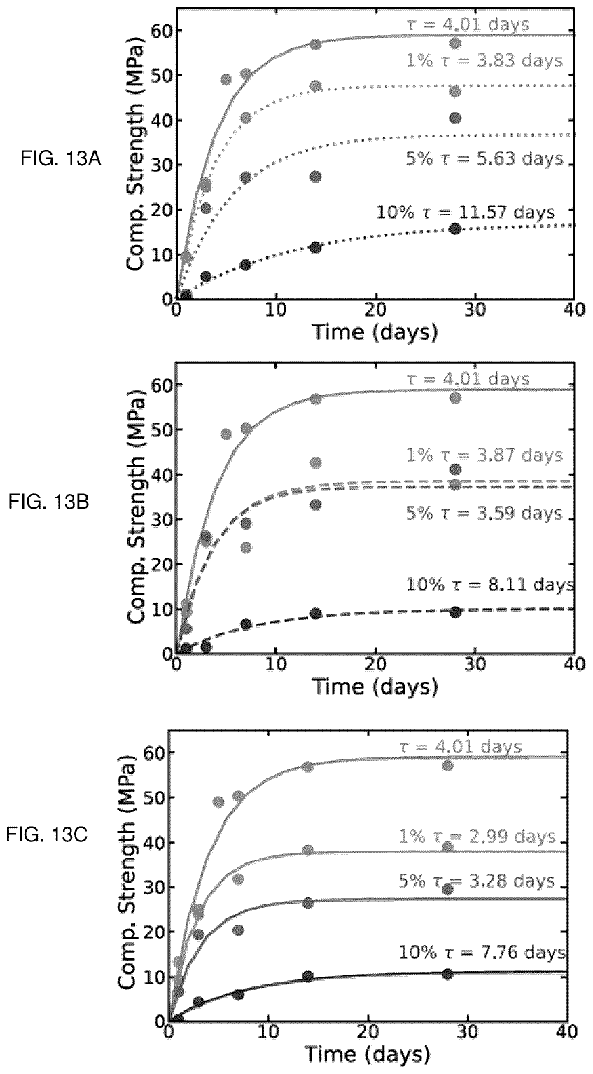

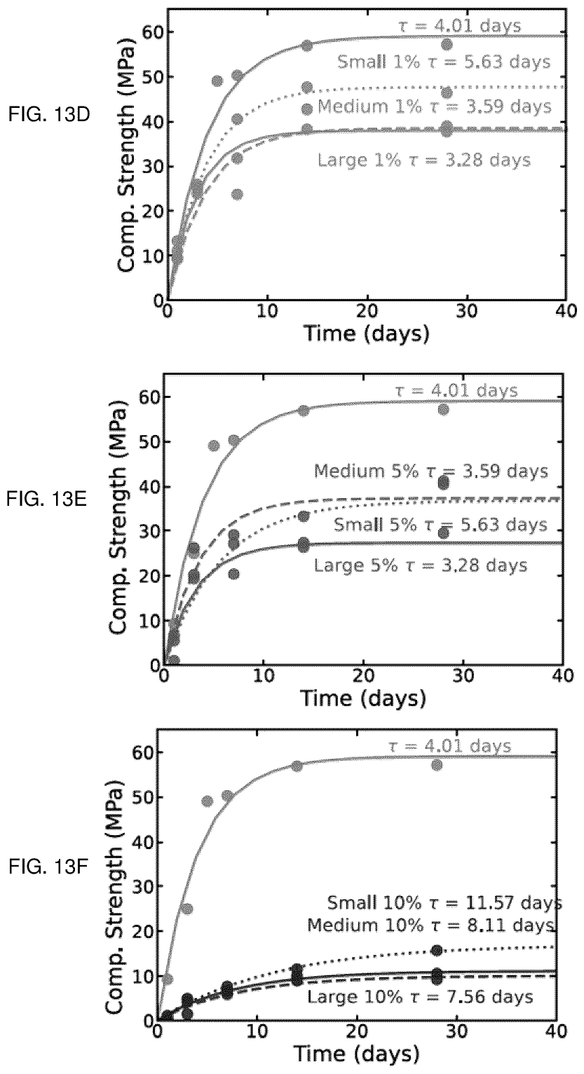

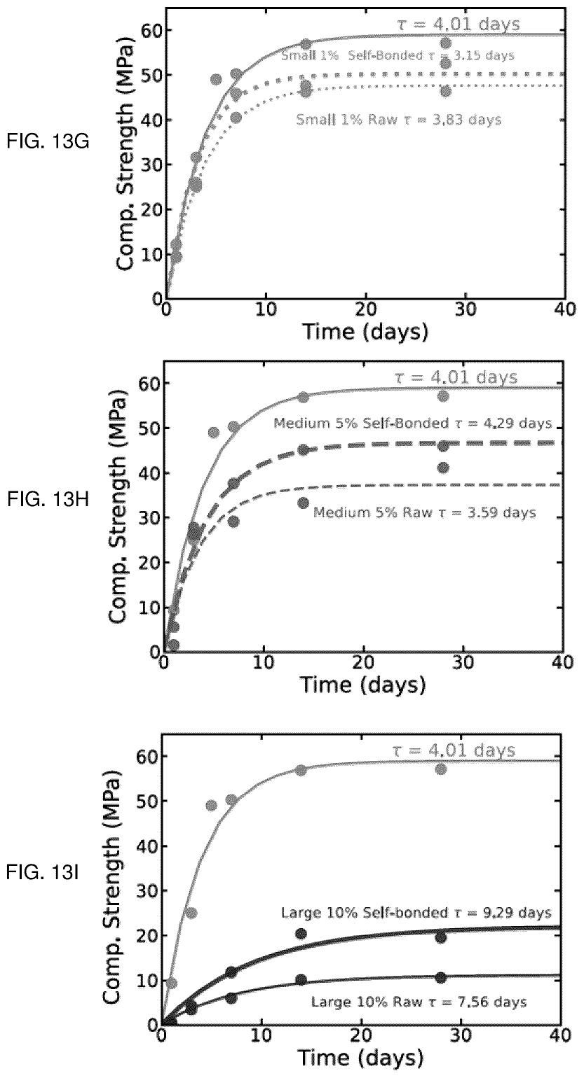

The strength development curves of the samples are compared in FIGS. 13A-13I. Equation 6 was utilized, originally proposed by Lin et al. [43], to evaluate the strength evolution, where of is the plateau strength and τ is the characteristic curing time (days) for that sample to reach a plateau in strength.

σ(t)=σf(1−e^{-t/t}) (6)

Comparing the effect of concentration in FIGS. 13A-13C, a pattern cannot confidently be discerned between 1% and 5% raw Ulva strength curves with characteristic τ values within 0.3 days of one another at the two larger particle sizes (FIGS. 13B, 13C). At the smallest particle size (FIG. 13A), there is a more noticeable difference of 1.8 days. A significant retardation was observed in the 10% samples compared to 1% and 5% at all particle sizes, as the τ value increases from 3.83 days in the 1% samples to 11.57 days for the 10% sample. This result agrees with the steady-state mechanical results in FIGS. 12A-12B where raw Ulva samples at 1% and 5% are comparable before a significant drop in performance at 10%.

The τ values are all statistically similar when observing the effect of particle size and self-bonding. The strength development curves comparing self-bonding do show that self-bonding biomass enhances the strength development. Furthermore, this effect is more apparent as strength increases.

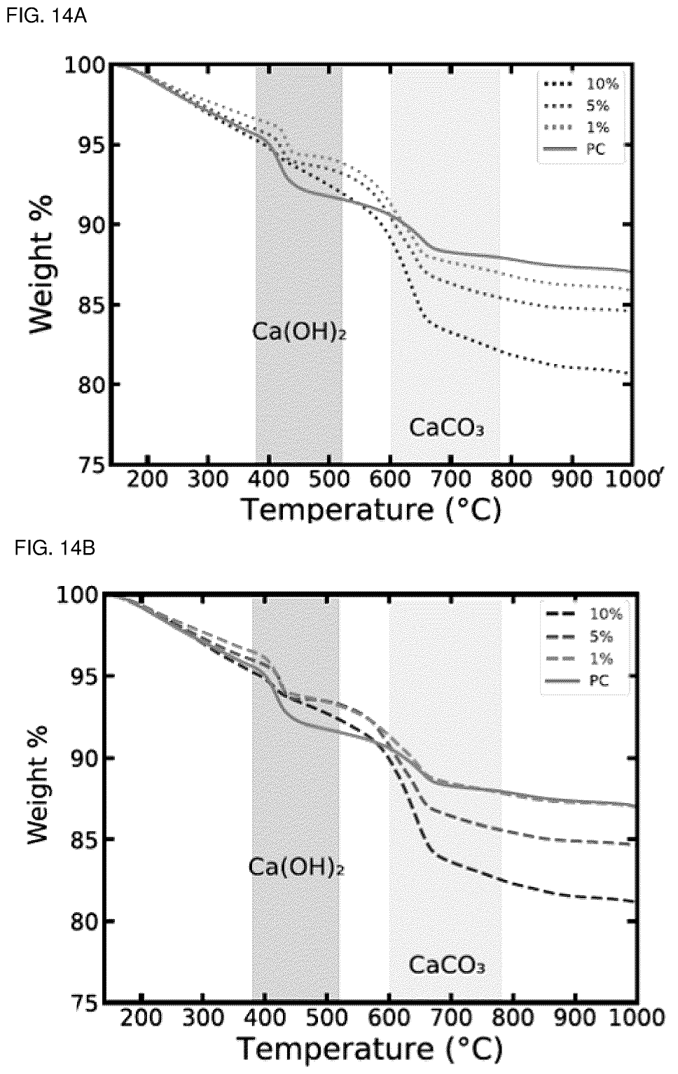

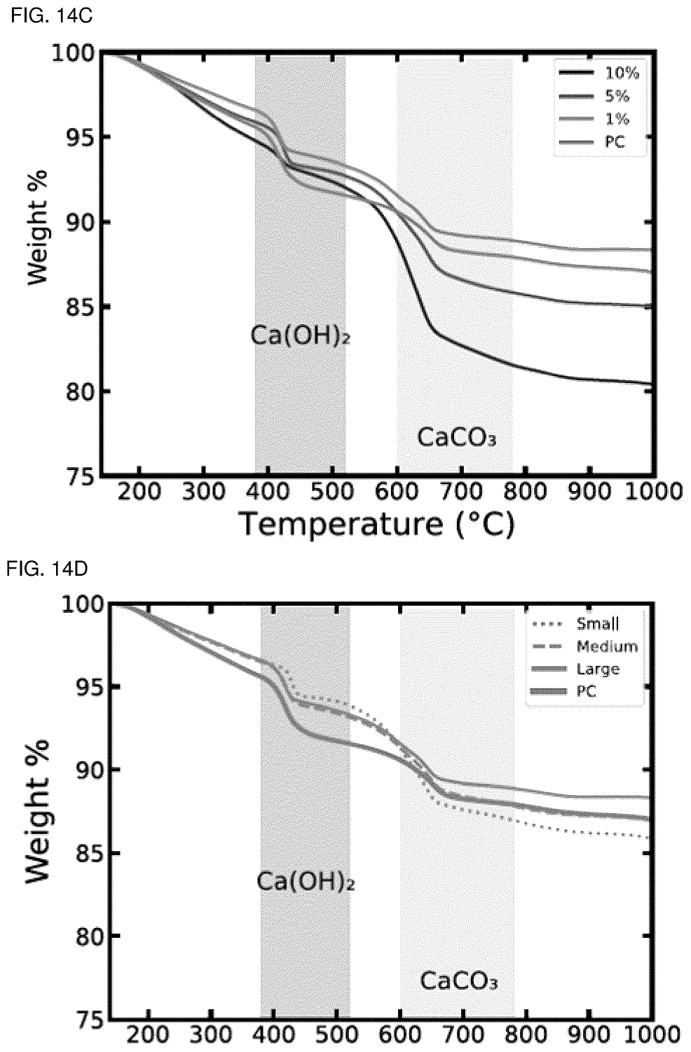

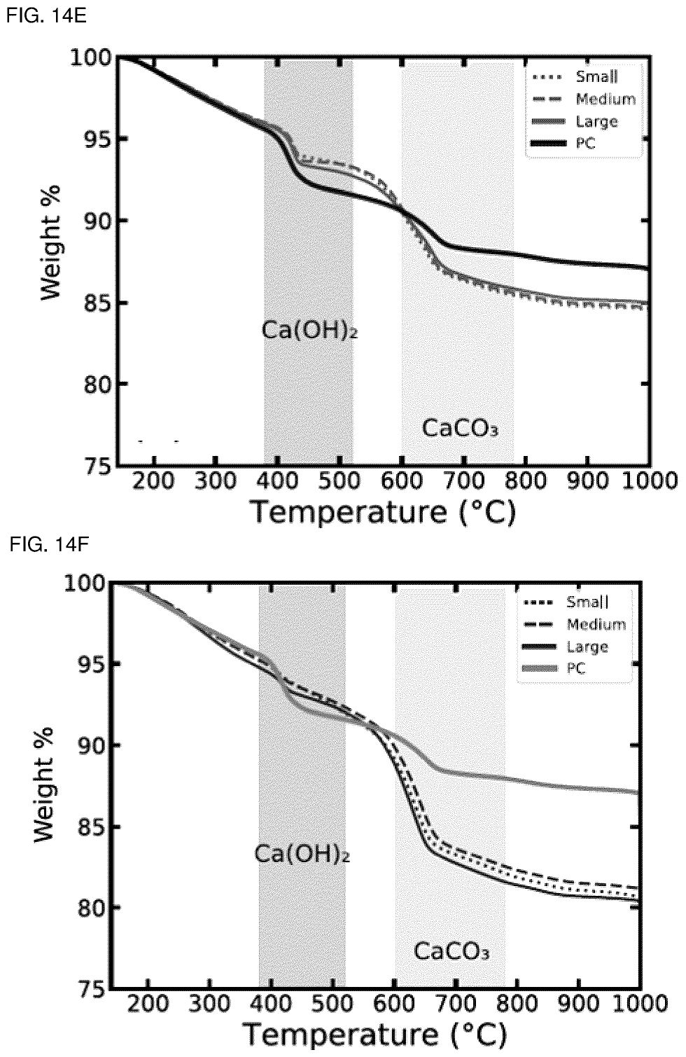

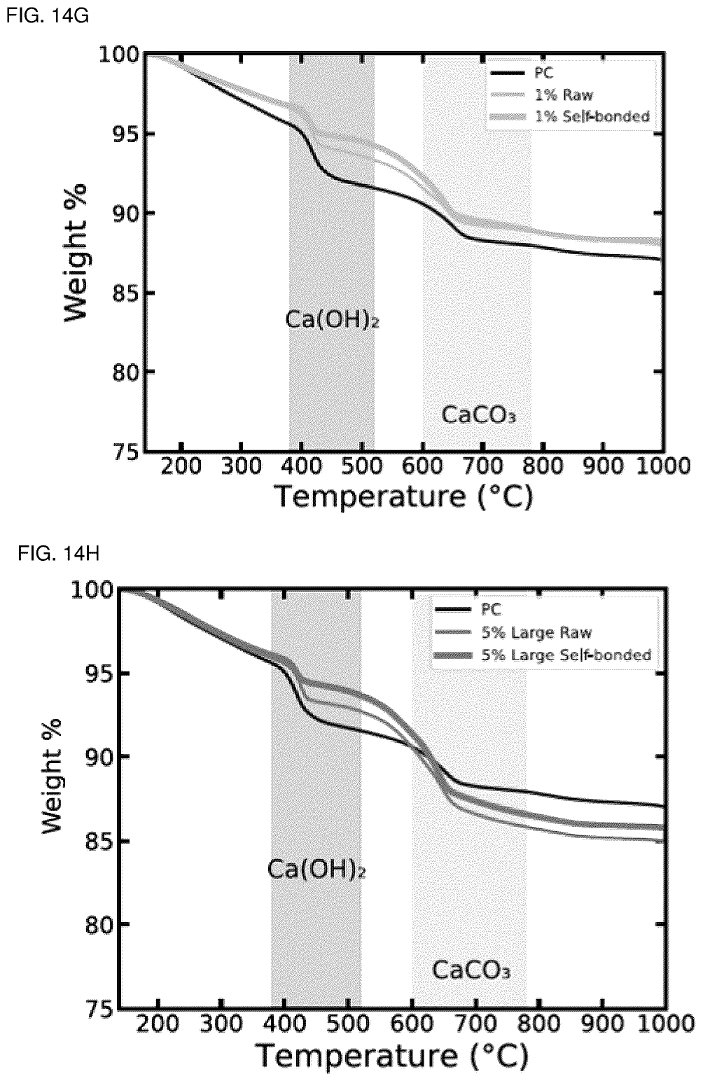

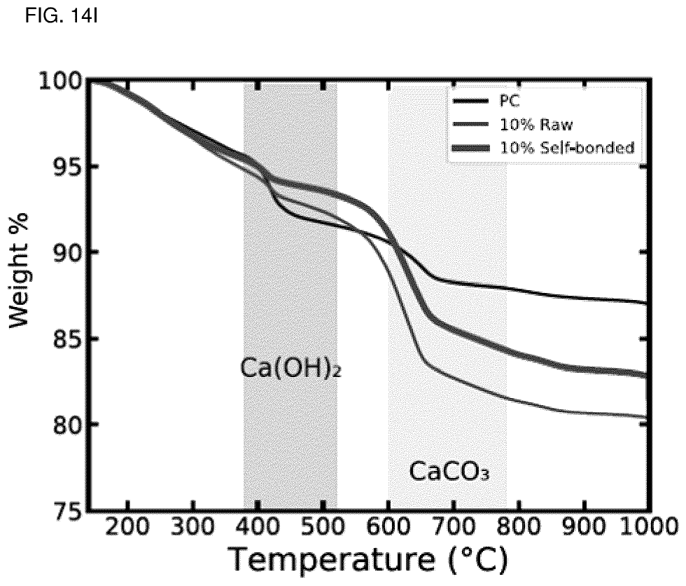

Effect on hydration reactions: Pure cement and the biomass composites were analyzed via TGA to observe any differences in the steady-state hydration products. TGA data was normalized to 140° C. to negate the loss of water entrapped in pores. FIGS. 14A-14I presents the TGA curves for various Ulva-cement composites. As mentioned in Section 2.7, the initial portion of the TGA curves is to eliminate any water loss which may be attributed to water entrapped in pores, as well as uptake accounted for by the biomass. It is noted that particle size and self-bonding may influence the water uptake of the algae, though that has not been directly compared in this study. There are two shaded regions in the TGA curves; the grey region spans from 380° C. to 520° C. and is attributed to the decomposition of Ca(OH)₂, while the yellow region spans from 600° C. to 780° C. and is related to a decomposition of CaCO₃ [54], [55]. There is mass loss occurring over the entire temperature regiment which can be attributed to the decomposition of the amorphous C—S—H [54]-[56] as well as the algal biomatter [57]. These mechanisms for thermal degradation are considered when observing the effects of the concentration, particle size, and self-bonding as an indicator for the hydration reactions derived from alite and belite.

The pure cement degradation profile is visually discernable in behavior from the composite curves, and the composites themselves show a correlation with concentration. By calculating the area of the derivative curve of the TGA within the Ca(OH)₂ decomposition region, it was found that the pure cement sample contains approximately 3.5% Ca(OH)₂ while the 1% and 5% small particle size composites contain approximately 1% and the 10% composite does not appear to present this characteristic decomposition (FIG. 14A). This trend in concentration is observed regardless of particle size for the raw Ulva composites (FIGS. 14B, 14C). The difference in degradation profiles suggests that adding up to 5% of raw Ulva will partially hinder the primary hydration reactions that occur in pure cement while not entirely halting them, but reaching a concentration of 10% amplifies this effect drastically. The 10% sample differing from the 1% and 5% in this manner could be reflected by a decrease in steady-state mechanical performance, which is what was observed in both raw and self-bonded Ulva when comparing concentration solely. The mass loss falling in the CaCO₃ region becomes more dramatic with increasing concentration and may be related to the Ulva degradation [57], but there is no method utilized in this experiment to conclusively deconvolute the contributions from this, CaCO₃, C—S—H, and other carbonated phases [54] solely through TGA.

Overall, the effect of particle size appears to be fairly minimal at all concentrations. At 5% and 10%, the raw Ulva composites of all particle sizes present nearly identical degradation (FIGS. 14E and 14F, respectively). FIG. 14D indicates that for the 1% samples, there are some slight deviations at the tail end (>800° C.), but there is nothing significant enough to warrant further investigation. Most importantly, all peaks of the same concentration observe similar behavior in the Ca(OH)₂ region, suggesting that particle size plays a small role towards the effect on hydration reactions. This again aligns with the mechanical results of raw Ulva at steady-state, as there is no significant difference in the σc of different particle sizes of filler at similar concentrations.

The degradation profiles are once again reorganized to analyze the effect of self-bonding on the composites in FIGS. 8G-8I. While the profiles appear overall very similar, the self-bonded samples undergo a smaller mass loss in the Ca(OH)₂ region. These differences in mass loss are insignificant towards the overall hydration reactions. There is less mass loss in self-bonded algae composites compared to raw counterparts, and this is more observable as concentration increases. There is a possibility that the self-bonded particles have reinforced thermal stability, though this cannot be confirmed through this experiment and is unlikely to carry an impact to the mechanical strength. Therefore, the root cause of the strength enhancement from self-bonding is not a chemical source.

Effect on micromorphology: To further investigate the interactions between the cement matrix and the algae fillers, SEM analysis was conducted after both 7 and 28 days of composite curing. The interface between the filler and the matrix are of the most importance during this analysis; as explained in the introduction, a stronger interface between the biomass and cement matrix will prevent defect driven fracture.

The mechanical results and degradation profiles suggest the effect of particle size is expected to be similar at each concentration, so there is no SEM analysis explored to explicitly expand on these observations. First looking at the effect of concentration, the cement matrix appears to become less densified with increasing concentration and the presence of voids increases. Although there appears to be more voids (10-30 μm) in the 10% and 5% samples compared to the 1% samples, SEM analysis is not a quantitative method to holistically classify this trend. These are both potential sources for the decreasing mechanical performance of the composites with increasing concentration; a less densified cement matrix is indicative of hindered hydration, and the increased presence of voids adds more defects to the composite which may lead to earlier fracture. As mentioned before, the thermal degradation results agree with the observation that hydration reactions are less fulfilled when adding higher concentrations of biomass. The increased filler concentration will certainly play a role in the strength, and more quantitative methods to discern the more dominant mechanism in terms of interface interactions and fracture mechanics are recommended beyond this experiment.

Regarding the effect of particle size, the two larger particle sizes share similarities in their filler-matrix interfaces. Ulva biomass used in this experiment takes a flake-like structure; the flake surface in both the large and medium particles seem to have no interaction with the cement matrix. In fact, there is a very noticeable gap that forms between the matrix and flake surface. Additionally, the interface between the matrix and filler is very distinct. The small particles differ in micromorphology, as there appears to be some product growing on the surface of the filler particles. Despite the products observed, there is still a clear gap between the matrix and filler as in the larger two particle sizes.

Regardless of the differing interactions with the cement matrix depending on particle size, the mechanical and degradation results indicate no significant effect on the mechanical performance and hydration products formed. Therefore, the dominant effect appears to be concentration rather than particle size for the raw Ulva.

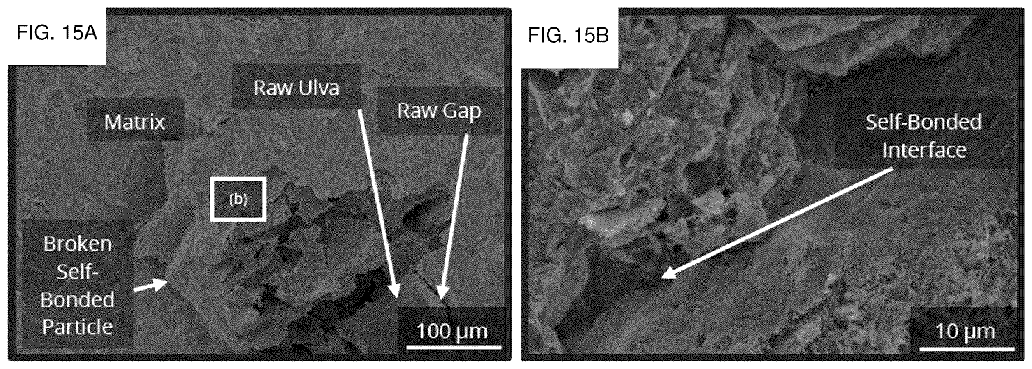

Now discussing the effect of self-bonding, FIGS. 15A-15B show a large self-bonded Ulva particle in a 10% concentration sample at steady state. This image reveals information regarding both the degree of self-bonding as well as its effectiveness as a filler relative to raw Ulva. Looking at the degree of self-bonding, FIG. 15A shows a cluster of raw Ulva that was previously encapsulated by an outer layer which can be interpreted as self-bonded Ulva; this suggests that the hot pressing does not self-bond every particle of Ulva. FIG. 15A also points out a raw Ulva particle, which still has visible cells and an easily observed gap between the biomass and cement matrix. Now looking at FIG. 15B, a much more developed interface was observed between the self-bonded Ulva and the cement matrix. Considering the effect of interfacial strength on composite performance [24]-[26], these micromorphology observations agree with the mechanical results where a strength enhancement is observed as an effect of using self-bonded additives. Therefore, the strength enhancement seen in self-bonded biomass results from stronger interface developments between the biomass and the cement matrix serving as increased mechanical reinforcement. Furthermore, the mechanical results also depicted this enhancement becoming stronger as particle size decreases. These observations explain the strengthening observed in self-bonded composites despite the degradation profiles suggesting a less fulfilled hydration. However, again regarding the degree of self-bonding, the presence of raw Ulva indicates that self-bonding can be further optimized such that a higher percentage of the raw biomass processed is receives the intended treatment.

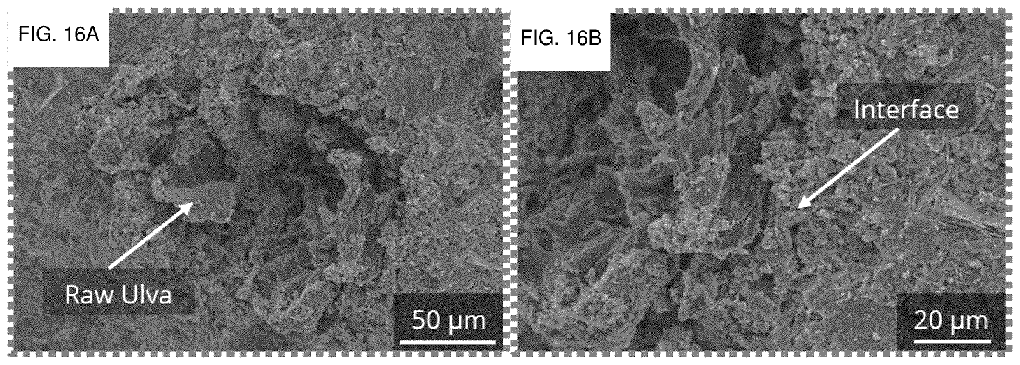

FIG. 11 above again looks at the effect of self-bonding, but at the small particle size. Similar to with what is seen in FIG. 15A, FIG. 16A points out a raw Ulva particle within what appears to be a self-bonded cluster. The higher magnification image presented in FIG. 16B shows an interface seemingly less dense than the interface in FIG. 15B, but with no clear gap or interface seen in all the raw Ulva composites.

This observation suggests that the interface microstructure between Ulva and cement are influenced by the compounding effects of particle size and self-bonding pretreatment, yet the self-bonding pretreatment is more effective in creating a dense interface.

Combining the results from the compression testing and micromorphology, a hypothesis is proposed to explain the significant strength enhancement in composites containing small and self-bonded Ulva. As mentioned in the Section 2.3, the self-bonded particles were grinded down and further processed to achieve different particle size ranges. In the case of the smaller particles, speed-milling was the method of choice. If the observations from FIGS. 15A-15B are true, it is then expected that smaller particle size ranges would break up these clusters of Ulva particles with self-bonded boundaries and raw Ulva within. The mechanical results indicate that self-bonding strengthens the composites, which becomes more effective as particle size decreases. Therefore, a viable explanation for this strength enhancement is explained by the increased surface area of self-bonded Ulva as particle size decreases. As the surface area of self-bonded Ulva increases, there will be an increased number of strengthened interfaces with the cement matrix relative to its raw counterpart. Therefore, more strong interfaces will result in stronger composite performance. No sample in this work exceeds the experimental or literature σc of pure cement; however, this could potentially be achieved if the efficiency of the self-bonding process is optimized to subsequently increase the overall interfacial strength. The observations explored in this section are noted, as they will later be compared with the observed effects of Spirulina microalgae in the following section.

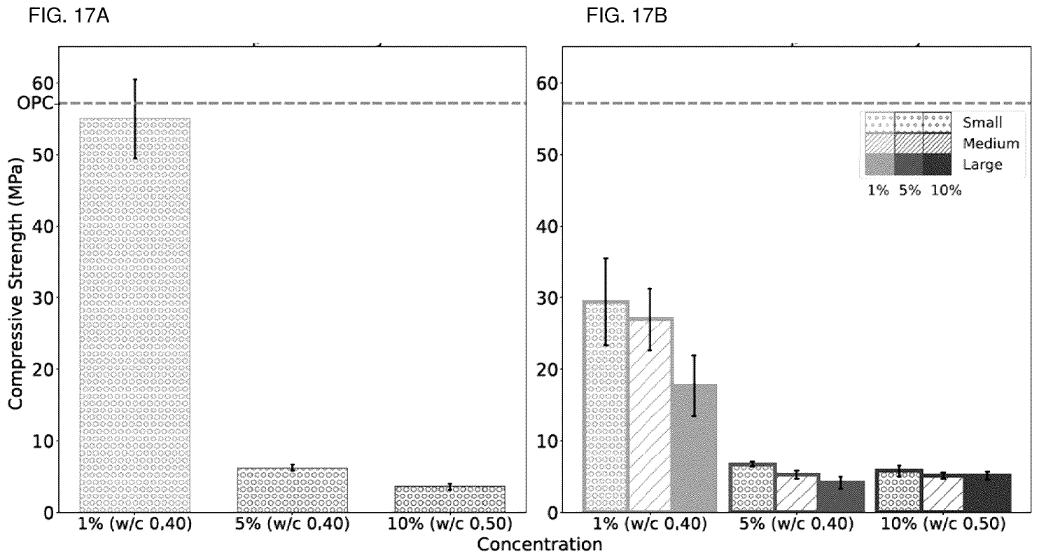

Mechanical Results: The steady-state mechanical performance is considered in below where FIG. 17A shows the 28-day σc of raw Spirulina cement composites and FIG. 17B shows such for self-bonded cement composites. The black dashed line again shows the σc of pure cement.

These plots are grouped from left to right by concentration, and are organized within each group by particle size (smallest to largest in each group). Also note that only the small particle size is explored for raw Spirulina, as this was the out-of-bag condition. The same trend is present with concentration for both the self-bonded and raw results, where a significant drop in strength was see when biomass concentration reaches 5%. This agrees with previous work where Spirulina concentration created a plateau in strength drop off at 5% [43], where it was discovered that this strength decrease was largely due to the retardation of hydration reactions. Looking at the self-bonded results, the self-bonded Spirulina with 1% concentration is significantly weaker than the raw filler. Contrary to the strength enhancement seen in macroalgae, self-bonding pretreatment appears to further hinder the mechanical performance of the microalgae composites.

Looking at each individual group of bar plots in FIG. 17B, the effect of particle size can be observed at each concentration for self-bonded materials. The largest particle size samples for 1% and 5% concentration appear to be weaker than the two smaller particle sizes, with the difference being larger in the 1% sample. However, at 10% for the self-bonded samples, there is no apparent effect of particle size. This is drastically different from the macroalgae results where the effect of particle size and self-bonding is more observable as concentration increases. This suggests that the retardation effect from Spirulina concentration is more dominant than the effects of particle size or self-bonding.

As mentioned, the effect of concentration appears to be dominant over both the particle size and self-bonding mechanisms here. This is supported by the 5% and 10% self-bonded samples showing nearly identical steady-state σc (6.25 MPa and 3.62 MPa respectively) to the raw counterparts (6.73 MPa and 5.80 MPa). Though both values get lower, it is still clear that self-bonding does not create the intended enhancement. At 1%, the raw steady-state σc decreases from 55.02 MPa to 29.42 MPa as a result of self-bonding. The reason for this dramatic decrease in strength is considered in the next sections.

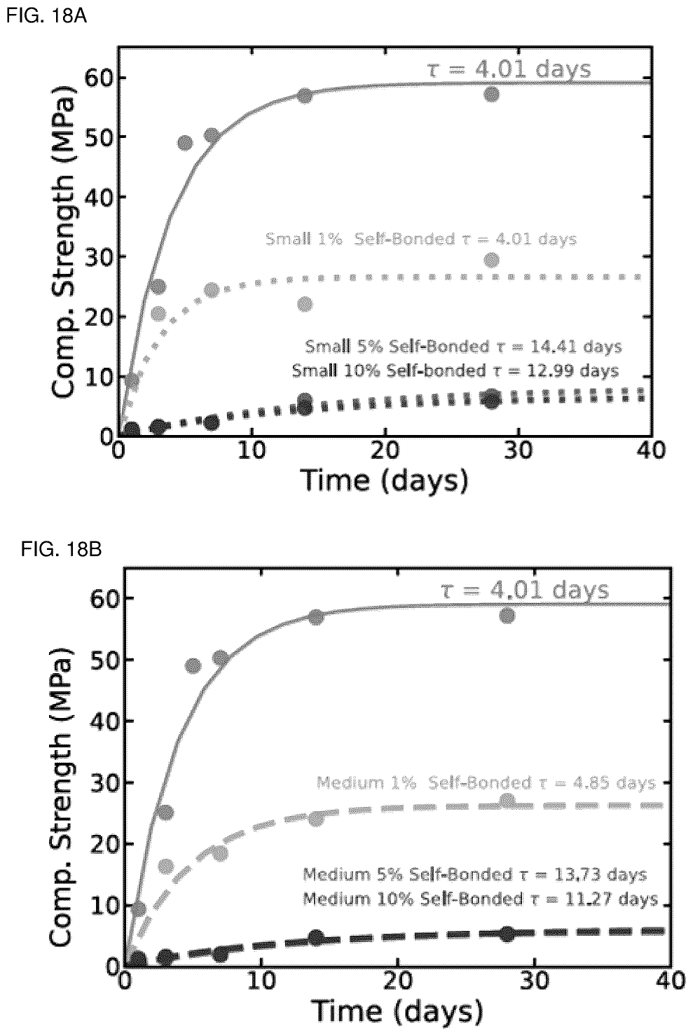

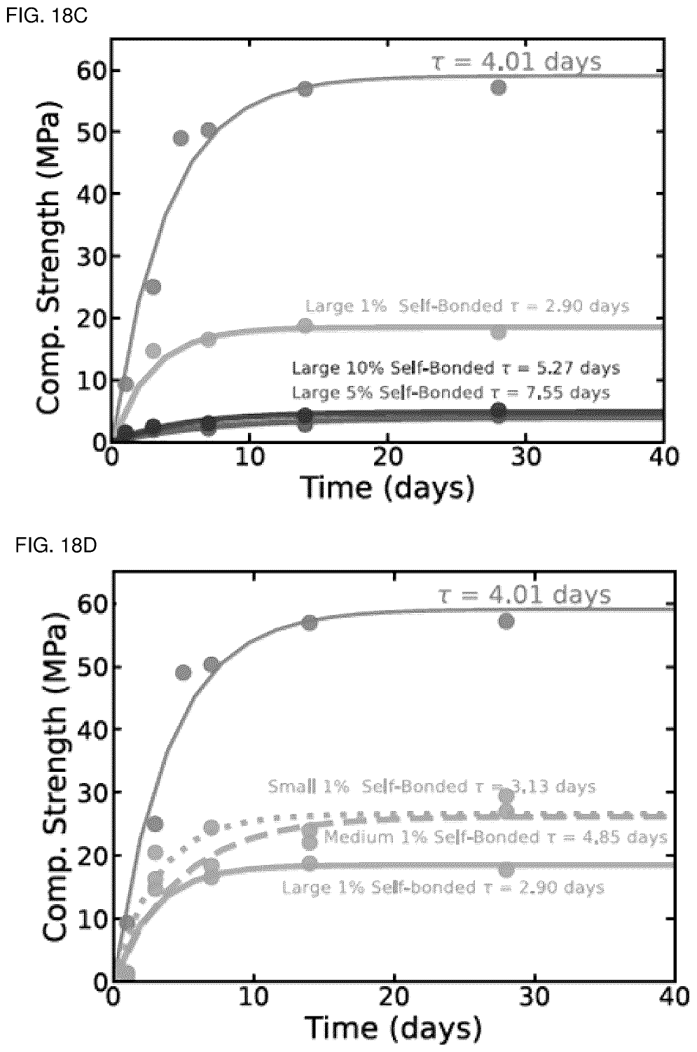

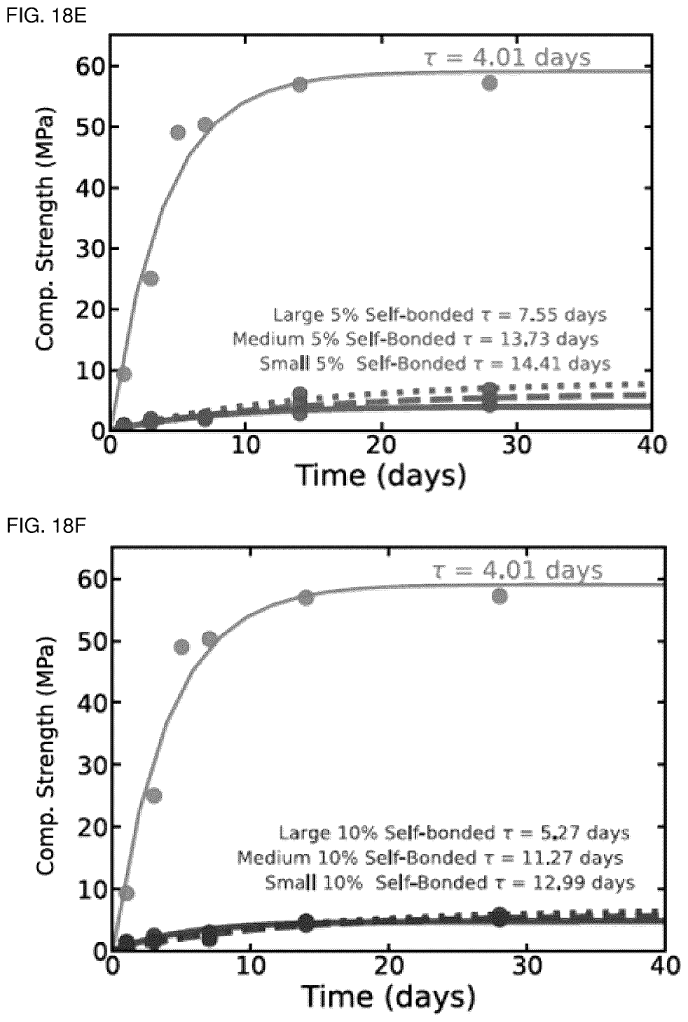

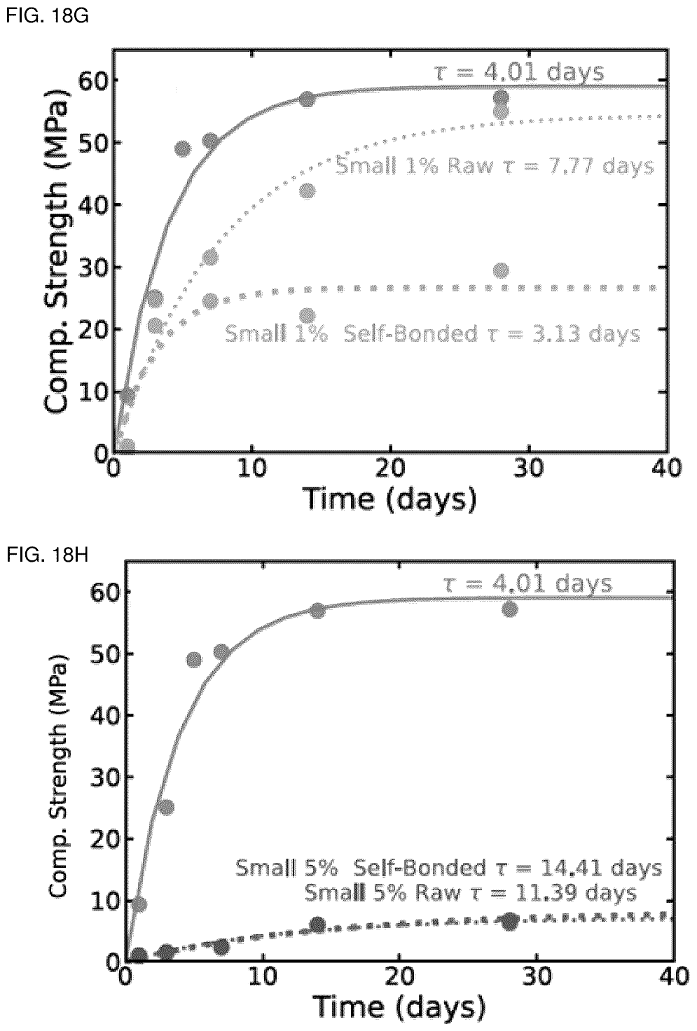

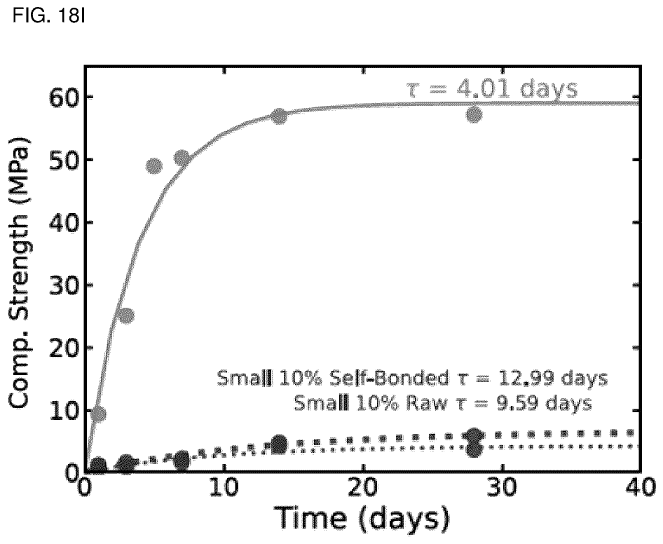

The strength development curves of the Spirulina samples are compared in FIGS. 18A-18I. Looking first at the effect of concentration, it was seen that small and medium (FIGS. 18A, 18B, respectively) particle sizes cause a significant retardation in the strength development at and above 5% concentration. Comparing 1% and 5%, the characteristic τ value increases by 10.4 days and 8.88 days at small and medium particle sizes, respectively. Yet, less retardation difference is observed for large particles when increasing concentration from 1 to 5%. Moreover, despite the curves looking similar between particle sizes for a given concentration (FIGS. 17D, 17F), the characteristic τ values indicate a dramatic retardation when small and medium particles are utilized. This is most prevalent at 5% and 10% where more biomass is present in the composite; here, the τ value increases by 6.18 and 6.00 at 5% and 10% respectively as particle size changes from large to medium. Now looking at the effect of self-bonding, similar trends were see to what was observed in the steady-state σc.

Although there is no significant trend on the characteristic τ, the strength development was seen to plateau at a lower compressive strength in the 1% self-bonded sample compared to the raw sample. This trend is no longer present at and above 5%, agreeing with the expected plateau [43].

Effect on hydration reactions: The steady-state TGA curves were prepared for 1%, 5%, and 10% Spirulina composites in the raw form at small particle size range, self-bonded at the small particle size range, and self-bonded at the large particle size range. The pure cement sample contains approximately 3.5% Ca(OH)₂ while the 1% raw composites contain approximately 2.5%. Yet, the 5% and 10% composite do not present this characteristic decomposition which agrees with the steady-state compressive strength where a dramatic decrease at and above 5% concentration is seen. Therefore, the hindrance of the cement hydration reactions is likely a contributor to the poor σc of the Spirulina composites at 5% and 10% concentration.

Overall, the effect of particle size appears to be fairly minimal at all concentrations. Again, all peaks of the same concentration observe similar behavior in the Ca(OH)₂ region, suggesting that particle size plays a smaller role here similar to in raw Ulva; this finding is again in agreement with the mechanical results. Most notably, the smallest particle size of the 1% composites undergoes more degradation above 500° C.; this trend is not present in the 5% and 10% samples, which can be investigated further. Regarding the effect of self-bonding at 1%, the profile shows a smaller mass loss in the Ca(OH)₂ region for the self-bonded Spirulina composites compared to the raw powder Spirulina, explaining the decreased compressive strength with self-bonding pretreatment previously observed. This differing profile aligns with the observed compressive strength, suggesting that self-bonding further retards the hydration reactions and strength development relative to the raw powder. This trend is not observed at either 5% or 10%, which again suggests that the effect of concentration is a more influential factor on the hydration reactions and mechanical performance than the effect of self-bonding.

Effect on micromorphology: SEM images were taken at day 7 of 10% Spirulina concentration as a raw filler, a self-bonded filler, and a self-bonded filler with large particle size. Here, the 10% 7-day samples are presented due to difficulties observing the particle-matrix interface at lower concentrations and at steady-state. It is noted that the interface is not expected to change with varying concentration, and the interactions between the filler and matrix can still be compared at day 7.

The micromorphology of the 10% raw Spirulina aligns with the observations from previous work imaging microalgae filler [43], where nanofibers (˜500 nm) were see at the cement-biomass interface that have a different morphology than typical hydration products and may therefore not be the amorphous C—S—H which strengthens cement. There was also a noticeable gap between the Spirulina and the matrix, which could be caused by the water lost by the biomass as it dehydrates and subsequently shrinks.

Now comparing the composites with raw Spirulina and the self-bonded Spirulina, the first similarity is the presence of the same fibers at higher magnification, though less significantly in the self-bonded biomass. The very distinct gap between the matrix and Spirulina in the raw powder is much less pronounced in the self-bonded sample. This is an indication that the self-bonding may play a role in affecting the interactions between the cement matrix and the biomass, but this cannot be explored further through SEM analysis. Regardless, self-bonding has no significant impact on steady-state strength at 5% or 10%, and even weakens the composite at 1%. This result almost exactly contradicts what is seen with the Ulva results, warranting further discussion and exploration.

Regarding the effect of particle size, the small and large particle sizes of self-bonded Spirulina look nearly identical, as expected. The large particle composite again has comparatively few fibers on the biomass surface, with many of these products at the interface with the cement matrix. There are also voids ranging from 5-30 μm observed. Nonetheless, the similar degradation and mechanical performance indicates that there is no significant effect of particle size on the hydration reactions and strength, which is also seen here.

Now comparing the microalgae and macroalgae, differences in their behavior arising from self-bonding were observe. In short, Spirulina influences on cement composite strength are seen to be rooted in the chemical interactions sufficiently retarding the hydration reactions; conversely, the Ulva appears to have comparatively little impact on the hydration reactions and the effects on cement composite strength are governed by the mechanical reinforcement the Ulva filler provides. Compositionally, macroalgae can have a protein content ranging from 7-31% of the dry weight, lipid content in the 2-13% range, a carbohydrate content of 32-60% [58], [59], and cellulose contents from 1-15% [60].

Conversely, microalgae is rich in carbohydrates, proteins and lipids [61]. The main differences between the macroalgae and microalgae is the significant amount of cellulose in the multicellular macroalgae structure, and the protein rich environment of the unicellular microalgae. It is expected that the self-bonding of Spirulina exposes more proteins and cellular innards, which carries the detrimental influence on the compressive strength. It is therefore hypothesized that similar interactions from Ulva self-bonding have an strengthening effect, though this is an area to explore in further experimentation.

### Conclusion

In this work, macroalgae in the form of Ulva and microalgae in the form of commercial Spirulina underwent preprocessing to alter the particle size as well as to self-bond the biomass. Resultant composites were characterized by their mechanical strength and strength development over 28 days of curing, thermal degradation studies at steady-state, and micromorphological assessments at both early (7 day) and late (28 day) stages of curing. The results gathered support the following general conclusions:

A decrease in compressive strength was observed with increasing concentration of raw Ulva at and above 10%, where the addition of 1 and 5% raw Ulva have similar effects on cement composites in terms of their mechanical performance, hydration products and micromorphology. The small particle Ulva (25+/−19.7 um) composites are ˜1.5× stronger than the large particle (272.1+/−124.9 μm) counterparts. In addition, it was found that the particle sizes of raw Ulva have negligible effect on the hydration reactions due to the similar TGA degradation profile. While a gap between the biomass and the matrix is observed in SEM analysis for all raw Ulva, the effect of particle size is best explained by defect mechanisms where smaller defects will hinder the strength less. Leveraging the self-bonding preprocessing, the potential of enhancing the compressive strength of Ulva-cement composite up to 2-fold (from 15.66 MPa to 33.04 MPa) at 10% small particle Ulva concentration was show. This strength enhancement is attributed to the reduced gap at the filler-matrix interfaces seen in the micromorphology, which may be caused by the change in hydrophilicity of biomass through the self-bonding preprocessing; this change will lead to stronger interfacial bonding, as well as intrinsically stronger additives. Highlighting the improved interfacial bonding through self-bonding preprocessing, increasing filler surface area (decreasing particle size) also shows an increase in compressive strength.

In contrast to the macroalgae, Spirulina shows a concentration-dominated mechanism where more than 5% addition of raw or self-bonded Spirulina drastically hinders both the cement hydration reactions and the mechanical performance. Surprisingly, when 1% self-bonded Spirulina is introduced, the compressive strength of the composite decreases by a factor of 0.53 compared to the raw Spirulina counterparts. It is hypothesized that this reduction in strength is induced by the self-bonding processing that enhances the detrimental chemical interactions between the Spirulina filler and the cement matrix. The contrary effect of self-bonded bio-additives on cement between Ulva and Spirulina is attributed to the compositional differences between the macro and micro-algal species, which is beyond the scope of this work.

### References for Example 4

1. Kosmatka & Wilson, Portland Cem. Assoc., Fifteenth Edition, p. 459, 2011.
2. Ramsden, “Cement and Concrete: The Environmental Impact,” Nov. 3, 2020. Online at psci.princeton.edu/tips/2020/11/3/cement-and-concrete-the-environmental-impact
3. Talaei et al., Energy, 170:1051-1066, March 2019, doi: 10.1016/j.energy.2018.12.088.
4. Kajaste & Hurme, J. Clean. Prod., 112:4041-4052, 2016, doi: 10.1016/j.jclepro.2015.07.055.
5. Balsara et al., Environ. Pollut., 252:863-878, 2019, doi: 10.1016/j.envpol.2019.05.059.
6. Hasanbeigi et al., Renew. Sustain. Energy Rev., 16(8):6220-6238, 2012, doi: 10.1016/j.rser.2012.07.019.
8. Gartner, Cem. Concr. Res., 34(9):1489-1498, 2004, doi: 10.1016/j.cemconres.2004.01.021.
9. Courland, Concrete planet: the strange and fascinating story of the world's most common man-made material. Amherst, N.Y.: Prometheus Books. 2011; ISBN:978-1616144814
10. Soustos & Domone, Construction Materials: Their Nature and Behaviour, 5th ed. CRC Press, 2017. doi.org/10.1201/9781315164595
11. Xu & Chung, Cem. Concr. Res., 30(8):1305-1311, 2000, doi: 10.1016/S0008-8846(00)00337-9.
12. Obla et al., ACI Concrete International 25(8):29-34, 2003.
13. Neville, “The Strength of Concrete,” in Concrete Manual 2012 IBC and ACI 318-II Concrete Quality and Field Practices, ICC, 2013:23-27.
14. “Hydration of Portland Cement.” Online at engr.psu.edu/ce/courses/ce584/concrete/library/construction/curing/Hydration.htm (accessed May 17, 2023).
15. “Ettringite Formation and the Performance of Concrete.” Portland Cement Association, 2001. cement.org/docs/default-source/fc_concrete_technology/is417-ettringite-formation-and-the-performance-of-concrete.pdf?sfvrsn=412%26sfvrsn=412
16. Alizadeh et al., Mater. Struct., 44(1):13-28, 2011, doi: 10.1617/s11527-010-9605-9.
17. Yuksel, “Blast-furnace slag,” in Waste and Supplementary Cementitious Materials in Concrete, Rafat Siddique and Paulo Cachim, Eds., 2018:361-415. doi.org/10.1016/B978-0-08-102156-9.00012-2
18. Langan et al., Cem. Concr. Res., 32(7):1045-1051, 2002, doi: 10.1016/S0008-8846(02)00742-1.
19. Saraswathy & Song, Mater. Chem. Phys., 104(2-3):356-361, 2007, doi: 10.1016/j.matchemphys.2007.03.033.
20. Yen et al., Constr. Build. Mater., 21(2):458-463, 2007, doi: 10.1016/j.conbuildmat.2005.06.051.
21. Ban et al., Polymers, 12(11) Art. no. 11, 2020, doi: 10.3390/polym12112650.
22. Hisseine et al., Constr. Build. Mater., 206:84-96, 2019, doi: 10.1016/j.conbuildmat.2019.02.042.
23. Amziane & Arnaud, “Bioaggregate-based Building Materials, Applications to Hemp Concrete.” ISTE Ltd and John Wiley & Sons. Inc, 2013.
24. Debnath et al., Dent. Mater., 20(7):677-686, 2004, doi: 10.1016/j.dental.2003.12.001.
25. Jebli et al., Constr. Build. Mater., 161:16-25, 2018, doi: 10.1016/j.conbuildmat.2017.11.100.
26. Omairey et al., SN Appl. Sci., 3(9):769, 2021, doi: 10.1007/s42452-021-04753-8.
27. Yang et al., Cem. Concr. Res., 22(4):612-620, 1992, doi: 10.1016/0008-8846(92)90013-L.
28. Ollivier et al., Adv Cement Based Mat. 2(1):30-38, 1995.
29. Scrivener et al., Interface Sci., 12(4):411-421, 2004, doi: 10.1023/B:INTS.0000042339.92990.4c.
30. Shane et al., J. Am. Ceram. Soc., 83(5):1137-1144, 2004, doi: 10.1111/j.1151-2916.2000.tb01344.x.
31. Chiellini et al., Biomacromolecules, 9(3):1007-1013, 2008, doi: 10.1021/bm701041e.
32. Iannace et al., J. Appl. Polym. Sci., 73(4):583-592, 1999, doi: 10.1002/(SICI)1097-4628(19990725)73:4<583::AID-APP14>3.0.CO;2-H
33. Bulota & Budtova, Compos. Part Appl. Sci. Manuf., 73:109-115, 2015, doi: 10.1016/j.compositesa.2015.03.001.
34. Barghini et al., J. Polym. Sci. Part Polym. Chem., 48(23:5282-5288, 2010, doi: 10.1002/pola.24327.
35. Torres et al., ACS Sustain. Chem. Eng., 3(4):614-624, 2015, doi: 10.1021/sc500753h.
36. León-Martínez et al., Constr. Build. Mater., 53:190-202, 2014, doi: 10.1016/j.conbuildmat.2013.11.068.
37. Amer Algaifi et al., Constr. Build. Mater., 254:119258, 2020, doi: 10.1016/j.conbuildmat.2020.119258.
38. Chen et al., Mater. 1996-1944, 12(24):4099, 2019, doi: 10.3390/ma12244099.
39. Jonkers et al., Ecol. Eng., 36(2):230-235, 2010, doi: 10.1016/j.ecoleng.2008.12.036.
40. Gwon et al., Constr. Build. Mater., 267: 121734, 2021, doi: 10.1016/j.conbuildmat.2020.121734.
41. Haoyang, IOP Conf. Ser. Earth Environ. Sci., 120:012011, 2018, doi: 10.1088/1755-1315/120/1/012011.
42. Zhu et al., Macromol. Res., 25(2):165-171, 2017, doi: 10.1007/s13233-017-5025-9.
43. Lin et al., ACS Sustain. Chem. Eng., p. acssuschemeng.2c07539, 2023, doi: 10.1021/acssuschemeng.2c07539.
44. Chen et al., ACS Sustain. Chem. Eng., 9(41):13726-13734, 2021, doi: 10.1021/acssuschemeng.1c04033.
45. Ramasubramani et al., “Study on the strength properties of marine algae concrete,” RASAYAN J. Chem 9(4):706-715, 2016.
46. Achenza & Fenu, Mater. Struct., 39(1):21-27, 2007, doi:10.1617/s11527-005-9000-0.
47. Frigione & Marra, Cement and Concrete Res., 6(1), 113-127, 1976 doi.org/10/1016/0008-8846(76)90056-9.
48. Vollath et al., Beilstein J. Nanotechnol., 9:2265-2276, 2018, doi: 10.3762/bjnano.9.211.
49. Iyer et al., Adv. Funct. Mat. 2023, doi.org/10.1002/adfm.202302067
50. C01 Committee, “Specification for Portland Cement,” ASTM International. doi: 10.1520/C0150_C0150M-22.
51. E29 Committee, “Specification for Woven Wire Test Sieve Cloth and Test Sieves,” ASTM International. doi: 10.1520/E0011-22.
52. C01 Committee, “Test Method for Compressive Strength of Hydraulic Cement Mortars (Using 2-in. or [50 mm] Cube Specimens),” ASTM International. doi: 10.1520/C0109_C0109M-21.
53. Schneider et al., Nat. Methods, 9(7):671-675, July 2012, doi: 10.1038/nmeth.2089.
54. Gabrovšek et al., Acta Chim Slov, 53:159-165, 2006.
55. Pane & Hansen, Cem. Concr. Res., 35(6):1155-1164, 2005, doi: 10.1016/j.cemconres.2004.10.027.
56. Rupasinghe et al., Cem. Concr. Compos., 80:17-30, 2017, doi: 10.1016/j.cemconcomp.2017.02.011.
57. Ceylan & Goldfarb, Energy Convers. Manag., 101:263-270, 2015, doi: 10.1016/j.enconman.2015.05.029.
58. Kazir et al., Food Hydrocoll., 87:194-203, 2019, doi: 10.1016/j.foodhyd.2018.07.047.
59. Biris-Dorhoi et al., Nutrients, 12(10):3085, 2020, doi: 10.3390/nu12103085.
60. Wahlström et al., Cellulose, 27(7):3707-3725, 2020, doi: 10.1007/s10570-020-03029-5.
61. Kumar et al., Renew. Sustain. Energy Rev., 65:235-249, 2016, doi: 10.1016/j.rser.2016.06.055.
62. Abell et al., J. Colloid Interface Sci., 211(1):39-44, 1999, doi: 10.1006/jcis.1998.5986.
63. Moro & Böhni, J. Colloid Interface Sci., 246(1):135-149, 2002, doi: 10.1006/jcis.2001.7962.
64. Odler, Cem. Concr. Res., 33(12):2049-2056, 2003, doi: 10.1016/S0008-8846(03)00225-4.
65. Brunauer et al., J. Am. Chem. Soc., 60(2):309-319, 1938, doi: 10.1021/ja01269a023.

### (IX) Closing Paragraphs

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain implementations are described herein, including the best mode known to the inventors for carrying out implementations of the disclosure. Of course, variations on these described implementations will become apparent to those of ordinary skill in the art upon reading the foregoing description. The inventors expect skilled artisans to employ such variations as appropriate, and the inventors intend for implementations to be practiced otherwise than specifically described herein. Accordingly, the scope of this disclosure includes all modifications and equivalents of the subject matter recited in the claims appended hereto as permitted by applicable law. Moreover, any combination of the above-described elements in all possible variations thereof is encompassed by implementations of the disclosure unless otherwise indicated herein or otherwise clearly contradicted by context.

What is claimed is:

1. A method of preparing a biological cement product, the method comprising:
forming a biological cement paste by mixing dry matter and water, wherein the dry matter comprises:
0.5 wt % to 15 wt % algal biomatter per dry matter; and
cement;
pouring the biological cement paste into a mold; and
curing the biological cement paste, thereby forming the biological cement product; wherein the algal biomatter comprises at least one of a Saccharina sp. or an Ulva sp.

2. The method of claim 1, wherein the algal biomatter comprises at least one of Chlorella, Spirulina (Arthrospira platensis), Saccharina latissima, Ulva lactuca, Ulva expensa, Agarophyton, Sargassum, Gracilaria parvispora, Halymenia hawaiiana or Caulerpa lentillifera.

3. The method of claim 1, wherein the biological cement paste comprises:
3 wt % to 15 wt % algal biomatter per dry matter; or
10 wt % to 15 wt % algal biomatter per dry matter.

4. The method of claim 1, wherein the biological cement paste comprises a water to cement ratio of 0.35 to 0.5.

5. The method of claim 1, wherein the biological cement paste comprises one or more of:
20 wt % to 40 wt % water;
20 wt % to 33 wt % water;
55 wt % to 80 wt % cement; or
55 wt % to 74 wt % cement.

6. The method of claim 1, wherein the cement comprises: tricalcium silicate, dicalcium silicate, tricalcium aluminate, tetracalcium aluminoferrite, and gypsum.

7. The method of claim 6, wherein the cement comprises:
25-50% tricalcium silicate,
20-45% dicalcium silicates,
5-12% tricalcium aluminate,
6-12% tetracalcium aluminoferrite, and
2-10% gypsum,
wherein the sum total does not exceed 100%.

8. The method of claim 1, wherein the dry matter further comprising one or more of: construction aggregate, limestone, nanoclay, non-algal biomatter, an inorganic polymer, an organic polymer, a salt, a hardening agent, a hardening-retarding agent, a colorant, a water-repelling chemical, an air-entraining agent, a corrosion inhibitor, a glue, a resin, or a self-bonding agent.

9. The method of claim 1, wherein the curing comprises drying.

10. The method of claim 1, wherein the curing comprises one or more of:
incubating at 50% to 100% relative humidity;
incubating at 90% relative humidity; and/or
incubating at ambient conditions.

11. The method of claim 10, wherein the ambient conditions comprise:
a temperature ranging from 20° C. to 30° C.; or
a temperature of 25° C.

12. The method of claim 10, wherein the ambient conditions comprises a relative humidity of 30-50% relative humidity.

13. The method of claim 1, wherein one or more of:
the curing comprises applying additional water to the biological cement paste;
at least a portion of the algal biomatter is dried;
at least a portion of the algal biomatter has been preprocessed by hot water extraction;
at least a portion of the algal biomatter has been preprocessed by cold water extraction;
at least a portion of the algal biomatter has been preprocessed by self-bonding;
at least a portion of the algal biomatter is formulated as a bioplastic;
at least a portion of the algal biomatter is a powder; and/or
at least a portion of the cement is a powder.

14. A biological cement comprising dry matter and water, wherein the dry matter comprises:
0.5 wt %-15 wt % algal biomatter per dry matter comprising at least one of a Saccharina sp. or an Ulva sp.; and
cement.

15. The biological cement of claim 14, made by a method comprising:
forming a biological cement paste by mixing dry matter and water, wherein the dry matter comprises 0.5 wt % to 15 wt % algal biomatter per dry matter and cement;
pouring the biological cement paste into a mold; and
curing the biological cement paste, thereby forming the biological cement.

16. The biological cement of claim 14, wherein the algal biomatter comprises at least one of Chlorella, Spirulina (Arthrospira platensis), Saccharina latissima, Ulva lactuca, Ulva expensa, Agarophyton, Sargassum, Gracilaria parvispora, Halymenia hawaiiana or Caulerpa lentillifera.

17. The biological cement of claim 14, wherein the biological cement has at least one mechanical property that is:
within 5% to 110% of the same mechanical property of conventional cement; or
within 90% to 110% of the same mechanical property of conventional cement.

18. A building product comprising the biological cement of claim 14, which building product is a mortar or a concrete.

19. A method of tuning one or more mechanical properties of a biological cement comprising dry matter and water, wherein the dry matter comprises algal biomatter and cement, the method comprising one or more of:
varying an amount of algal biomatter;
varying a type of algal biomatter; and/or
varying a preprocessing/pretreatment of the algal biomatter.

20. The method of claim 19, wherein one or more of:
the amount of algal biomatter ranges from 0.5 wt % to 15 wt % algal biomatter per dry matter;
the amount of algal biomatter ranges from 3 wt % to 15 wt % algal biomatter per dry matter;
the amount of algal biomatter ranges from 10 wt % to 15 wt % algal biomatter per dry matter; and/or
the type of algal biomatter comprises at least one of Chlorella, Spirulina (Arthrospira platensis), Saccharina latissima, Ulva lactuca, Ulva expensa, Agarophyton, Sargassum, Gracilaria parvispora, Halymenia hawaiiana or Caulerpa lentillifera.
